(19) United States
(12) Patent Application Publication
(10) Pub. No.: US 2026/0268835 A1
(43) Pub. Date: Sep. 10, 2026

(54) GATE DRIVER, DISPLAY DEVICE INCLUDING THE GATE DRIVER, AND ELECTRONIC DEVICE INCLUDING THE DISPLAY DEVICE

(71) Applicant: Samsung Display Co., Ltd., Yongin-si (KR)

(72) Inventors: Sanghun Kim, Yongin-si (KR); Seungjun Shin, Yongin-si (KR)

(21) Appl. No.: 19/542,197

(22) Filed: Feb. 17, 2026

(30) Foreign Application Priority Data
Mar. 7, 2025 (KR) 10-2025-0029935

(51) Int. Cl. G09G 3/32; G09G 3/3233; G09G 3/3266

(52) U.S. Cl. CPC G09G 3/32; G09G 3/3233; G09G 3/3266; G09G 2300/0819; G09G 2300/0852; G09G 2300/0861; G09G 2310/0278; G09G 2310/0286; G09G 2330/023

(57) ABSTRACT

A gate driver includes an input circuit, which controls a voltage of a control node in response to a clock signal, an inversion clock signal which is an inverted signal of the clock signal, and an input signal, an inverter circuit, which inverts the voltage of the control node and provides the inverted voltage of the control node to an inversion control node, a feedback circuit, which inverts a voltage of the inversion control node and controls the voltage of the control node, and a gate output circuit, which outputs a gate signal in response to the voltage of the control node or the voltage of the inversion control node.

This application claims priority to Korean Patent Application No. 10-2025-0029935, filed on Mar. 7, 2025, and all the benefits accruing therefrom under 35 U.S.C. § 119, the content of which in its entirety is herein incorporated by reference.

### BACKGROUND

### 1. Field

Embodiments of the present invention relates to a gate driver, a display device including the gate driver, and an electronic device including the display device. More particularly, the present invention relates to a gate driver, a display device including the gate driver, and an electronic device including the display device for controlling a node voltage.

### 2. Description of the Related Art

In general, a display device includes a display panel and a display panel driver. The display panel includes gate lines, data lines, emission lines, and pixels. The display panel driver includes a gate driver for providing a gate signal to the gate lines, a data driver for providing a data voltage to the data lines, an emission driver for providing an emission signal to the emission lines, and a driving controller for controlling the gate driver, the data driver, and the emission driver.

The gate driver may receive a gate start signal and a clock signal, and a node voltage of the gate driver may be determined based on the gate start signal and the clock signal. Therefore, the node voltage may be unstable based on the gate initiation signal and the clock signal.

For example, the clock signal may include a first clock signal and a second clock signal. When the first clock signal and the second clock signal are not aligned with each other, the node voltage may be unstable. For example, when a toggling (i.e., a frequency) of the clock signal is reduced, the node voltage may be unstable.

### SUMMARY

Embodiments of the present invention provide a gate driver for maintaining a node voltage stably.

Embodiments of the present invention provide a display device including the gate driver.

Embodiments of the present invention provide an electronic device including the display device.

In an embodiment of a gate driver according to the present invention, the gate driver includes an input circuit configured to control a voltage of a control node in response to a clock signal, an inversion clock signal which is an inverted signal of the clock signal, and an input signal, an inverter circuit configured to invert the voltage of the control node and provide the inverted voltage of the control node to an inversion control node, a feedback circuit configured to invert a voltage of the inversion control node and control the voltage of the control node, and a gate output circuit configured to output a gate signal in response to the voltage of the control node or the voltage of the inversion control node.

In an embodiment, the input circuit may include a first transistor including a gate electrode, which receives the clock signal, a first electrode, and a second electrode connected to the control node, a second transistor including a gate electrode, which receives the inversion clock signal, a first electrode, and a second electrode connected to the control node, a third transistor including a gate electrode, which receives the input signal, a first electrode, which receives a high gate voltage, and a second electrode connected to the first electrode of the first transistor, and a fourth transistor including a gate electrode, which receives the input signal, a first electrode, which receives a low gate voltage, and a second electrode connected to the first electrode of the second transistor.

In an embodiment, the first transistor and the third transistor may be p-channel metal-oxide-semiconductor field-effect transistor (PMOS) transistors, and the second transistor and the fourth transistor may be n-channel metal-oxide-semiconductor field-effect transistor (NMOS) transistors.

In an embodiment, the inverter circuit may include a fifth transistor including a gate electrode connected to the control node, a first electrode, which receives the high gate voltage, and a second electrode connected to the inversion control node, and a sixth transistor including a gate electrode connected to the control node, a first electrode, which receives the low gate voltage, and a second electrode connected to the inversion control node.

In an embodiment, the fifth transistor may be a PMOS transistor and the sixth transistor may be an NMOS transistor.

In an embodiment, the feedback circuit may include a seventh transistor including a gate electrode connected to the inversion control node, a first electrode connected to the first electrode of the first transistor, and a second electrode connected to the control node, and an eighth transistor including a gate electrode connected to the inversion control node, a first electrode connected to the first electrode of the second transistor, and a second electrode connected to the control node.

In an embodiment, the seventh transistor may be a PMOS transistor and the eighth transistor may be an NMOS transistor.

In an embodiment, the gate output circuit may include a ninth transistor including a gate electrode electrically connected to the inversion control node, a first electrode, which receives a gate clock signal, and a second electrode connected to a gate output node from which the gate signal is output, and a tenth transistor including a gate electrode connected to the inversion control node, a first electrode, which receives the low gate voltage, and a second electrode connected to the gate output node.

In an embodiment, the ninth transistor may be a PMOS transistor and the tenth transistor may be an NMOS transistor.

In an embodiment, the inversion control node may include a first inversion control node and a second inversion control node, and the gate driver may further include a node separation circuit configured to separate the first inversion control node and the second inversion control node. The node separation circuit may include an eleventh transistor including a gate electrode, which receives the low gate voltage, a first electrode connected to the first inversion control node, and a second electrode connected to the second inversion control node.

In an embodiment, the gate driver may further include a reset circuit configured to reset the voltage of the inversion control node. The reset circuit may include a twelfth transistor including a gate electrode, which receives a reset signal, a first electrode, which receives the high gate voltage, and a second electrode connected to the inversion control node.

In an embodiment, the gate driver may further include a clock inverter circuit configured to invert the clock signal and output the inversion clock signal. The clock inverter circuit may include a thirteenth transistor including a gate electrode, which receives the clock signal, a first electrode, which receives the high gate voltage, and a second electrode configured to output the inversion clock signal, and a fourteenth transistor including a gate electrode, which receives the clock signal, a first electrode, which receives the low gate voltage, and a second electrode configured to output the inversion clock signal.

In an embodiment, the thirteenth transistor may be a PMOS transistor and the fourteenth transistor may be an NMOS transistor.

In an embodiment, the gate output circuit may include a ninth transistor including a gate electrode electrically connected to the inversion control node, a first electrode, which receives the low gate voltage, and a second electrode connected to a gate output node from which the gate signal is output, and a tenth transistor including a gate electrode connected to the control node, a first electrode, which receives the high gate voltage, and a second electrode connected to the gate output node.

In an embodiment, the ninth transistor and the tenth transistor may be PMOS transistors.

In an embodiment, the inversion control node may include a first inversion control node and a second inversion control node, and the gate driver may further include a node separation circuit configured to separate the first inversion control node and the second inversion control node. The node separation circuit may include an eleventh transistor including a gate electrode, which receives the low gate voltage, a first electrode connected to the first inversion control node, and a second electrode connected to the second inversion control node.

In an embodiment, the gate driver may further include a reset circuit configured to reset the voltage of the control node. The reset circuit may include a twelfth transistor including a gate electrode, which receives a reset signal, a first electrode, which receives the high gate voltage, and a second electrode connected to the control node.

In an embodiment, the gate driver may further include a clock inverter circuit configured to invert the clock signal and output the inversion clock signal. The clock inverter circuit may include a thirteenth transistor including a gate electrode, which receives the clock signal, a first electrode, which receives the high gate voltage, and a second electrode configured to output the inversion clock signal, and a fourteenth transistor including a gate electrode, which receives the clock signal, a first electrode, which receives the low gate voltage, and a second electrode configured to output the inversion clock signal.

In an embodiment of a display device according to the present invention, the display device includes a display panel including a pixel, a gate driver configured to provide a gate signal to the pixel, a data driver configured to provide a data voltage to the pixel, and a driving controller configured to control the gate driver and the data driver. The gate driver includes an input circuit configured to control a voltage of a control node in response to a clock signal, an inversion clock signal which is an inverted signal of the clock signal, and an input signal, an inverter circuit configured to invert the voltage of the control node and provide the inverted voltage of the control node to an inversion control node, a feedback circuit configured to invert a voltage of the inversion control node and control the voltage of the control node, and a gate output circuit configured to output a gate signal in response to the voltage of the control node or the voltage of the inversion control node.

In an embodiment of an electronic device according to the present invention, the electronic device includes a display panel including a pixel, a gate driver configured to provide a gate signal to the pixel, a data driver configured to provide a data voltage to the pixel, a driving controller configured to control the gate driver and the data driver, and a processor configured to control the driving controller. The gate driver includes an input circuit configured to control a voltage of a control node in response to a clock signal, an inversion clock signal which is an inverted signal of the clock signal, and an input signal, an inverter circuit configured to invert the voltage of the control node and provide the inverted voltage of the control node to an inversion control node, a feedback circuit configured to invert a voltage of the inversion control node and control the voltage of the control node, and a gate output circuit configured to output a gate signal in response to the voltage of the control node or the voltage of the inversion control node.

According to the gate driver, the display device, and the electronic device, since an inversion clock signal applied to a stage of the gate driver is inverted from a clock signal, the clock signal and the inversion clock signal may be generated dependently and may not have a distortion.

Furthermore, the stage of the gate driver may include an input circuit which controls a voltage of a control node, an inverter circuit which inverts the voltage of the control node and provides the inverted voltage of the control node to an inversion control node, and a feedback circuit which inverts the voltage of the inversion control node and controls the voltage of the control node. Therefore, a feedback path may be formed between the control node and the inverted control node, and the voltage of the inversion control node is determined by the voltage of the control node, but the voltage of the inverted control node may in turn affect the voltage of the control node. Accordingly, even if a toggling (i.e., a frequency) of the clock signal and a toggling of the inversion clock signal are reduced in order to reduce a power consumption of the gate driver, a node voltage of the stage of the gate driver (e.g., the voltage of the control node and the voltage of the inversion control node) may be stabilized.

### BRIEF DESCRIPTION OF THE DRAWINGS

The above and other features of embodiments of the present invention will become more apparent by describing in detailed embodiments thereof with reference to the accompanying drawings, in which:

FIG. 1 is a block diagram showing a display device according to embodiments of the present invention;

FIG. 2 is a circuit diagram showing an example of a pixel of a display panel of FIG. 1;

FIG. 3 is a circuit diagram showing an example of a pixel of a display panel of FIG. 1;

FIG. 4 is a block diagram showing a gate driver according to a comparative example;

FIG. 5 is a circuit diagram showing an example of an N-th stage of a gate driver of FIG. 4;

FIG. 6 is a circuit diagram showing an example of an N+1-th stage of a gate driver of FIG. 4;

FIG. 7 is a timing diagram showing an example of a normal operation of a gate driver of FIG. 3;

FIGS. 8 and 9 are diagrams showing an example of an abnormal operation of a gate driver of FIG. 3;

FIGS. 10 and 11 are diagrams showing an example of an abnormal operation of a gate driver of FIG. 3;

FIG. 12 is a block diagram showing a gate driver according to embodiments of the present invention;

FIG. 13 is a timing diagram showing an example of an operation of a gate driver of FIG. 12;

FIG. 14 is a circuit diagram showing an example of stages included in a gate driver of FIG. 12;

FIG. 15 is a timing diagram showing an example of an operation of a stage of FIG. 14;

FIG. 16 is a circuit diagram showing an example of an operation of a stage of FIG. 14 in a first period of FIG. 15;

FIG. 17 is a circuit diagram showing an example of an operation of a stage of FIG. 14 in a second period of FIG. 15;

FIG. 18 is a circuit diagram showing an example of an operation of a stage of FIG. 14 in a third period of FIG. 15;

FIG. 19 is a circuit diagram showing an example of an operation of a stage of FIG. 14 in a fourth period of FIG. 15;

FIG. 20 is a circuit diagram showing an example of an operation of a stage of FIG. 14 in a fifth period of FIG. 15;

FIG. 21 is a circuit diagram showing an example of a stage included in a gate driver of FIG. 12;

FIG. 22 is a block diagram showing a gate driver according to embodiments of the present invention;

FIG. 23 is a timing diagram showing an example of an operation of a gate driver of FIG. 22;

FIG. 24 is a circuit diagram showing an example of a stage included in a gate driver of FIG. 22;

FIG. 25 is a timing diagram showing an example of an operation of a stage of FIG. 24;

FIG. 26 is a circuit diagram showing an example of an operation of a stage of FIG. 24 in a first period of FIG. 25;

FIG. 27 is a circuit diagram showing an example of an operation of a stage of FIG. 24 in a second period of FIG. 25;

FIG. 28 is a circuit diagram showing an example of an operation of a stage of FIG. 24 in a third period of FIG. 25;

FIG. 29 is a circuit diagram showing an example of an operation of a stage of FIG. 24 in a fourth period of FIG. 25;

FIG. 30 is a circuit diagram showing an example of a stage included in a gate driver of FIG. 22;

FIG. 31 is a block diagram showing a gate driver according to embodiments of the present invention;

FIG. 32 is a timing diagram showing an example of an operation of a gate driver of FIG. 31;

FIG. 33 is a circuit diagram showing an example of a stage included in a gate driver of FIG. 31;

FIG. 34 is a timing diagram showing an example of an operation of a stage of FIG. 33;

FIG. 35 is a circuit diagram showing an example of an operation of a stage of FIG. 33 in a first period of FIG. 34;

FIG. 36 is a circuit diagram showing an example of an operation of a stage of FIG. 33 in a second period of FIG. 34;

FIG. 37 is a circuit diagram showing an example of an operation of a stage of FIG. 33 in a third period of FIG. 34;

FIG. 38 is a circuit diagram showing an example of an operation of a stage of FIG. 33 in a fourth period of FIG. 34;

FIG. 39 is a circuit diagram showing an example of a stage included in a gate driver of FIG. 31;

FIG. 40 is a block diagram showing an electronic device according to an embodiment of the present invention;

FIG. 41 is a diagram showing an example in which the electronic device of FIG. 40 is implemented as a smart phone;

FIG. 42 is a block diagram showing an electronic device 10 according to an embodiment of the present invention; and

FIG. 43 is schematic diagrams showing electronic devices of FIG. 42.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Hereinafter, the present invention will be described in more detail with reference to the accompanying drawings.

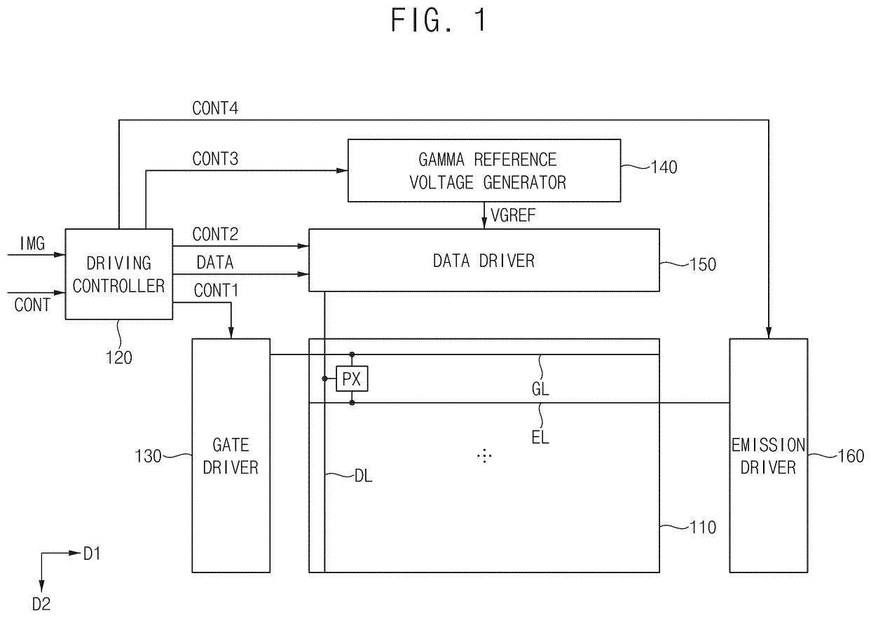

FIG. 1 is a block diagram showing a display device according to embodiments of the present invention.

Referring to FIG. 1, a display device may include a display panel 110 and a display panel driver. The display panel driver may include a driving controller 120, a gate driver 130, a gamma reference voltage generator 140, and a data driver 150. The display panel driver may further include an emission driver 160.

For example, the driving controller 120 and the data driver 150 may be formed integrally. For example, the driving controller 120, the gamma reference voltage generator 140, and the data driver 150 may be formed integrally. For example, the driving controller 120, the gate driver 130, the gamma reference voltage generator 140, and the data driver 150 may be formed integrally. For example, the driving controller 120, the gate driver 130, the gamma reference voltage generator 140, the data driver 150, and the emission driver 160 may be formed integrally. Meanwhile, a driving module in which at least the driving controller 120 and the data driver 150 are formed integrally may be named a timing controller embedded data driver (TED).

The display panel 110 may include a display area for displaying an image and a peripheral area disposed adjacent to the display area.

For example, the display panel 110 may be an organic light-emitting diode display panel including an organic light emitting diode. For example, the display panel 110 may be a quantum-dot organic light emitting diode display panel including an organic light emitting diode and a quantum-dot color filter. For example, the display panel 110 may be a quantum-dot nano light emitting diode display panel including a nano light emitting diode and a quantum-dot color filter.

The display panel 110 may include gate lines GL, data lines DL, emission lines EL, and pixels PX electrically connected to the gate lines GL, the data lines DL, and the emission lines EL, respectively. The gate lines GL may extend in a first direction D1, the data lines DL may extend in a second direction D2 crossing the first direction D1, and the emission lines EL may extend in the first direction D1.

The driving controller 120 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 120 may generate a first control signal CONT1, a second control signal CONT2, a third control signal CONT3, a fourth control signal CONT4, and a data signal DATA based on the input image data IMG and the input control signal CONT.

The driving controller 120 may generate the first control signal CONT1 for controlling an operation of the gate driver 130 based on the input control signal CONT, and output the first control signal CONT1 to the gate driver 130. The first control signal CONT1 may include a vertical start signal and a gate clock signal.

The driving controller 120 may generate the second control signal CONT2 for controlling an operation of the data driver 150 based on the input control signal CONT, and output the second control signal CONT2 to the data driver 150. The second control signal CONT2 may include a horizontal start signal and a load signal.

The driving controller 120 may generate the data signal DATA based on the input image data IMG. The driving controller 120 may output the data signal DATA to the data driver 150.

The driving controller 120 may generate the third control signal CONT3 for controlling an operation of the gamma reference voltage generator 140 based on the input control signal CONT, and output the third control signal CONT3 to the gamma reference voltage generator 140.

The driving controller 120 may generate the fourth control signal CONT4 for controlling an operation of the emission driver 160 based on the input control signal CONT, and output the fourth control signal CONT4 to the emission driver 160.

The gate driver 130 may generate gate signals for driving the gate lines GL in response to the first control signal CONT1 received from the driving controller 120. The gate driver 130 may output the gate signals to the gate lines GL.

In an embodiment, the gate driver 130 may be integrated into the peripheral area of the display panel 110. In an embodiment, the gate driver 130 may be mounted into the peripheral area of the display panel 110.

The gamma reference voltage generator 140 may generate a gamma reference voltage VGREF in response to the third control signal CONT3 received from the driving controller 120. The gamma reference voltage generator 140 may provide the gamma reference voltage VGREF to the data driver 150. The gamma reference voltage VGREF may have a value corresponding to each data signal DATA.

For example, the gamma reference voltage generator 140 may be disposed within the driving controller 120 or may be disposed within the data driver 150.

The data driver 150 may receive the second control signal CONT2 and the data signal DATA from the driving controller 120, and receive the gamma reference voltage VGREF from the gamma reference voltage generator 140. The data driver 150 may convert the data signal DATA into a data voltage having an analog type using the gamma reference voltage VGREF. The data driver 150 may output the data voltage to the data line DL.

In an embodiment, the data driver 150 may be integrated into the peripheral area of the display panel 110. In an embodiment, the data driver 150 may be mounted in the peripheral area of the display panel 110.

The emission driver 160 may generate emission signals for driving the emission lines EL in response to the fourth control signal CONT4 received from the driving controller 120. The emission driver 160 may output the emission signals to the emission lines EL.

In an embodiment, the emission driver 160 may be integrated in the peripheral area of the display panel 110. In an embodiment, the emission driver 160 may be mounted in the peripheral area of the display panel 110.

In FIG. 1, for a convenience of an explanation, the gate driver 130 may be disposed on a first side of the display panel 110 and the emission driver 160 may be disposed on a second side of the display panel 110. Although shown, the present invention is not limited thereto. For example, both the gate driver 130 and the emission driver 160 may be disposed on the first side of the display panel 110. For example, both the gate driver 130 and the emission driver 160 may be disposed on both sides of the display panel 110. For example, the gate driver 130 and the emission driver 160 may be formed integrally.

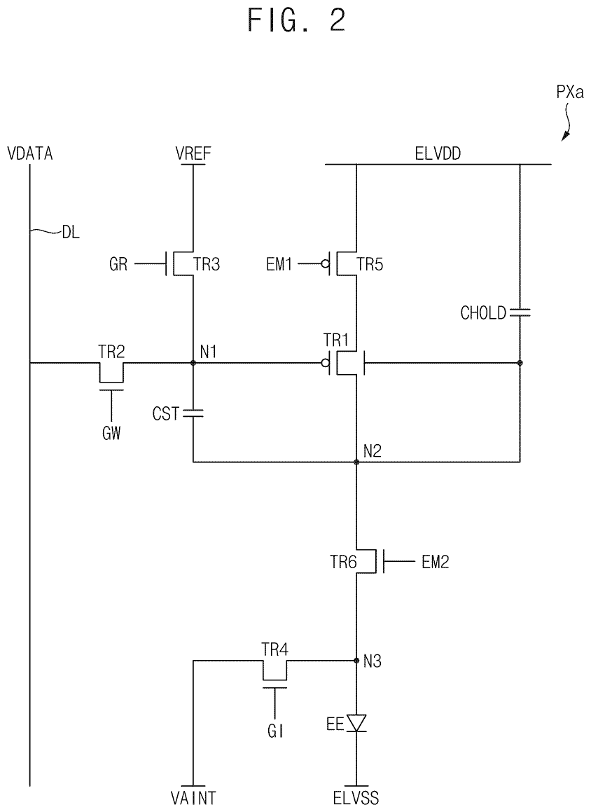

FIG. 2 is a circuit diagram showing an example PXa of a pixel PX of a display panel 110 of FIG. 1.

Referring to FIGS. 1 and 2, a pixel PXa may include a first transistor TR1, a second transistor TR2, a third transistor TR3, a fourth transistor TR4, a fifth transistor TR5, a sixth transistor TR6, a storage capacitor CST, a hold capacitor CHOLD, and a light emitting element EE.

In an embodiment, the fifth transistor TR5 may be a PMOS transistor, and the first transistor TR1, the second transistor TR2, the third transistor TR3, the fourth transistor TR4, and the sixth transistor TR6 may be NMOS transistors.

The PMOS transistor may be turned on when a gate-source voltage of the PMOS transistor is less than or equal to a threshold voltage (e.g., a negative value) of the PMOS transistor. On the other hand, the PMOS transistor may be turned off when the gate-source voltage of the PMOS transistor is greater than the threshold voltage of the PMOS transistor. For example, when a gate signal having a low level is applied to a gate electrode of the PMOS transistor, the PMOS transistor may be turned on. For example, when a gate signal having a high level is applied to the gate electrode of the PMOS transistor, the PMOS transistor may be turned off.

The NMOS transistor may be turned on when the gate-source voltage of the NMOS transistor is greater than or equal to the threshold voltage (e.g., a positive value) of the NMOS transistor. On the other hand, the NMOS transistor may be turned off when the gate-source voltage of the NMOS transistor is less than the threshold voltage of the NMOS transistor. For example, when a gate signal having the high level is applied to the gate electrode of the NMOS transistor, the PMOS transistor may be turned on. For example, when a gate signal having the low level is applied to the gate electrode of the PMOS transistor, the NMOS transistor may be turned off.

The first transistor TR1 may include a gate electrode connected to a first node N1, a first electrode, a second electrode connected to a second node N2, and a back gate electrode connected to the second node N2. The first transistor TR1 may be turned on based on a voltage of the first node N1 and a voltage of the second node N2 to generate a driving current. Specifically, the first transistor TR1 may generate the driving current based on a difference between the voltage of the first node N1 and the voltage of the second node N2. Therefore, as the difference between the voltage of the first node N1 and the voltage of the second node N2 is large, a magnitude of the driving current may be large. For example, the first transistor TR1 may be referred to as a driving transistor.

The second transistor TR2 may include a gate electrode, which receives a data write gate signal GW, a first electrode connected to a data line DL transmitting a data voltage VDATA, and a second electrode connected to the first node N1. The second transistor TR2 may be turned on in response to a data write gate signal GW having the high level to provide the data voltage VDATA to the first node N1. For example, the second transistor TR2 may be referred to as a data write transistor.

The third transistor TR3 may include a gate electrode, which receives a reset gate signal GR, a first electrode, which receives a reference voltage VREF, and a second electrode connected to the first node N1. The third transistor TR3 may be turned on in response to a reset gate signal GR having the high level to provide the reference voltage VREF to the first node N1. For example, the third transistor TR3 may be referred to as a reset transistor.

The fourth transistor TR4 may include a gate electrode, which receives an initialization gate signal GI, a first electrode, which receives an initialization voltage VAINT, and a second electrode connected to a third node N3. The fourth transistor TR4 may be turned on in response to the initialization gate signal GI having the high level to provide the initialization voltage VINT to the first node N1. For example, the fourth transistor TR4 may be referred to as an initialization transistor.

The fifth transistor TR5 may include a gate electrode, which receives a first emission signal EM1, a first electrode, which receives a first power supply voltage ELVDD, and a second electrode connected to the first electrode of the first transistor TR1. The sixth transistor TR6 may include a gate electrode, which receives a second emission signal EM2, a first electrode connected to the second node N2, and a second electrode connected to a third node N3. When the fifth transistor TR5 is turned on in response to a first emission signal EM1 having the low level and the sixth transistor TR6 is turned on in response to a second emission signal EM2 having the high level, the driving current may be applied to the light emitting element EE. For example, the fifth transistor TR5 may be referred to as a first light-emitting control transistor, and the sixth transistor TR6 may be referred to as a second light-emitting control transistor.

The storage capacitor CST may include a first electrode connected to the first node N1 and a second electrode connected to the second node N2. The storage capacitor CST may store the data voltage VDATA.

The hold capacitor CHOLD may include a first electrode, which receives the first power supply voltage ELVDD and a second electrode connected to the second node N2. The hold capacitor CHOLD may hold the voltage of the second node N2.

The light emitting element EE may include an anode electrode connected to the third node N3 and a cathode electrode, which receives a second power supply voltage ELVSS. The light emitting element EE may emit a light based on the driving current. As the magnitude of the driving current is large, a luminance corresponding to a light emission intensity of the light emitting element EE may be large.

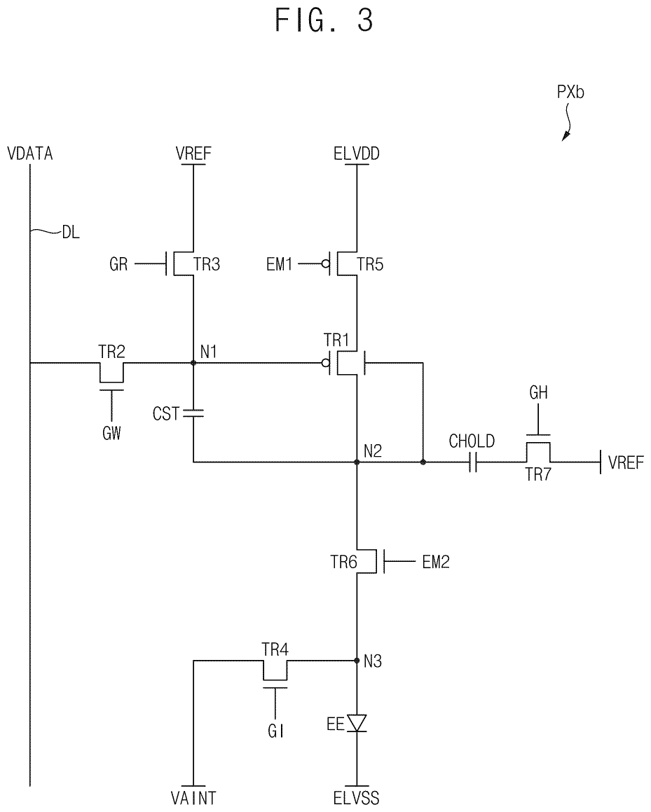

FIG. 3 is a circuit diagram showing an example of a pixel PXb of a display panel 110 of FIG. 1.

Referring to FIGS. 1 to 3, a pixel PXb may include a first transistor TR1, a second transistor TR2, a third transistor TR3, a fourth transistor TR4, a fifth transistor TR5, a sixth transistor TR6, a seventh transistor TR7, a storage capacitor CST, a hold capacitor CHOLD, and a light emitting element EE.

The pixel PXb of FIG. 3 is substantially equal to the pixel PXa of FIG. 2, except for the hold capacitor CHOLD and the seventh transistor TR7. Therefore, excluding the hold capacitor CHOLD and the seventh transistor TR7, a duplicate description of the first transistor TR1, the second transistor TR2, the third transistor TR3, the fourth transistor TR4, the fifth transistor TR5, the sixth transistor TR6, the storage capacitor CST, and the light emitting element EE will be omitted.

In an embodiment, the seventh transistor TR7 may be an NMOS transistor.

The seventh transistor TR7 may include a gate electrode, which receives a second reset gate signal GH, a first electrode, which receives a reference voltage VREF, and a second electrode. The seventh transistor TR7 may be turned on in response to a second reset gate signal GH having a high level to output the reference voltage VREF. For example, the seventh transistor TR7 may be referred to as a second reset transistor.

The hold capacitor CHOLD may include a first electrode connected to the second electrode of the seventh transistor TR7 and a second electrode connected to a second node N2. The hold capacitor CHOLD may hold a voltage of the second node N2.

The pixel PX of FIG. 1 is not limited to the pixel PXa of FIG. 2 and the pixel PXb of FIG. 3 and may have any pixel structure.

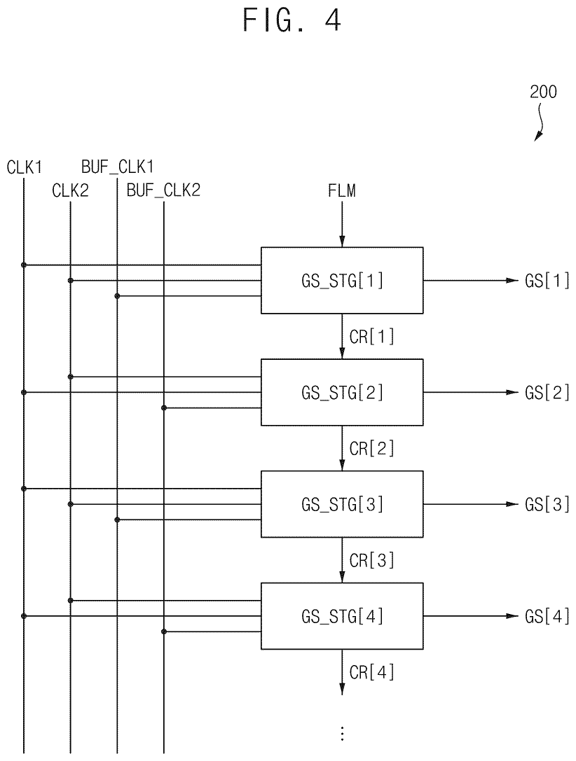

FIG. 4 is a block diagram showing a gate driver 200 according to a comparative example.

Referring to FIGS. 1 to 4, a gate driver 200 according to a comparative example may include a plurality of stages GS_STG[1], GS_STG[2], GS_STG[3], GS_STG[4], . . . . The gate driver 200 may be implemented in a form of a shift register in which the stages GS_STG[1], GS_STG[2], GS_STG[3], GS_STG[4], . . . sequentially output gate signals GS[1], GS[2], GS[3], GS[4], . . . .

The stages GS_STG[1], GS_STG[2], GS_STG[3], GS_STG[4], . . . may receive a gate start signal FLM, a first clock signal CLK1, a second clock signal CLK2, a first gate clock signal BUF_CLK1, and a second gate clock signal BUF_CLK2. The first clock signal CLK1 and the second clock signal CLK2 may have different phases. For example, the first clock signal CLK1 and the second clock signal CLK2 may have opposite phases. The first gate clock signal BUF_CLK1 and the second gate clock signal BUF_CLK2 may have different phases. For example, the first gate clock signal BUF_CLK1 and the second gate clock signal BUF_CLK2 may have opposite phases.

Each of the stages GS_STG[1], GS_STG[2], GS_STG[3], GS_STG[4], . . . . may alternately receive the first clock signal CLK1 and the second clock signal CLK2. In an embodiment, a first clock terminal of an odd-numbered stage GS_STG[1], GS_STG[3], . . . may receive the first clock signal CLK1, and a second clock terminal of the odd-numbered stage GS_STG[1], GS_STG[3], . . . may receive the second clock signal CLK2. In an embodiment, a first clock terminal of an even-numbered stage GS_STG[2], GS_STG[4], . . . may receive the second clock signal CLK2, and a second clock terminal of the even-numbered stage GS_STG[2], GS_STG[4], . . . may receive the first clock signal CLK1. For example, a first clock terminal of a first stage GS_STG[1] may receive the first clock signal CLK1, and a second clock terminal of the first stage GS_STG[1] may receive the second clock signal CLK2. For example, a first clock terminal of a second stage GS_STG[2] may receive the second clock signal CLK2, and a second clock terminal of the second stage GS_STG[2] may receive the first clock signal CLK1. For example, a first clock terminal of a third stage GS_STG[3] may receive the first clock signal CLK1, and a second clock terminal of the third stage GS_STG[3] may receive the second clock signal CLK2. For example, the first clock terminal of the fourth stage GS_STG[4] may receive the second clock signal CLK2, and the second clock terminal of the fourth stage GS_STG[4] may receive the first clock signal CLK1.

Each of the stages GS_STG[1], GS_STG[2], GS_STG[3], GS_STG[4], . . . may receive an input signal (e.g., a gate start signal FLM or a previous carry signal CR[1], CR[2], CR[3], CR[4], . . . ) in response to the first clock signal CLK1 and the second clock signal CLK2. Each of the stages GS_STG[1], GS_STG[2], GS_STG[3], GS_STG[4], . . . may initiate an operation in response to the input signal. In an embodiment, an input terminal of the first stage GS_STG[1] may receive the gate start signal FLM. In an embodiment, an input terminal of each of subsequent stages GS_STG[2], GS_STG[3], GS_STG[4], . . . may receive a carry signal of a previous stage. For example, an input terminal of the second stage GS_STG[2] may receive a first carry signal CR[1] of the first stage GS_STG[1]. For example, the third stage GS_STG[3] may receive a second carry signal CR[2] of the second stage GS_STG[2]. For example, the fourth stage GS_STG[4] may receive a third carry signal CR[3] of the third stage GS_STG[3].

Each of the stages GS_STG[1], GS_STG[2], GS_STG[3], GS_STG[4], . . . may alternately receive the first gate clock signal BUF_CLK1 and the second gate clock signal BUF_CLK2. In an embodiment, a gate clock terminal of the odd-numbered stage GS_STG[1], GS_STG[3], . . . may receive the first gate clock signal BUF_CLK1. In an embodiment, a gate clock terminal of the even-numbered stage GS_STG[2], GS_STG[4], . . . may receive the second gate clock signal BUF_CLK2. For example, a gate clock terminal of the first stage GS_STG[1] may receive the first gate clock signal BUF_CLK1. For example, a gate clock terminal of the second stage GS_STG[2] may receive the second gate clock signal BUF_CLK2. For example, a gate clock terminal of the third stage GS_STG[3] may receive the first gate clock signal BUF_CLK1. For example, a gate clock terminal of the fourth stage GS_STG[4] may receive the second gate clock signal BUF_CLK2.

The stages GS_STG[1], GS_STG[2], GS_STG[3], GS_STG[4], . . . may sequentially output carry signals CR[1], CR[2], CR[3], CR[4], . . . in response to the first clock signal CLK1 and the second clock signal CLK2. For example, a carry output terminal of the first stage GS_STG[1] may output the first carry signal CR[1]. For example, a carry output terminal of the second stage GS_STG[2] may output the second carry signal CR[2]. For example, a carry output terminal of the third stage GS_STG[3] may output the third carry signal CR[3]. For example, a carry output terminal of the fourth stage GS_STG[4] may output the fourth carry signal CR[4].

The stages GS_STG[1], GS_STG[2], GS_STG[3], GS_STG[4], . . . may sequentially output the gate signals GS[1], GS[2], GS[3], GS[4], . . . in response to the first clock signal CLK1, the second clock signal CLK2, the first gate clock signal BUF_CLK1, and the second gate clock signal BUF_CLK2. For example, a gate output terminal of the first stage GS_STG[1] may output a first gate signal GS[1]. For example, a gate output terminal of the second stage GS_STG[2] may output the second gate signal GS[2]. For example, a gate output terminal of the third stage GS_STG[3] may output the third gate signal GS[3]. For example, a gate output terminal of the fourth stage GS_STG[4] may output the fourth gate signal GS[4].

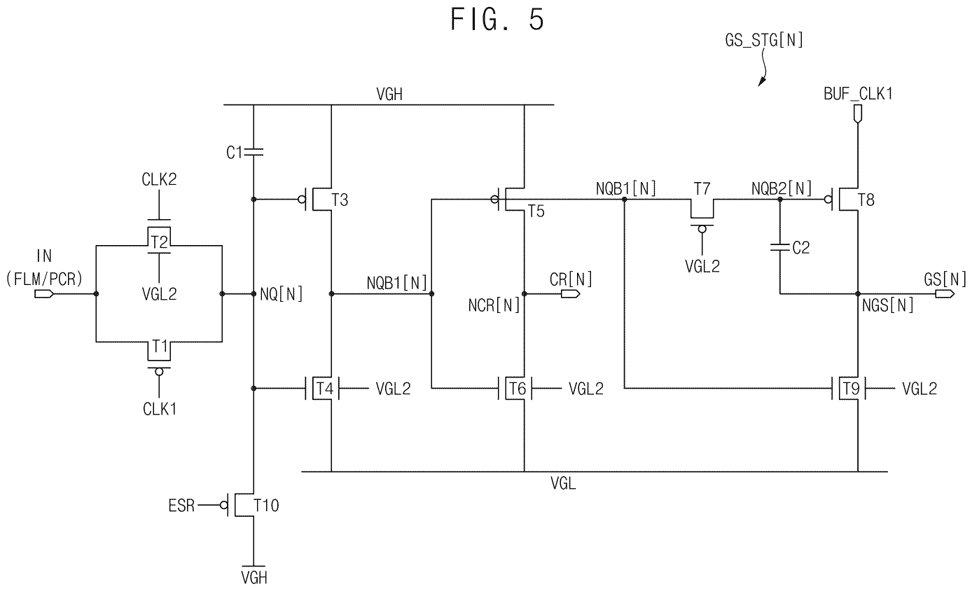

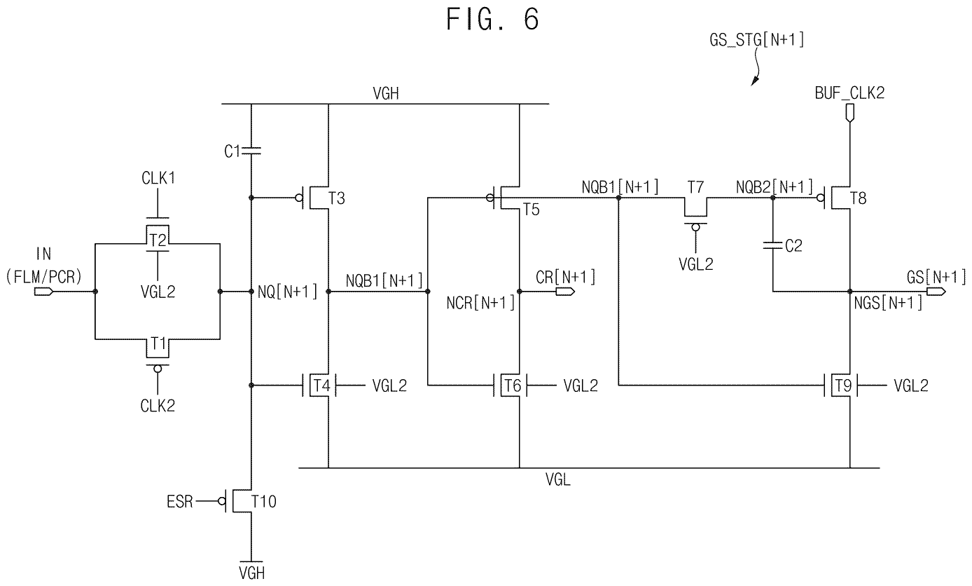

FIG. 5 is a circuit diagram showing an example of an N-th stage GS_STG[N] of a gate driver 200 of FIG. 4. FIG. 6 is a circuit diagram showing an example of an N+1-th stage GS_STG[N+1] of a gate driver 200 of FIG. 4.

An N-th stage GS_STG[N] of FIG. 5 may be an odd-numbered stage of FIG. 4, and an N+1-th stage GS_STG[N+1] of FIG. 6 may be a subsequent stage to the N-th stage GS_STG[N] of FIG. 5. Here, N is a positive integer greater than or equal to 1.

Referring to FIGS. 1 to 4 and FIG. 5, the N-th stage GS_STG[N] of FIG. 5 may include a first transistor T1, a second transistor T2, a third transistor T3, a fourth transistor T4, a fifth transistor T5, a sixth transistor T6, a seventh transistor T7, an eighth transistor T8, a ninth transistor T9, a tenth transistor T10, a first capacitor C1, and a second capacitor C2.

In an embodiment, the first transistor T1, the third transistor T3, the fifth transistor T5, the seventh transistor T7, the eighth transistor T8, and the tenth transistor T10 may be PMOS transistors, and the second transistor T2, the fourth transistor T4, the sixth transistor T6, and the ninth transistor T9 may be NMOS transistors.

The first transistor T1 may include a gate electrode, which receives a first clock signal CLK1, a first electrode, which receives an input signal IN, and a second electrode connected to a control node NQ[N]. The input signal IN may be a gate start signal FLM or a previous carry signal PCR. The first transistor T1 may be turned on in response to a first clock signal CLK1 having a low level to provide the input signal IN to the control node NQ[N].

The second transistor T2 may include a gate electrode, which receives a second clock signal CLK2, a first electrode, which receives the input signal IN, and a second electrode connected to the control node NQ[N]. The second transistor T2 may further include a back gate electrode, which receives a second low gate voltage VGL2. The second transistor T2 may be turned on in response to a second clock signal CLK2 having a high level to provide the input signal IN to the control node NQ[N].

The first clock signal CLK1 and the second clock signal CLK2 may have different phases. For example, the first clock signal CLK1 and the second clock signal CLK2 may have opposite phases.

The first transistor T1 and the second transistor T2 may constitute an input circuit. Since the first clock signal CLK1 and the second clock signal CLK2 have opposite phases, the first transistor T1 and the second transistor T2 may be turned on simultaneously to provide the input circuit IN to the control node NQ[N], or the first transistor T1 and the second transistor T2 may be turned off simultaneously.

The third transistor T3 may include a gate electrode connected to the control node NQ[N], a first electrode, which receives a high gate voltage VGH, and a second electrode connected to an inversion control node NQB1[N], NQB2[N]. The third transistor T3 may be turned on in response to a voltage of the control node NQ[N] having the low level to provide the high gate voltage VGH to the inversion control node NQB1[N], NQB2[N].

The fourth transistor T4 may include a gate electrode connected to the control node NQ[N], a first electrode, which receives a low gate voltage VGL, and a second electrode connected to the inversion control node NQB1[N], NQB2[N]. The fourth transistor T4 may further include a back gate electrode, which receives the second low gate voltage VGL2. The fourth transistor T4 may be turned on in response to the voltage of the control node NQ[N] having the high level to provide the low gate voltage VGL to the inversion control node NQB1[N], NQB2[N]. The low gate voltage VGL may be greater than the second low gate voltage VGL2.

The third transistor T3 and the fourth transistor T4 may constitute an inverter circuit. The third transistor T3 and the fourth transistor T4 may invert the voltage of the control node NQ[N] to control a voltage of the inversion control node NQB1[N], NQB2[N]. For example, the third transistor T3 and the fourth transistor T4 may invert the voltage of the control node NQ[N] having the high level to control the voltage of the inversion control node NQB1[N], NQB2[N] to the low level. For example, the third transistor T3 and the fourth transistor T4 may invert the voltage of the control node NQ[N] having the low level to control the voltage of the inversion control node NQB1[N], NQB2[N] to the high level.

The fifth transistor T5 may include a gate electrode connected to the inversion control node NQB1[N], NQB2[N], a first electrode, which receives the high gate voltage VGH, and a second electrode connected to a carry output node NCR[N] from which a carry signal CR[N] is output. The fifth transistor T5 may be turned on in response to the voltage of the inversion control node NQB1[N], NQB2[N] having the low level to provide the high gate voltage VGH to the carry output node NCR[N].

The sixth transistor T6 may include a gate electrode connected to the inversion control node NQB1[N], NQB2[N], a first electrode, which receives the low gate voltage VGL, and a second electrode connected to a carry output node NCR[N] from which a carry signal CR[N] is output. The sixth transistor T6 may further include a back gate electrode, which receives the second low gate voltage VGL2. The sixth transistor T6 may be turned on in response to the voltage of the inversion control node NQB1[N], NQB2[N] having the high level to provide the low gate voltage VGL to the carry output node NCR[N].

The fifth transistor T5 and the sixth transistor T6 may constitute a carry output circuit, and the carry output circuit may operate as the inverter circuit. The fifth transistor T5 and the sixth transistor T6 may invert the voltage of the inversion control node NQB1[N], NQB2[N] to control a voltage of the carry output node NCR[N]. For example, the fifth transistor T5 and the sixth transistor T6 may invert the voltage of the inversion control node NQB1[N], NQB2[N] having the high level to control the voltage of the carry output node NCR[N] to the low level. For example, the fifth transistor T5 and the sixth transistor T6 may invert the voltage of the inversion control node NQB1[N], NQB2[N] having the low level to control the voltage of the carry output node NCR[N] to the high level. The voltage of the carry output node NCR[N] may be output as the carry signal CR[N].

The inversion control node NQB1[N], NQB2[N] may include a first inversion control node NQB1[N] and a second inversion control node NQB2[N].

The seventh transistor T7 may include a gate electrode, which receives the second low gate voltage VGL2, a first electrode connected to the first inversion control node NQB1[N], and a second electrode connected to the second inversion control node NQB2[N]. Since the seventh transistor T7 is turned on in response to the second low gate voltage VGL2, the seventh transistor T7 may be an always-on transistor (AOT). Since the seventh transistor T7 is the always-on transistor and the PMOS transistor, the seventh transistor T7 may prevent a bootstrapped voltage of the second inversion control node NQB2[N] from being provided to the first inversion control node NQB1[N].

The eighth transistor T8 may include a gate electrode connected to the inversion control node NQB1[N], NQB2[N], a first electrode, which receives a first gate clock signal BUF_CLK1, and a second electrode connected to a gate output node NGS[N] from which a gate signal GS[N] is output. The eighth transistor T8 may be turned on in response to the voltage of the inversion control node NQB1[N], NQB2[N] to provide the first gate clock signal BUF_CLK1 to the gate output node NGS[N].

The ninth transistor T9 may include a gate electrode connected to the inversion control node NQB1[N], NQB2[N], a first electrode, which receives the low gate voltage VGL, and a second electrode connected to the gate output node NGS[N]. The ninth transistor T9 may further include a back gate electrode, which receives the second low gate voltage VGL2. The ninth transistor T9 may be turned on in response to the voltage of the inversion control node NQB1[N], NQB2[N] to provide the low gate voltage VGL to the gate output node NGS[N].

The eighth transistor T8 and the ninth transistor T9 may constitute a gate output circuit, and the gate output circuit may operate as the inverter circuit. The eighth transistor T8 and the ninth transistor T9 may invert the voltage of the inversion control node NQB1[N], NQB2[N] to control a voltage of the gate output node NGS[N]. For example, the eighth transistor T8 and the ninth transistor T9 may invert the voltage of the inversion control node NQB1[N], NQB2[N] having the high level to control the voltage of the gate output node NGS[N] to the low level. For example, the eighth transistor T8 and the ninth transistor T9 may invert the voltage of the inversion control node NQB1[N], NQB2[N] having the low level to control the voltage of the gate output node NGS[N] to the high level. The voltage of the gate output node NGS[N] may be output as the gate signal GS[N].

The tenth transistor T10 may include a gate electrode, which receives a reset signal ESR, a first electrode, which receives the high gate voltage VGH, and a second electrode connected to the control node NQ[N]. The tenth transistor T10 may be turned on in response to a reset signal ESR having the low level to provide the high gate voltage VGH to the control node NQ[N]. Accordingly, the voltage of the control node NQ[N] may be initialized to the high gate voltage VGH. The reset signal ESR may be a global signal which is simultaneously applied to the plurality of stages GS_STG[1], GS_STG[2], GS_STG[3], GS_STG[4], . . . included in the gate driver 200 of FIG. 4. For example, when a display device is turned on, the reset signal ESR may be simultaneously applied to the stages GS_STG[1], GS_STG[2], GS_STG[3], GS_STG[4], . . . . Accordingly, node voltages of the stages GS_STG[1], GS_STG[2], GS_STG[3], GS_STG[4], . . . may be initialized, and a reliability of an operation of the gate driver 200 may be maintained.

The first capacitor C1 may include a first electrode, which receives the high gate voltage VGH and a second electrode connected to the control node NQ[N].

The second capacitor C2 may include a first electrode connected to the inversion control node NQB1[N], NQB2[N] and a second electrode connected to the gate output node NGS[N].

Referring to FIGS. 1 to 4 and FIG. 6, the N+1-th stage GS_STG[N+1] of FIG. 6 may include a first transistor T1, a second transistor T2, a third transistor T3, a fourth transistor T4, a fifth transistor T5, a sixth transistor T6, a seventh transistor T7, an eighth transistor T8, a ninth transistor T9, a tenth transistor T10, a first capacitor C1, and a second capacitor C2.

The N+1-th stage GS_STG[N+1] of FIG. 6 is substantially equal to the N-th stage GS_STG[N] of FIG. 5, except for a clock signal CLK1, CLK2 applied to a gate electrode of the first transistor T1, a clock signal CLK1, CLK2 applied to a gate electrode of the second transistor T2, and a gate clock signal BUF_CLK1, BUF_CLK2 applied to a first electrode of the eighth transistor T8. Therefore, except for the clock signal CLK1, CLK2 applied to the gate electrode of the first transistor T1, the clock signal CLK1, CLK2 applied to the gate electrode of the second transistor T2, and the gate clock signal BUF_CLK1, BUF_CLK2 applied to the first electrode of the eighth transistor T8, a duplicate description of the third transistor T3, the fourth transistor T4, the fifth transistor T5, the sixth transistor T6, the seventh transistor T7, the ninth transistor T9, the tenth transistor T10, the first capacitor C1, and the second capacitor C2 will be omitted.

The first transistor T1 may include a gate electrode, which receives a second clock signal CLK2, a first electrode, which receives an input signal IN, and a second electrode connected to a control node NQ[N+1].

The second transistor T2 may include a gate electrode, which receives a first clock signal CLK1, a first electrode, which receives the input signal IN, and a second electrode connected to the control node NQ[N+1].

The eighth transistor T8 may include a gate electrode connected to an inversion control node NQB1[N+1], NQB2[N+1], a first electrode, which receives a second gate clock signal BUF_CLK2, and a second electrode connected to a gate output node NGS[N+1] from which a gate signal GS[N+1] is output.

That is, as described in FIG. 4, each of the N-th stage GS_STG[N] and the N+1-th stage GS_STG[N+1] may alternately receive the first clock signal CLK1 and the second clock signal CLK2, and each of the N-th stage GS_STG[N] and the N+1-th stage GS_STG[N+1] may alternately receive the first gate clock signal BUF_CLK1 and the second gate clock signal BUF_CLK2.

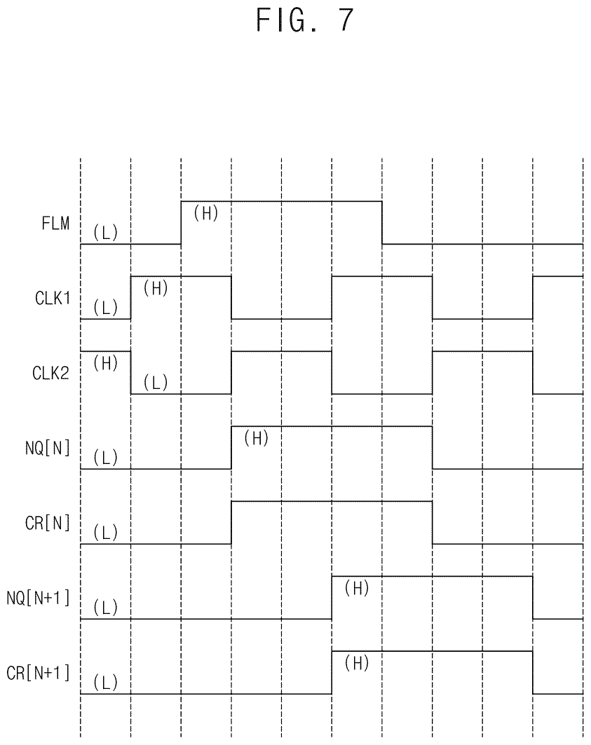

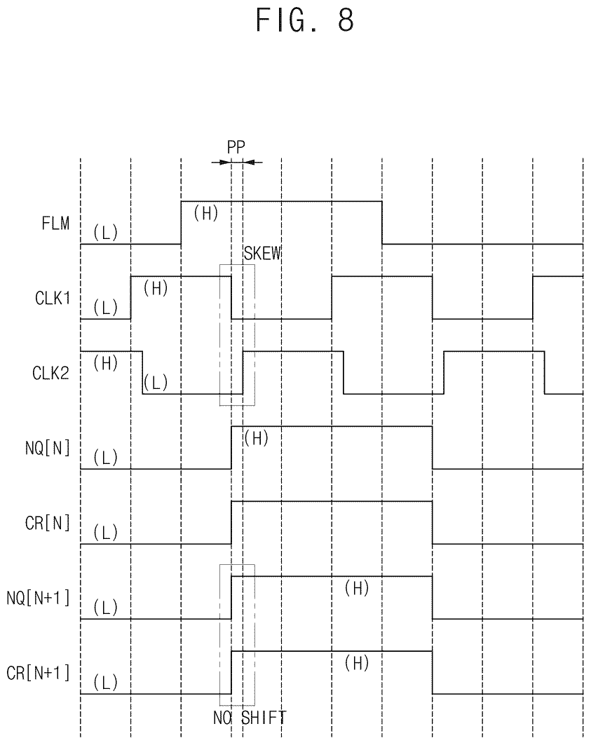

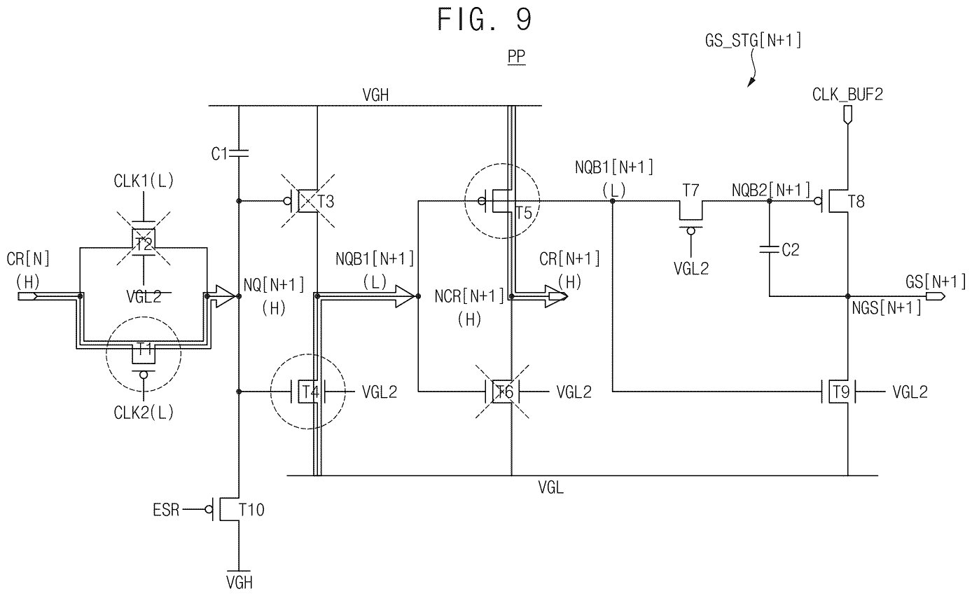

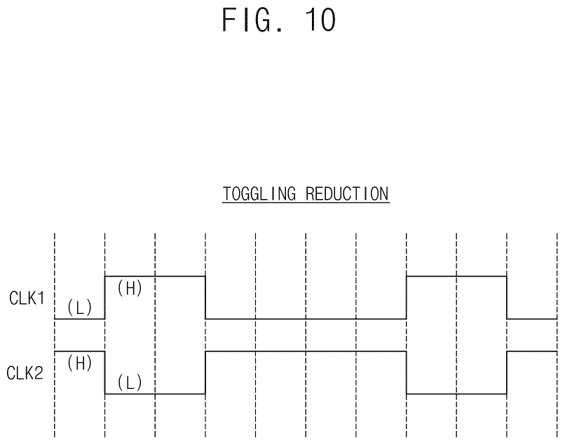

FIG. 7 is a timing diagram showing an example of a normal operation of a gate driver 200 of FIG. 3. FIGS. 8 and 9 are diagrams showing an example of an abnormal operation of a gate driver 200 of FIG. 3. FIGS. 10 and 11 are diagrams showing an example of an abnormal operation of a gate driver 200 of FIG. 3.

Referring to FIGS. 1 to 6 and 7, the gate driver 200 of FIG. 3 may sequentially change the voltage of the control node NQ[N], NQ[N+1] in response to the first clock signal CLK1 and the second clock signal CLK2, and may sequentially output the carry signal CR[N], CR[N+1] in response to the first clock signal CLK1 and the second clock signal CLK2.

Since the first clock signal CLK1 and the second clock signal CLK2 have opposite phases and are aligned, the gate driver 200 may operate normally.

Referring to FIGS. 1 to 7 and 8 to 9, the first clock signal CLK1 and the second clock signal CLK2 may not have opposite phases and may have a distortion. That is, the first clock signal CLK1 and the second clock signal CLK2 may be out of sync with each other. For example, in a problem period PP, the first clock signal CLK1 and the second clock signal CLK2 may not have the opposite phases and may have the low level L.

In this case, the N-th stage GS_STG[N] of FIG. 5 may operate normally to change the voltage of the control node NQ[N], and may output the carry signal CR[N]. However, as shown in FIG. 9, in the N+1-th stage GS_STG[N+1] of FIG. 6, due to the misalignment between the first clock signal CLK1 and the second clock signal CLK2, the first transistor T1 and the second transistor T2 may not be turned off at a same time, and the second transistor T2 may be turned on in response to the second clock signal CLK2 having the low level L to provide the previous carry signal CR[N] having the high level H to the control node NQ[N+1], and a voltage of the control node NQ[N+1] may have the high level H.

The third transistor T3 may be turned off in response to the voltage of the control node NQ[N+1] having the high level H.

The fourth transistor T4 may be turned on in response to the voltage of the control node NQ[N+1] having the high level H to provide the low gate voltage VGL to an inversion control node NQB1[N+1], NQB2[N+1]. Therefore, a voltage of the inversion control node NQB1[N+1], NQB2[N+1] may have the low level L.

The fifth transistor T5 may be turned on in response to the voltage of the inversion control node NQB1[N+1], NQB2[N+1] having the low level L to provide the high gate voltage VGH to a carry output node NCR[N+1]. Therefore, a voltage of the carry output node NCR[N+1] may have the high level H, and the carry signal CR[N+1] may have the high level H.

That is, the gate driver 200 cannot change the voltage of the control node NQ[N], NQ[N+1] in response to the first clock signal CLK1 and the second clock signal CLK2, and may not sequentially output the carry signal CR[N], CR[N+1] in response to the first clock signal CLK1 and the second clock signal CLK2. Accordingly, the gate driver 200 may not be implemented in the form of the shift register.

As such, when the first clock signal CLK1 and the second clock signal CLK2 are out of sync with each other, the node voltage of the gate driver 200 may be unstable, and the gate driver 200 cannot be implemented in the form of the shift register.

Referring to FIGS. 1 to 7 and 10 to 11, in order to reduce a power consumption of the gate driver 200, a toggling (i.e., a frequency) of the clock signal CLK1, CLK2 may be reduced. When the toggling of the clock signal CLK1, CLK2 is reduced, the input signal IN may not be provided as is to the control node NQ[N], but may be provided after being changed by a threshold voltage of the first transistor T1 or the second transistor T2. In this case, a leakage current may occur in the third transistor T3 and the fourth transistor T4 which operate according to the voltage of the control node NQ[N]. Accordingly, the node voltage of the gate driver 200 may become unstable, and the gate driver 200 may not operate normally.

As such, when the toggling of the clock signal CLK1, CLK2 decreases, the node voltage of the gate driver 200 may become unstable, and the gate driver 200 may not operate normally.

In FIGS. 12 to 39, a gate driver, which prevents the misalignment of the first clock signal CLK1 and the second clock signal CLK2 and maintains the node voltage of the gate driver 200 stably to maintain a reliability of an operation of the gate driver 200 even if the toggling of the clock signals CLK1, CLK2 decreases, will be described later.

FIG. 12 is a block diagram showing a gate driver 300 according to embodiments of the present invention. FIG. 13 is a timing diagram showing an example of an operation of a gate driver 300 of FIG. 12.

Referring to FIGS. 1 to 13, a gate driver 300 according to embodiments of the present invention may include a plurality of stages GW_STG[1], GW_STG[2], GW_STG[3], GW_STG[4], . . . . The gate driver 300 may be implemented in a form of a shift register in which the stages GW_STG[1], GW_STG[2], GW_STG[3], GW_STG[4], . . . sequentially output gate signals GW[1], GW[2], GW[3], GW[4], . . . .

The stages GW_STG[1], GW_STG[2], GW_STG[3], GW_STG[4], . . . may receive a gate start signal FLM, a clock signal CLK, a first gate clock signal BUF_CLK1, and a second gate clock signal BUF_CLK2. The first gate clock signal BUF_CLK1 and the second gate clock signal BUF_CLK2 may have different phases. For example, the first gate clock signal BUF_CLK1 and the second gate clock signal BUF_CLK2 may have opposite phases.

Each of the stages GW_STG[1], GW_STG[2], GW_STG[3], GW_STG[4], . . . may receive the clock signal CLK. For example, a clock terminal of the first stage GW_STG[1] may receive the clock signal CLK. For example, a clock terminal of the second stage GW_STG[2] may receive the clock signal CLK. For example, a clock terminal of the third stage GW_STG[3] may receive the clock signal CLK. For example, a clock terminal of the fourth stage GW_STG[4] may receive the clock signal CLK.

Each of the stages GW_STG[1], GW_STG[2], GW_STG[3], GW_STG[4], . . . may receive an input signal (e.g., a gate start signal FLM or a previous carry signal CR[1], CR[2], CR[3], CR[4], . . . ) in response to the clock signal CLK and an inversion clock signal CLKB inverted from the clock signal CLK. Each of the stages GW_STG[1], GW_STG[2], GW_STG[3], GW_STG[4], . . . may initiate an operation in response to the input signal. In an embodiment, an odd-numbered stage GW_STG[1], GW_STG[3], . . . may receive the input signal in response to a clock signal CLK having a low level L and an inversion clock signal CLKB having a high level H. In an embodiment, an even-numbered stage GW_STG[2], GW_STG[4], . . . may receive the input signal in response to a clock signal CLK having the high level H and an inversion clock signal CLKB having the low level L. In an embodiment, an input terminal of the first stage GW_STG[1] may receive the gate start signal FLM. In an embodiment, an input terminal of each of subsequent stages GW_STG[2], GW_STG[3], GW_STG[4], . . . may receive a carry signal of a previous stage. For example, an input terminal of the first stage GW_STG[1] may receive the gate start signal FLM in response to the clock signal CLK having the low level L and the inversion clock signal CLKB having the high level H. For example, an input terminal of the second stage GW_STG[2] may receive a first carry signal CR[1] of the first stage GW_STG[1] in response to the clock signal CLK having the high level H and the inversion clock signal CLKB having the low level L. For example, an input terminal of the third stage GW_STG[3] may receive a second carry signal CR[2] of the second stage GW_STG[2] in response to a clock signal CLK having the low level L and the inversion clock signal CLKB having the high level H. For example, an input terminal of the fourth stage GW_STG[4] may receive a third carry signal CR[3] of the third stage GW_STG[3] in response to the clock signal CLK having the high level H and the inversion clock signal CLKB having the low level L.

Each of the stages GW_STG[1], GW_STG[2], GW_STG[3], GW_STG[4], . . . may alternately receive a first gate clock signal BUF_CLK1 and a second gate clock signal BUF_CLK2. In an embodiment, a gate clock terminal of the odd-numbered stage GW_STG[1], GW_STG[3], . . . may receive the first gate clock signal BUF_CLK1. In an embodiment, a gate clock terminal of the even-numbered stage GW_STG[2], GW_STG[4], . . . may receive the second gate clock signal BUF_CLK2. For example, a gate clock terminal of the first stage GW_STG[1] may receive the first gate clock signal BUF_CLK1. For example, a gate clock terminal of the second stage GW_STG[2] may receive the second gate clock signal BUF_CLK2. For example, a gate clock terminal of the third stage GW_STG[3] may receive the first gate clock signal BUF_CLK1. For example, a gate clock terminal of the fourth stage GW_STG[4] may receive the second gate clock signal CLK2.

The stages GW_STG[1], GW_STG[2], GW_STG[3], GW_STG[4], . . . may sequentially output carry signals CR[1], CR[2], CR[3], CR[4], . . . in response to the clock signal CLK and the inversion clock signal CLKB. For example, a carry output terminal of the first stage GW_STG[1] may output the first carry signal CR[1]. For example, a carry output terminal of the second stage GW_STG[2] may output the second carry signal CR[2]. For example, a carry output terminal of the third stage GW_STG[3] may output the third carry signal CR[3]. For example, a carry output terminal of the fourth stage GW_STG[4] may output the fourth carry signal CR[4].

The stages GW_STG[1], GW_STG[2], GW_STG[3], GW_STG[4], . . . may sequentially output the gate signals GW[1], GW[2], GW[3], GW[4], . . . in response to the clock signal CLK, the first gate clock signal BUF_CLK1, and the second gate clock signal BUF_CLK2. For example, a gate output terminal of the first stage GW_STG[1] may output a first gate signal GW[1] having the high level H. For example, a gate output terminal of the second stage GW_STG[2] may output a second gate signal GW[2] having the high level H. For example, a gate output terminal of the third stage GW_STG[3] may output a third gate signal GW[3] having the high level H. For example, a gate output terminal of the fourth stage GW_STG[4] may output a fourth gate signal GW[4] having the high level H.

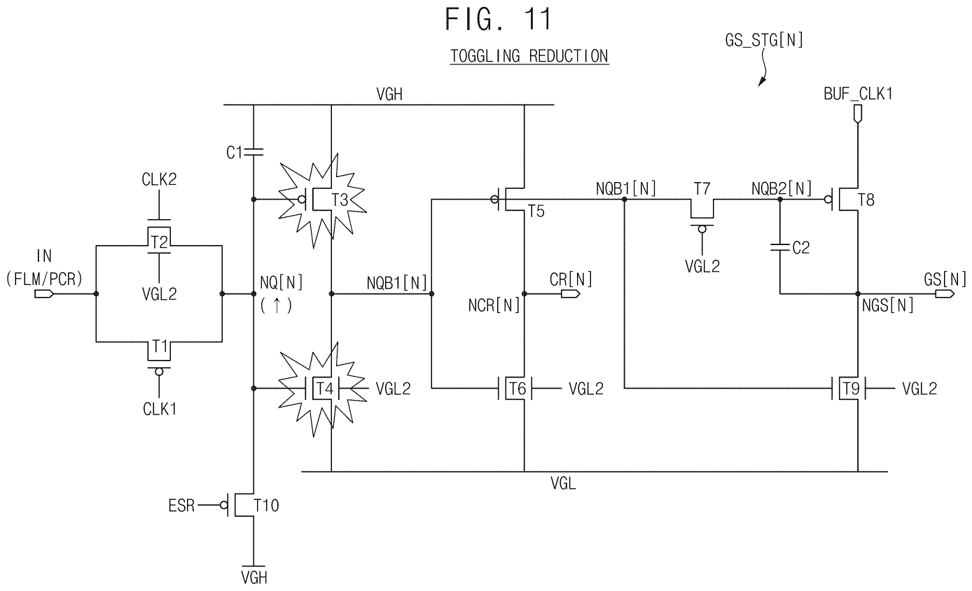

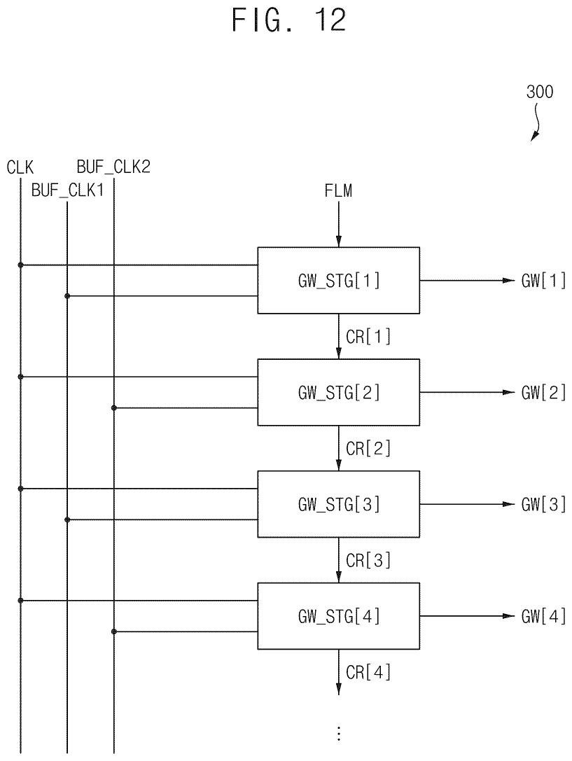

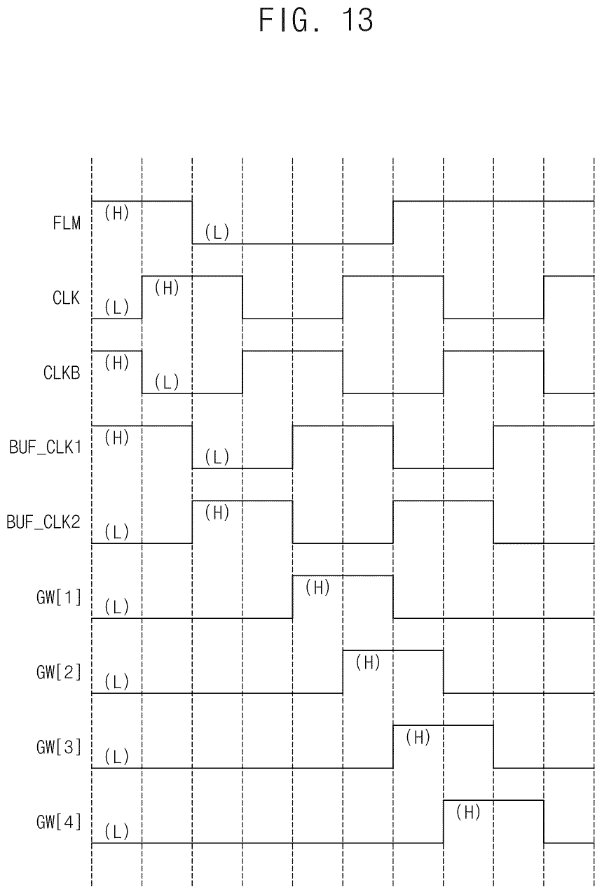

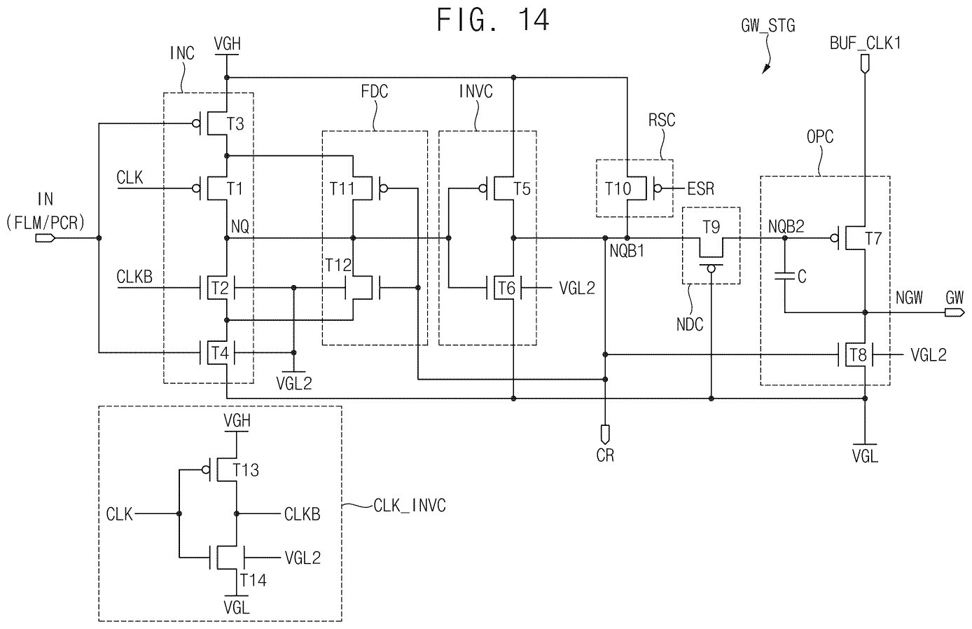

FIG. 14 is a circuit diagram showing an example GW_STG of stages GW_STG[1], GW_STG[2], GW_STG[3], GW_STG[4], . . . included in a gate driver 300 of FIG. 12.

Referring to FIGS. 1 to 14, a gate driver 300 according to embodiments of the present invention may include a plurality of stages GW_STG[1], GW_STG[2], GW_STG[3], GW_STG[4], . . . . The stages GW_STG[1], GW_STG[2], GW_STG[3], GW_STG[4], . . . have substantially a same configuration and a same operation. Therefore, in FIG. 14, the first stage GS_STG[1] of FIG. 12 is described, and a description of the subsequent stages GW_STG[2], GW_STG[3], GW_STG[4], . . . of FIG. 12 is omitted.

A stage GW_STG may include an input circuit INC, an inverter circuit INVC, a feedback circuit FDC, and a gate output circuit OPC. In an embodiment, the stage GW_STG may further include a node separation circuit NDC. In an embodiment, the stage GW_STG may further include a reset circuit RSC. In an embodiment, the stage GW_STG may further include a clock inverter circuit CLK_INVC.

The input circuit INC may control a voltage of a control node NQ in response to a clock signal CLK, an inversion clock signal CLKB inverted from the clock signal CLK, and an input signal IN. The input signal IN may be a gate start signal FLM or a previous carry signal PCR.

The input circuit INC may include a first transistor T1, a second transistor T2, a third transistor T3, and a fourth transistor T4.

In an embodiment, the first transistor T1 and the third transistor T3 may be PMOS transistors, and the second transistor T2 and the fourth transistor T4 may be NMOS transistors.

The first transistor T1 may include a gate electrode, which receives a clock signal CLK, a first electrode, and a second electrode connected to a control node NQ. The first transistor T1 may be turned on in response to a clock signal CLK having a low level L.

The second transistor T2 may include a gate electrode, which receives an inversion clock signal CLKB inverted from the clock signal CLK, a first electrode, and a second electrode connected to the control node NQ. The second transistor T2 may further include a back gate electrode, which receives a second low gate voltage VGL2. The second transistor T2 may be turned on in response to an inversion clock signal CLKB having a high level H.

The third transistor T3 may include a gate electrode, which receives the input signal IN, a first electrode, which receives a high gate voltage VGH, and a second electrode connected to the first electrode of the first transistor T1. The third transistor T3 may be turned on in response to an input signal IN having a low level L.

The fourth transistor T4 may include a gate electrode, which receives the input signal IN, a first electrode, which receives a low gate voltage VGL, and a second electrode connected to the first electrode of the second transistor T2. The fourth transistor T4 may further include a back gate electrode, which receives the second low gate voltage VGL2. The low gate voltage VGL may be greater than the second low gate voltage VGL2. The fourth transistor T4 may be turned on in response to an input signal IN having the high level H.

When the first transistor T1 and the third transistor T3 are turned on, the first transistor T1 and the third transistor T3 may provide the high gate voltage VGH to the control node NQ. Accordingly, the voltage of the control node NQ may have the high level H.

When the second transistor T2 and the fourth transistor T4 are turned on, the second transistor T2 and the fourth transistor T4 may provide the low gate voltage VGL to the control node NQ. Accordingly, the voltage of the control node NQ may have the low level L.

The inverter circuit INVC may invert the voltage of the control node NQ and provide the inverted voltage of the control node NQ to an inversion control node NQB1, NQB2. For example, the inverter circuit INVC may invert the voltage of the control node NQ having the high level H and provide the inverted voltage of the control node NQ having the low level L to the inversion control node NQB1, NQB2. For example, the inverter circuit INVC may invert the voltage of the control node NQ having the low level L and provide the inverted voltage of the control node NQ having the high level H to the inversion control node NQB1, NQB2.

The inverter circuit INVC may include a fifth transistor T5 and a sixth transistor T6.

In an embodiment, the fifth transistor T5 may be the PMOS transistor, and the sixth transistor T6 may be the NMOS transistor.

The fifth transistor T5 may include a gate electrode connected to the control node NQ, a first electrode, which receives the high gate voltage VGH, and a second electrode connected to the inversion control node NQB1, NQB2. The fifth transistor T5 may be turned on in response to the voltage of the control node NQ having the low level L to provide the high gate voltage VGH to the inversion control node NQB1, NQB2.

The sixth transistor T6 may include a gate electrode connected to the control node NQ, a first electrode, which receives the low gate voltage VGL, and a second electrode connected to the inversion control node NQB1, NQB2. The sixth transistor T6 may further include a back gate electrode, which receives the second low gate voltage VGL2. The sixth transistor T6 may be turned on in response to the voltage of the control node NQ having the high level H to provide the low gate voltage VGL to the inversion control node NQB1, NQB2.

The gate output circuit OPC may output a gate signal GW in response to the voltage of the inversion control node NQB1, NQB2.

The gate output circuit OPC may include a seventh transistor T7, an eighth transistor T8, and a capacitor C.

In an embodiment, the seventh transistor T7 may be the PMOS transistor, and the eighth transistor T8 may be the NMOS transistor.

The seventh transistor T7 may include a gate electrode connected to the inversion control node NQB1, NQB2, a first electrode, which receives a first gate clock signal BUF_CLK1, and a second electrode connected to a gate output node NGW from which a gate signal GW is output. The seventh transistor T7 may be turned on in response to the voltage of the inversion control node NQB1, NQB2 having the low level L to provide the first gate clock signal BUF_CLK1 to the gate output node NGW.

The eighth transistor T8 may include a gate electrode connected to the inversion control node NQB1, NQB2, a first electrode, which receives the low gate voltage VGL, and a second electrode connected to the gate output node NGW. The eighth transistor T8 may further include a back gate electrode, which receives the second low gate voltage VGL2. The eighth transistor T8 may be turned on in response to the voltage of the inversion control node NQB1, NQB2 having the high level H to provide the low gate voltage VGL to the gate output node NGW.

The capacitor C may include a first electrode connected to the inversion control node NQB1, NQB2 and a second electrode connected to the gate output node NGW.

The inversion control node NQB1, NQB2 may include a first inversion control node NQB1 and a second inversion control node NQB2.

The node separation circuit NDC may separate the first inversion control node NQB1 and the second inversion control node NQB2. The node separation circuit NDC may include a ninth transistor T9.

In an embodiment, the ninth transistor T9 may be the PMOS transistor.

The ninth transistor T9 may include a gate electrode, which receives the low gate voltage VGL, a first electrode connected to the first inversion control node NQB1, and a second electrode connected to the second inversion control node NQB2. Since the ninth transistor T9 is turned on in response to the low gate voltage VGL, the ninth transistor T9 may be an always-on transistor (AOT). Since the ninth transistor T9 is the always-on transistor and the PMOS transistor, the ninth transistor T9 may prevent a bootstrapped voltage of the second inversion control node NQB2 from being provided to the first inversion control node NQB1.

The reset circuit RSC may reset the voltage of the inversion control node NQB1, NQB2.

The reset circuit RSC may include a tenth transistor T10.

In an embodiment, the tenth transistor T10 may be the PMOS transistor.

The tenth transistor T10 may include a gate electrode, which receives a reset signal ESR, a first electrode, which receives the high gate voltage VGH, and a second electrode connected to the inversion control node NQB1, NQB2. The tenth transistor T10 may be turned on in response to the reset signal ESR having the low level L to provide the high gate voltage VGH to the inversion control node NQB1, NQB2. Accordingly, the voltage of the inversion control node NQB1, NQB2 may be initialized to the high gate voltage VGH. The reset signal ESR may be a global signal which is simultaneously applied to the plurality of stages GW_STG[1], GW_STG[2], GW_STG[3], GW_STG[4], . . . included in the gate driver 300 of FIG. 12. For example, when a display device is turned on, the reset signal ESR may be simultaneously applied to the stages GW_STG[1], GW_STG[2], GW_STG[3], GW_STG[4], . . . . Accordingly, node voltages of the stages GW_STG[1], GW_STG[2], GW_STG[3], GW_STG[4], . . . may be initialized, and a reliability of an operation of the gate driver 300 may be maintained.

The feedback circuit FDC may invert the voltage of the inversion control node NQB1, NQB2 to control the voltage of the control node NQ. The feedback circuit FDC may operate as an inverter circuit. For example, the feedback circuit FDC may invert the voltage of the inversion control node NQB1, NQB2 having the high level H and provide the inverted voltage of the inversion control node NQB1, NQB2 having the low level L to the control node NQ. For example, the feedback circuit FDC may invert the voltage of the inversion control node NQB1, NQB2 having the low level L and provide the inverted voltage of the inversion control node NQB1, NQB2 having the high level H to the control node NQ.

The feedback circuit FDC may include an eleventh transistor T11 and a twelfth transistor T12.

In an embodiment, the eleventh transistor T11 may be the PMOS transistor, and the twelfth transistor T12 may be the NMOS transistor.

The eleventh transistor T11 may include a gate electrode connected to the inversion control node NQB1, NQB2, a first electrode connected to the first electrode of the first transistor T1, and a second electrode connected to the control node NQ. The eleventh transistor T11 may be turned on in response to the voltage of the inversion control node NQB1, NQB2 having the low level L.

The twelfth transistor T12 may include a gate electrode connected to the inversion control node NQB1, NQB2, a first electrode connected to the first electrode of the second transistor T2, and a second electrode connected to the control node NQ. The twelfth transistor T12 may further include a back gate electrode, which receives the second low gate voltage VGL2. The twelfth transistor T12 may be turned on in response to the voltage of the inversion control node NQB1, NQB2 having the high level H.

The clock inverter circuit CLK_INVC may invert the clock signal CLK and output the inversion clock signal CLKB. The clock inverter circuit CLK_INVC may operate as the inverter circuit. For example, the clock inverter circuit CLK_INVC may invert a clock signal CLK having the high level H and output the inverted clock signal CLK having the low level L. For example, the clock inverter circuit CLK_INVC may invert a clock signal CLK having the low level L and output the inverted clock signal CLK having the high level H.

The clock inverter circuit CLK_INVC may include a thirteenth transistor T13 and a fourteenth transistor T14.

In an embodiment, the thirteenth transistor T13 may be the PMOS transistor, and the fourteenth transistor T14 may be the NMOS transistor.

The thirteenth transistor T13 may include a gate electrode, which receives the clock signal CLK, a first electrode, which receives the high gate voltage VGH, and a second electrode outputting the inversion clock signal CLKB. The thirteenth transistor T13 may be turned on in response to the clock signal CLK having the low level L to output the high gate voltage VGH as the inversion clock signal CLKB.

The fourteenth transistor T14 may include a gate electrode, which receives the clock signal CLK, a first electrode, which receives the low gate voltage VGL, and a second electrode outputting the inversion clock signal CLKB. The fourteenth transistor T14 may be turned on in response to the clock signal CLK having the high level H to output the low gate voltage VGL as the inversion clock signal CLKB.

In summary, even if the first clock signal CLK1 and the second clock signal CLK2 of FIG. 4 are designed to have opposite phases, since the first clock signal CLK1 and the second clock signal CLK2 of FIG. 4 are independently generated and applied to the gate driver 200 of FIG. 4, the first clock signal CLK1 and the second clock signal CLK2 may not have the opposite phases and may have a distortion. However, since the inversion clock signal CLKB applied to the stage GW_STG of the gate driver 300 is an inverted clock signal CLK, the clock signal CLK and the inversion clock signal CLKB may be generated dependently and may not have the distortion.

In addition, the stage GW_STG of the gate driver 300 may include the input circuit INC which controls the voltage of the control node NQ, the inverter circuit INVC which inverts the voltage of the control node NQ and provides the inverted voltage of the control node NQ to the inversion control node NQB1, NQB2, and the feedback circuit FDC which inverts the voltage of the inversion control node NQB1, NQB2 and controls the voltage of the control node NQ. Therefore, a feedback path may be formed between the control node NQ and the inversion control node NQB1, NQB2, and the voltage of the inversion control node NQB1, NQB2 is determined by the voltage of the control node NQ, but the voltage of the inversion control node NQB1, NQB2 may in turn affect the voltage of the control node NQ. Accordingly, even if the a toggling (i.e., a frequency) of the clock signal CLK and a toggling of the inversion clock signal CLKB are reduced in order to reduce a power consumption of the gate driver 300, a node voltage of the stage GW_STG of the gate driver 300 (e.g., the voltage of the control node NQ and the voltage of the inversion control node NQB1, NQB2) may be stabilized.

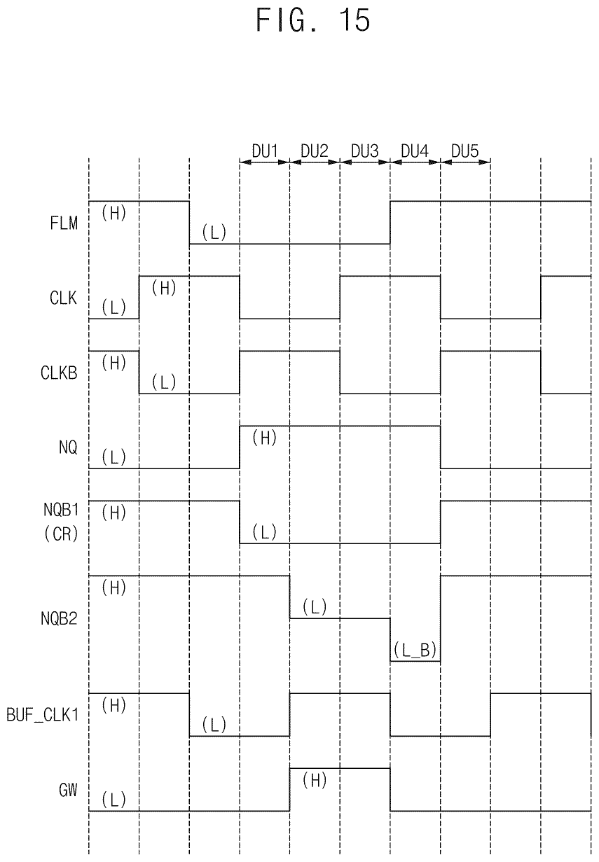

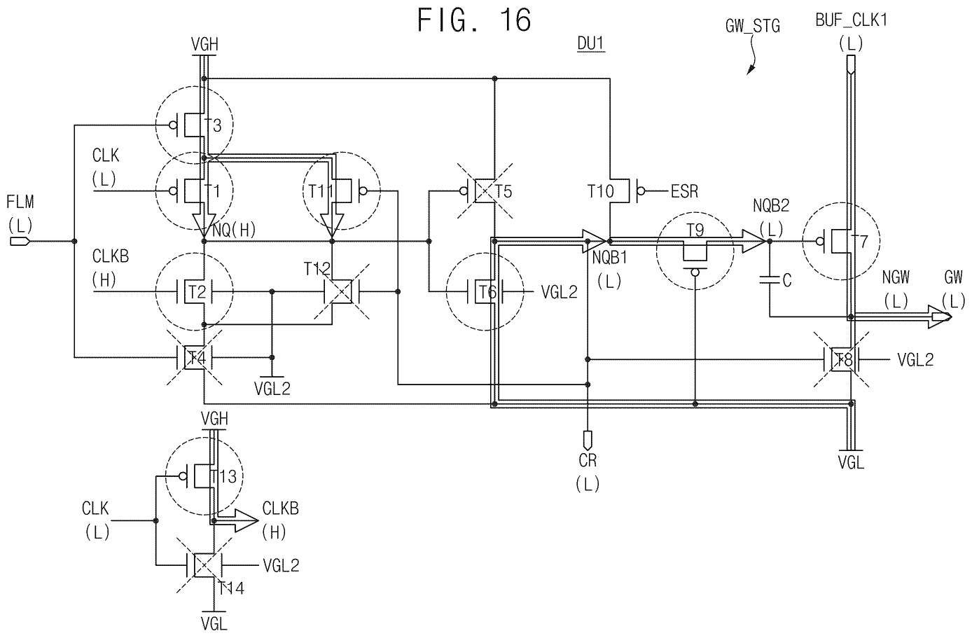

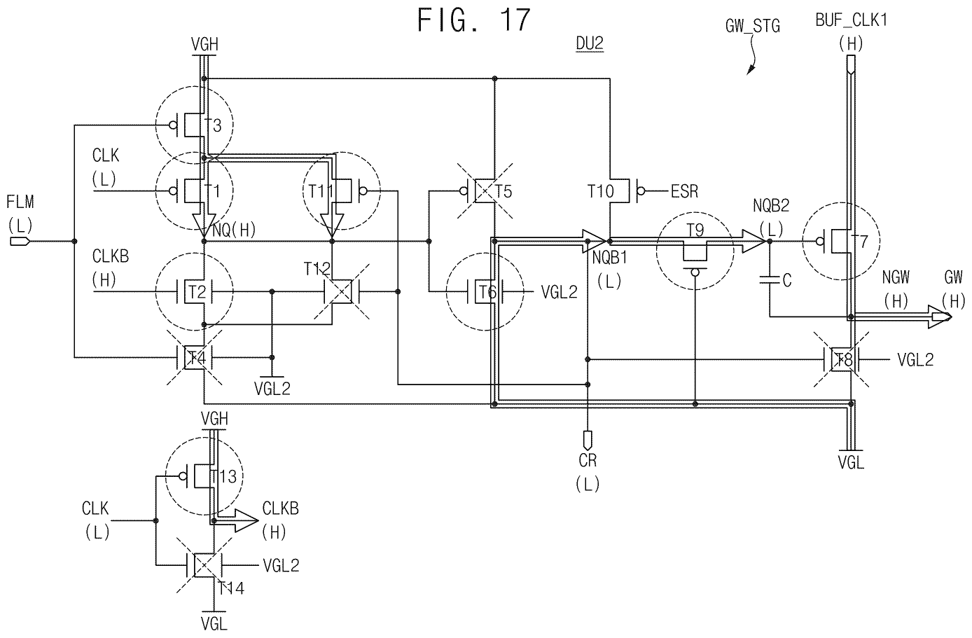

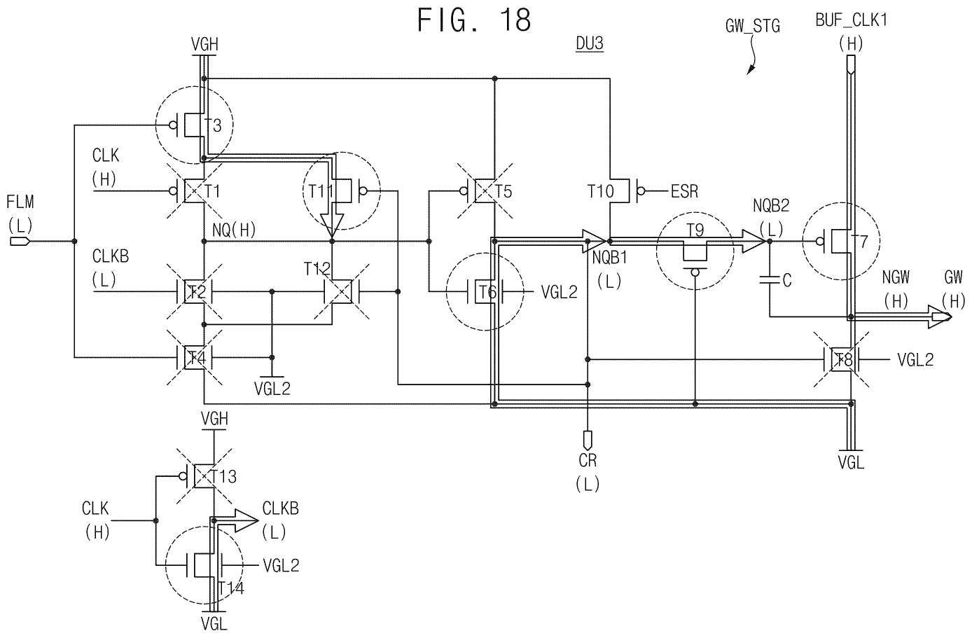

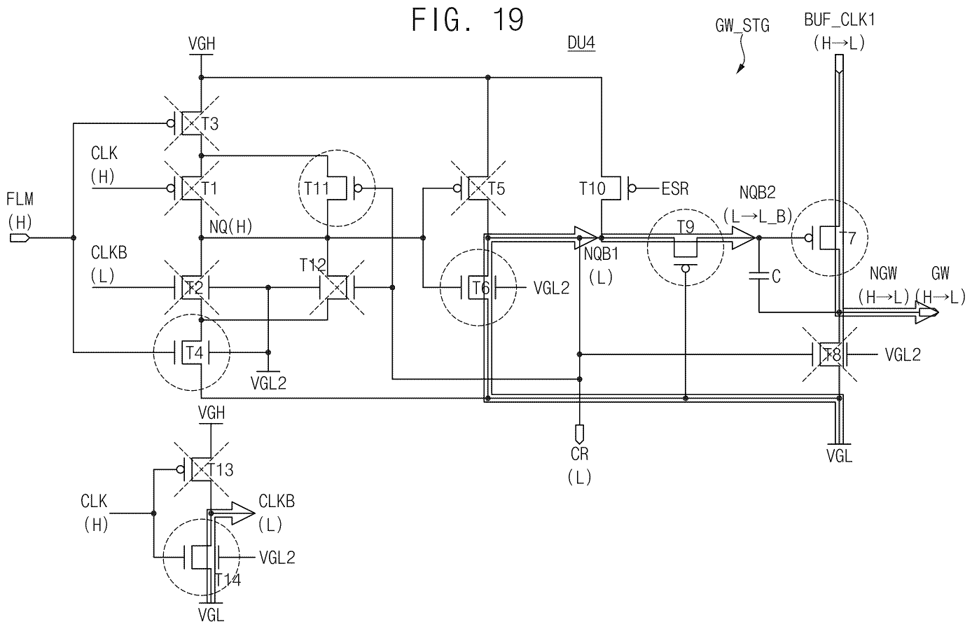

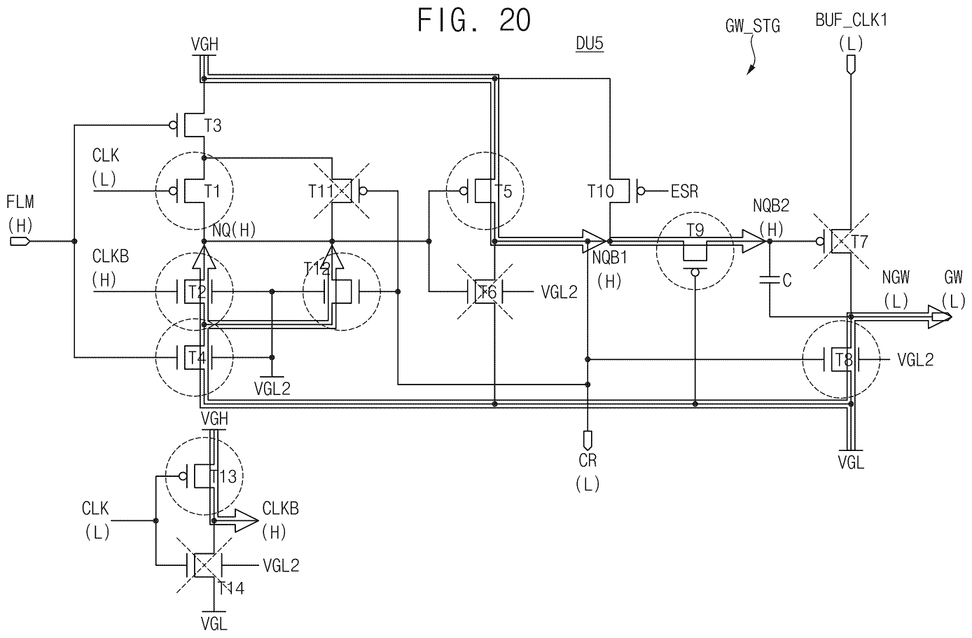

FIG. 15 is a timing diagram showing an example of an operation of a stage GW_STG of FIG. 14. FIG. 16 is a circuit diagram showing an example of an operation of a stage GW_STG of FIG. 14 in a first period DU1 of FIG. 15. FIG. 17 is a circuit diagram showing an example of an operation of a stage GW_STG of FIG. 14 in a second period DU2 of FIG. 15. FIG. 18 is a circuit diagram showing an example of an operation of a stage GW_STG of FIG. 14 in a third period DU3 of FIG. 15. FIG. 19 is a circuit diagram showing an example of an operation of a stage GW_STG of FIG. 14 in a fourth period DU4 of FIG. 15. FIG. 20 is a circuit diagram showing an example of an operation of a stage GW_STG of FIG. 14 in a fifth period DU5 of FIG. 15.

Referring to FIGS. 15 and 16, in a first period DU1, the clock signal CLK may have the low level L.

The clock inverter circuit CLK_INVC may invert the clock signal CLK having the low level L and output the inversion clock signal CLKB having the high level H. Specifically, the thirteenth transistor T13 may be turned on in response to the clock signal CLK having the low level L and output the high gate voltage VGH as the inversion clock signal CLKB. The fourteenth transistor T14 may be turned off in response to the clock signal CLK having the low level L.

The gate start signal FLM may have the low level L, the clock signal CLK may have the low level L, and the inversion clock signal CLKB may have the high level H.

The input circuit INC may control the voltage of the control node NQ in response to the gate start signal FLM having the low level L, the clock signal CLK having the low level L, and the inversion clock signal CLKB having the high level H. Specifically, the first transistor T1 may be turned on in response to the clock signal CLK having the low level L. The third transistor T3 may be turned on in response to the gate start signal FLM having the low level L. Therefore, the first transistor T1 and the third transistor T3 may be turned on to provide the high gate voltage VGH to the control node NQ. The second transistor T2 may be turned on in response to the inversion clock signal CLKB having the high level H. The fourth transistor T4 may be turned off in response to the gate start signal FLM having the low level L. Therefore, the voltage of the control node NQ may have the high level H.

The inverter circuit INVC may invert the voltage of the control node NQ having the high level H and provide the inverted voltage of the control node NQ having the low level L to the inversion control node NQB1, NQB2. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB1, NQB2. Therefore, the voltage of the inversion control node NQB1, NQB2 may have the low level L.

The feedback circuit FDC may invert the voltage of the inversion control node NQB1, NQB2 having the low level L to control the voltage of the control node NQ to the high level H. Specifically, the eleventh transistor T11 may be turned on in response to the voltage of the inversion control node NQB1, NQB2 having the low level L. Therefore, the third transistor T3 and the eleventh transistor T11 may be turned on to provide the high gate voltage VGH to the control node NQ. The twelfth transistor T12 may be turned off in response to the voltage of the inversion control node NQB1, NQB2 having the low level L. Therefore, the voltage of the control node NQ may have the high level H.

A voltage of the first inversion control node NQB1 among the inversion control node NQB1, NQB2 may have the low level L.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the low level L to the second inversion control node NQB2. Therefore, a voltage of the second inversion control node NQB2 may have the low level L.

The voltage of the inversion control node NQB1, NQB2 may have the low level L, and the first gate clock signal BUF_CLK1 may have the low level L.

The gate output circuit OPC may output the gate signal GW in response to the voltage of the inversion control node NQB1, NQB2 having the low level L. Specifically, the seventh transistor T7 may be turned on in response to the voltage of the inversion control node NQB1, NQB2 having the low level L to provide the first gate clock signal BUF_CLK1 having the low level L to the gate output node NGW. The eighth transistor T8 may be turned off in response to the voltage of the inversion control node NQB1, NQB2 having the low level L. Therefore, the voltage of the gate output node NGW may have the low level L, and the gate signal GW may have the low level L.

Referring to FIGS. 15 and 17, in a second period DU2, the clock signal CLK may have the low level L.

The clock inverter circuit CLK_INVC may invert the clock signal CLK having the low level L and output the inversion clock signal CLKB having the high level H. Specifically, the thirteenth transistor T13 may be turned on in response to the clock signal CLK having the low level L to output the high gate voltage VGH as the inversion clock signal CLKB. The fourteenth transistor T14 may be turned off in response to the clock signal CLK having the low level L.

The gate start signal FLM may have the low level L, the clock signal CLK may have the low level L, and the inversion clock signal CLKB may have the high level H.

The input circuit INC may control the voltage of the control node NQ in response to the gate start signal FLM having the low level L, the clock signal CLK having the low level L, and the inversion clock signal CLKB having the high level H. Specifically, the first transistor T1 may be turned on in response to the clock signal CLK having the low level L. The third transistor T3 may be turned on in response to the gate start signal FLM having the low level L. Therefore, the first transistor T1 and the third transistor T3 may be turned on to provide the high gate voltage VGH to the control node NQ. The second transistor T2 may be turned on in response to the inversion clock signal CLKB having the high level H. The fourth transistor T4 may be turned off in response to the gate start signal FLM having the low level L. Therefore, the voltage of the control node NQ may have the high level H.

The inverter circuit INVC may invert the voltage of the control node NQ having the high level H and provide the inverted voltage of the control node NQ having the low level L to the inversion control node NQB1, NQB2. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB1, NQB2. Therefore, the voltage of the inversion control node NQB1, NQB2 may have the low level L.

The feedback circuit FDC may invert the voltage of the inversion control node NQB1, NQB2 having the low level L to control the voltage of the control node NQ to the high level H. Specifically, the eleventh transistor T11 may be turned on in response to the voltage of the inversion control node NQB1, NQB2 having the low level L. Therefore, the third transistor T3 and the eleventh transistor T11 may be turned on to provide the high gate voltage VGH to the control node NQ. The twelfth transistor T12 may be turned off in response to the voltage of the inversion control node NQB1, NQB2 having the low level L. Therefore, the voltage of the control node NQ may have the high level H.

The voltage of the first inversion control node NQB1 among the inversion control node NQB1, NQB2 may have the low level L.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the low level L to the second inversion control node NQB2. Therefore, the voltage of the second inversion control node NQB2 may have the low level L.

The voltage of the inversion control node NQB1, NQB2 may have the low level L, and the first gate clock signal BUF_CLK1 may have the high level H.

The gate output circuit OPC may output the gate signal GW in response to the voltage of the inversion control node NQB1, NQB2 having the low level L. Specifically, the seventh transistor T7 may be turned on in response to the voltage of the inversion control node NQB1, NQB2 having the low level L and provide the first gate clock signal BUF_CLK1 having the high level H to the gate output node NGW. The eighth transistor T8 may be turned off in response to the voltage of the inversion control node NQB1, NQB2 having the low level L. Therefore, a voltage of the gate output node NGW may have the high level H, and the gate signal GW may have the high level H.

Referring to FIGS. 15 and 18, in a third period DU3, the clock signal CLK may have the high level H.

The clock inverter circuit CLK_INVC may invert the clock signal CLK having the high level H and output the inversion clock signal CLKB having the low level L. Specifically, the thirteenth transistor T13 may be turned off in response to the clock signal CLK having the high level H. The fourteenth transistor T14 may be turned on in response to the clock signal CLK having the high level H to output the low gate voltage VGL as the inversion clock signal CLKB.

The gate start signal FLM may have the low level L, the clock signal CLK may have the high level H, and the inversion clock signal CLKB may have the low level L.

The input circuit INC may control the voltage of the control node NQ in response to the gate start signal FLM having the low level L, the clock signal CLK having the high level H, and the inversion clock signal CLKB having the low level L. Specifically, the first transistor T1 may be turned off in response to the clock signal CLK having the high level H. The third transistor T3 may be turned on in response to the gate start signal FLM having the low level L. The second transistor T2 may be turned off in response to the inversion clock signal CLKB having the low level L. The fourth transistor T4 may be turned off in response to the gate start signal FLM having the low level L. Therefore, the voltage of the control node NQ may maintain the high level H.

The inverter circuit INVC may invert the voltage of the control node NQ having the high level H and provide the inverted voltage of the control node NQ having the low level L to the inversion control node NQB1, NQB2. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB1, NQB2. Therefore, the voltage of the inversion control node NQB1, NQB2 may have the low level L.

The feedback circuit FDC may invert the voltage of the inversion control node NQB1, NQB2 having the low level L to control the voltage of the control node NQ to the high level H. Specifically, the eleventh transistor T11 may be turned on in response to the voltage of the inversion control node NQB1, NQB2 having the low level L. Therefore, the third transistor T3 and the eleventh transistor T11 may be turned on to provide the high gate voltage VGH to the control node NQ. The twelfth transistor T12 may be turned off in response to the voltage of the inversion control node NQB1, NQB2 having the low level L. Therefore, the voltage of the control node NQ may have the high level H.

The voltage of the first inversion control node NQB1 among the inversion control node NQB1, NQB2 may have the low level L.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the low level L to the second inversion control node NQB2. Therefore, the voltage of the second inversion control node NQB2 may have the low level L.

The voltage of the inversion control node NQB1, NQB2 may have the low level L, and the first gate clock signal BUF_CLK1 may have the high level H.

The gate output circuit OPC may output the gate signal GW in response to the voltage of the inversion control node NQB1, NQB2 having the low level L. Specifically, the seventh transistor T7 may be turned on in response to the voltage of the inversion control node NQB1, NQB2 having the low level L and provide the first gate clock signal BUF_CLK1 having the high level H to the gate output node NGW. The eighth transistor T8 may be turned off in response to the voltage of the inversion control node NQB1, NQB2 having the low level L. Therefore, the voltage of the gate output node NGW may have the high level H, and the gate signal GW may have the high level H.

Referring to FIGS. 15 and 19, in a fourth period DU4, the clock signal CLK may have the high level H.

The clock inverter circuit CLK_INVC may invert the clock signal CLK having the high level H and output the inversion clock signal CLKB having the low level L. Specifically, the thirteenth transistor T13 may be turned off in response to the clock signal CLK having the high level H. The fourteenth transistor T14 may be turned on in response to the clock signal CLK having the high level H to output the low gate voltage VGL as the inversion clock signal CLKB.

The gate start signal FLM may have the low level L, the clock signal CLK may have the high level H, and the inversion clock signal CLKB may have the low level L.

The input circuit INC may control the voltage of the control node NQ in response to the gate start signal FLM having the low level L, the clock signal CLK having the high level H, and the inversion clock signal CLKB having the low level L. Specifically, the first transistor T1 may be turned off in response to the clock signal CLK having the high level H. The third transistor T3 may be turned on in response to the gate start signal FLM having the low level L. The second transistor T2 may be turned off in response to the inversion clock signal CLKB having the low level L. The fourth transistor T4 may be turned off in response to the gate start signal FLM having the low level L. Therefore, the voltage of the control node NQ may maintain the high level H.

The inverter circuit INVC may invert the voltage of the control node NQ having the high level H and provide the inverted voltage of the control node NQ having the low level L to the inversion control node NQB1, NQB2. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB1, NQB2. Therefore, the voltage of the inversion control node NQB1, NQB2 may have the low level L.

The feedback circuit FDC may invert the voltage of the inversion control node NQB1, NQB2 having the low level L to control the voltage of the control node NQ to the high level H. Specifically, the eleventh transistor T11 may be turned on in response to the voltage of the inversion control node NQB1, NQB2 having the low level L. Therefore, the third transistor T3 and the eleventh transistor T11 may be turned on to provide the high gate voltage VGH to the control node NQ. The twelfth transistor T12 may be turned off in response to the voltage of the inversion control node NQB1, NQB2 having the low level L. Therefore, the voltage of the control node NQ may have the high level H.

The voltage of the first inversion control node NQB1 among the inversion control node NQB1, NQB2 may have the low level L.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the low level L to the second inversion control node NQB2. Therefore, the voltage of the second inversion control node NQB2 may have the low level L.

The voltage of the inversion control node NQB1, NQB2 may have the low level L, and the first gate clock signal BUF_CLK1 may change from the high level H to the low level L.

The gate output circuit OPC may output the gate signal GW in response to the voltage of the inversion control node NQB1, NQB2 having the low level L. Specifically, the seventh transistor T7 may be turned on in response to the voltage of the inversion control node NQB1, NQB2 having the low level L to provide the first gate clock signal BUF_CLK1 changed from the high level H to the low level L to the gate output node NGW. The eighth transistor T8 may be turned off in response to the voltage of the inversion control node NQB1, NQB2 having the low level L. Therefore, the voltage of the gate output node NGW may be changed from the high level H to the low level L. Since the voltage of the gate output node NGW connected to the second electrode of the capacitor C is changed from the high level H to the low level L, the voltage of the second inversion control node NQB2 connected to the first electrode of the capacitor C may be changed from the low level L to a bootstrap low level L_B. The bootstrap low level L_B may be less than the low level L. Here, that a voltage of other electrode of the capacitor C changes as a voltage of one electrode of the capacitor C changes, is also expressed as the voltage of the other electrode of the capacitor C being bootstrapped.

The node separation circuit NDC may separate the first inversion control node NQB1 and the second inversion control node NQB2. Specifically, the ninth transistor T9 may prevent the voltage of the second inversion control node NQB2 having the bootstrap low level L_B from being provided to the first inversion control node NQB1. Therefore, the voltage of the first inversion control node NQB1 may have the low level L.

Referring to FIGS. 15 and 20, in the fifth period DU5, the clock signal CLK may have the low level L.

The clock inverter circuit CLK_INVC may invert the clock signal CLK having the low level L and output the inversion clock signal CLKB having the high level H. Specifically, the thirteenth transistor T13 may be turned on in response to the clock signal CLK having the low level L and output the high gate voltage VGH as the inversion clock signal CLKB. The fourteenth transistor T14 may be turned off in response to the clock signal CLK having the low level L.

The gate start signal FLM may have the high level H, the clock signal CLK may have the low level L, and the inversion clock signal CLKB may have the high level H.

The input circuit INC may control the voltage of the control node NQ in response to the gate start signal FLM having the high level H, the clock signal CLK having the low level L, and the inversion clock signal CLKB having the high level H. Specifically, the first transistor T1 may be turned on in response to the clock signal CLK having the low level L. The third transistor T3 may be turned off in response to the gate start signal FLM having the high level H. The second transistor T2 may be turned on in response to the inversion clock signal CLKB having the high level H. The fourth transistor T4 may be turned on in response to the gate start signal FLM having the high level H. Therefore, the second transistor T2 and the fourth transistor T4 may be turned on to provide the low gate voltage VGL to the control node NQ. Accordingly, the voltage of the control node NQ may have the low level L.

The inverter circuit INVC may invert the voltage of the control node NQ having the low level L and provide the inverted voltage of the control node NQ having the high level H to the inversion control node NQB1, NQB2. Specifically, the fifth transistor T5 may be turned on in response to the voltage of the control node NQ having the low level L to provide the high gate voltage VGH to the inversion control node NQB1, NQB2. The sixth transistor T6 may be turned off in response to the voltage of the control node NQ having the low level L. Therefore, the voltage of the inversion control node NQB1, NQB2 may have the high level H.

The feedback circuit FDC may invert the voltage of the inversion control node NQB1, NQB2 having the high level H to control the voltage of the control node NQ to the low level L. Specifically, the eleventh transistor T11 may be turned off in response to the voltage of the inversion control node NQB1, NQB2 having the high level H. The twelfth transistor T12 may be turned on in response to the voltage of the inversion control node NQB1, NQB2 having the high level H. Therefore, the fourth transistor T4 and the twelfth transistor T12 may be turned on to provide the low gate voltage VGL to the control node NQ. Accordingly, the voltage of the control node NQ may have the low level L.

The voltage of the first inversion control node NQB1 among the inversion control node NQB1, NQB2 may have the high level H.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the high level H to the second inversion control node NQB2. Therefore, the voltage of the second inversion control node NQB2 may have the high level H.

The voltage of the inversion control node NQB1, NQB2 may have the high level H, and the first gate clock signal BUF_CLK1 may have the low level L.

The gate output circuit OPC may output the gate signal GW in response to the voltage of the inversion control node NQB1, NQB2 having the high level H. Specifically, the seventh transistor T7 may be turned off in response to the voltage of the inversion control node NQB1, NQB2 having the high level H. The eighth transistor T8 may be turned on in response to the voltage of the inversion control node NQB1, NQB2 having the high level H to provide the low gate voltage VGL to the gate output node NGW. Therefore, the voltage of the gate output node NGW may have the low level L, and the gate signal GW may have the low level L.

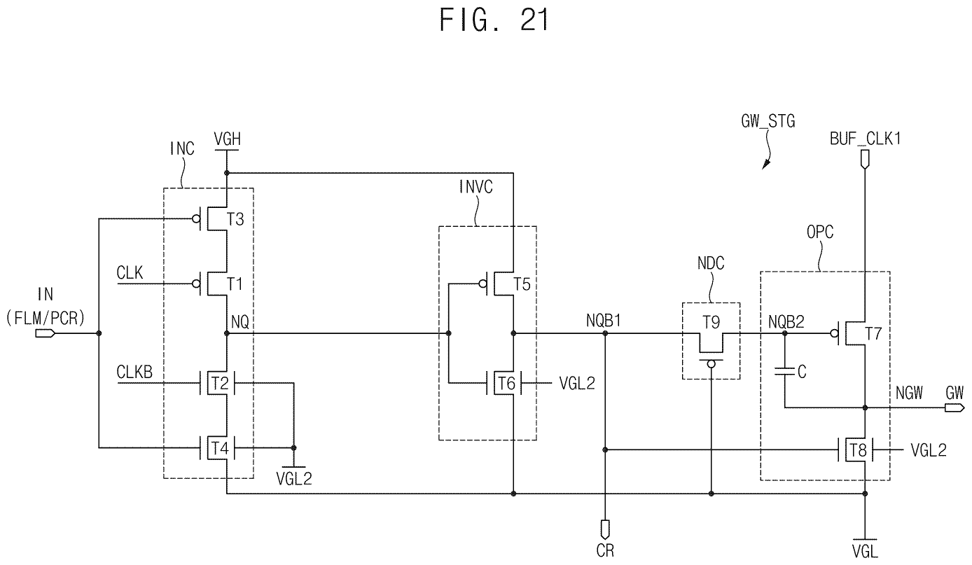

FIG. 21 is a circuit diagram showing an example GW_STG of a stage GW_STG[1], GW_STG[2], GW_STG[3], GW_STG[4], . . . included in a gate driver 300 of FIG. 12.

Referring to FIGS. 1 to 21, a gate driver 300 according to embodiments of the present invention may include a plurality of stages GW_STG[1], GW_STG[2], GW_STG[3], GW_STG[4], . . . . In an embodiment, as shown in FIG. 14, some of the stages GW_STG[1], GW_STG[2], GW_STG[3], GW_STG[4], . . . include the node separation circuit NDC, the reset circuit RSC, the feedback circuit FDC, and the clock inverter circuit CLK_INVC, but as shown in FIG. 21, other stage of the stages GW_STG[1], GW_STG[2], GW_STG[3], GW_STG[4], . . . may not include at least one of the node separation circuit NDC, the reset circuit RSC, the feedback circuit FDC, and the clock inverter circuit CLK_INVC.

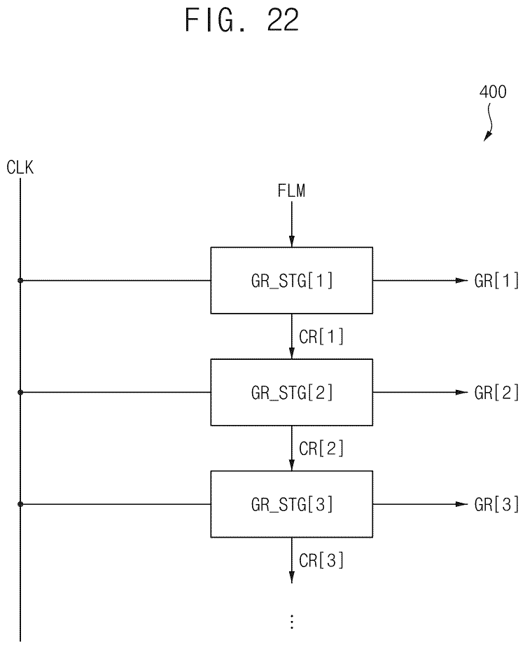

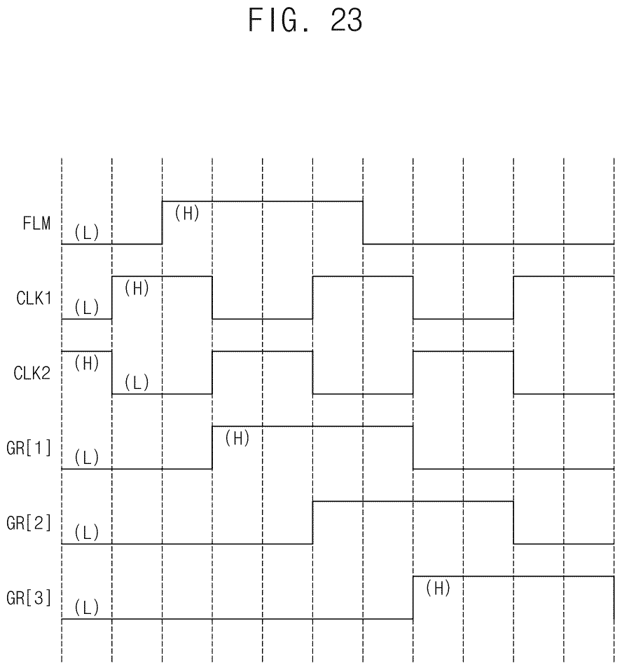

FIG. 22 is a block diagram showing a gate driver 400 according to embodiments of the present invention. FIG. 23 is a timing diagram showing an example of an operation of a gate driver 400 of FIG. 22.

Referring to FIGS. 1 to 23, a gate driver 400 according to embodiments of the present invention may include a plurality of stages GR_STG[1], GR_STG[2], GR_STG[3], . . . . The gate driver 400 may be implemented in a form of a shift register in which the stages GR_STG[1], GR_STG[2], GR_STG[3], . . . sequentially output gate signals GR[1], GR[2], GR[3], . . . .

The stages GR_STG[1], GR_STG[2], GR_STG[3], . . . may receive a gate start signal FLM and a clock signal CLK.

Each of the stages GR_STG[1], GR_STG[2], GR_STG[3], . . . may receive the clock signal CLK. For example, a clock terminal of a first stage GR_STG[1] may receive the clock signal CLK. For example, a clock terminal of a second stage GR_STG[2] may receive the clock signal CLK. For example, a clock terminal of a third stage GR_STG[3] may receive the clock signal CLK.

Each of the stages GR_STG[1], GR_STG[2], GR_STG[3], . . . may receive an input signal (e.g., a gate start signal FLM or a previous carry signal CR[1], CR[2], CR[3], . . . ) in response to the clock signal CLK and an inversion clock signal CLKB inverted from the clock signal CLK. Each of the stages GR_STG[1], GR_STG[2], GR_STG[3], . . . may initiate an operation in response to the input signal. In an embodiment, an odd-numbered stage GR_STG[1], GR_STG[3], . . . may receive the input signal in response to a clock signal CLK having a low level L and an inversion clock signal CLKB having a high level H. In an embodiment, an even-numbered stage GR_STG[2], . . . may receive the input signal in response to a clock signal CLK having the high level H and an inversion clock signal CLKB having the low level L. In an embodiment, an input terminal of the first stage GR_STG[1] may receive the gate start signal FLM. In an embodiment, an input terminal of each of subsequent stages GR_STG[2], GR_STG[3], . . . may receive a carry signal of a previous stage. For example, an input terminal of the first stage GR_STG[1] may receive the gate start signal FLM in response to the clock signal CLK having the low level L and the inversion clock signal CLKB having the high level H. For example, an input terminal of the second stage GR_STG[2] may receive a first carry signal CR[1] of the first stage GR_STG[1] in response to the clock signal CLK having the high level H and the inversion clock signal CLKB having the low level L. For example, an input terminal of the third stage GR_STG[3] may receive a second carry signal CR[2] of the second stage GR_STG[2] in response to the clock signal CLK having the low level L and the inversion clock signal CLKB having the high level H.

The stages GR_STG[1], GR_STG[2], GR_STG[3], . . . may sequentially output carry signals CR[1], CR[2], CR[3], . . . in response to the clock signal CLK and the inversion clock signal CLKB. For example, a carry output terminal of the first stage GR_STG[1] may output the first carry signal CR[1]. For example, a carry output terminal of the second stage GR_STG[2] may output the second carry signal CR[2]. For example, a carry output terminal of the third stage GR_STG[3] may output the third carry signal CR[3].

The stages GR_STG[1], GR_STG[2], GR_STG[3], . . . may sequentially output the gate signals GR[1], GR[2], GR[3], . . . in response to the clock signal CLK and the inversion clock signal CLKB. For example, a gate output terminal of the first stage GR_STG[1] may output a first gate signal GR[1] having the high level H. For example, a gate output terminal of the second stage GR_STG[2] may output a second gate signal GR[2] having the high level H. For example, a gate output terminal of the third stage GR_STG[3] may output a third gate signal GR[3] having the high level H.

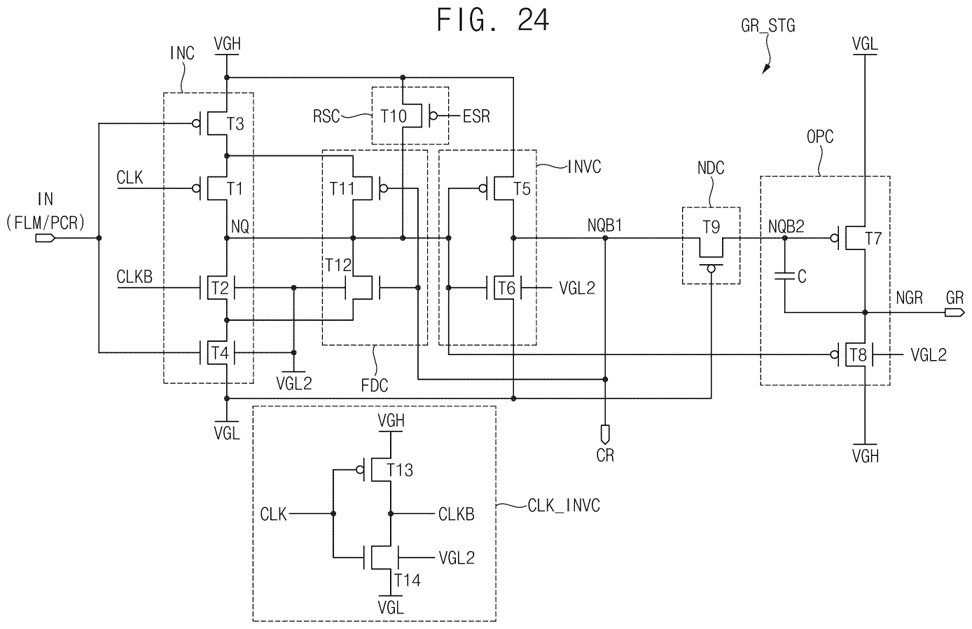

FIG. 24 is a circuit diagram showing an example GR_STG of a stage GR_STG[1], GR_STG[2], GR_STG[3], . . . included in a gate driver 400 of FIG. 22.

Referring to FIGS. 1 to 24, a gate driver 400 according to embodiments of the present invention may include a plurality of stages GR_STG[1], GR_STG[2], GR_STG[3], . . . . The stages GR_STG[1], GR_STG[2], GR_STG[3], . . . have substantially a same configuration and a same operation. Therefore, in FIG. 24, the first stage GR_STG[1] of FIG. 22 is described, and a description of the subsequent stages GR_STG[2], GR_STG[3], . . . of FIG. 22 is omitted.

A stage GR_STG may include an input circuit INC, an inverter circuit INVC, a feedback circuit FDC, and a gate output circuit OPC. In an embodiment, the stage GR_STG may further include a node separation circuit NDC. In an embodiment, the stage GR_STG may further include a reset circuit RSC. In an embodiment, the stage GR_STG may further include a clock inverter circuit CLK_INVC.

The input circuit INC may control a voltage of the control node NQ in response to a clock signal CLK, an inversion clock signal CLKB inverted from the clock signal CLK, and an input signal IN. The input signal IN may be a gate start signal FLM or a previous carry signal PCR.

The input circuit INC may include a first transistor T1, a second transistor T2, a third transistor T3, and a fourth transistor T4.

In an embodiment, the first transistor T1 and the third transistor T3 may be PMOS transistors, and the second transistor T2 and the fourth transistor T4 may be NMOS transistors.

The first transistor T1 may include a gate electrode, which receives a clock signal CLK, a first electrode, and a second electrode connected to a control node NQ. The first transistor T1 may be turned on in response to a clock signal CLK having a low level L.

The second transistor T2 may include a gate electrode, which receives an inversion clock signal CLKB inverted from the clock signal CLK, a first electrode, and a second electrode connected to the control node NQ. The second transistor T2 may further include a back gate electrode, which receives a second low gate voltage VGL2. The second transistor T2 may be turned on in response to an inversion clock signal CLKB having a high level H.

The third transistor T3 may include a gate electrode, which receives the input signal IN, a first electrode, which receives a high gate voltage VGH, and a second electrode connected to the first electrode of the first transistor T1. The third transistor T3 may be turned on in response to an input signal IN having the low level L.

The fourth transistor T4 may include a gate electrode, which receives the input signal IN, a first electrode, which receives a low gate voltage VGL, and a second electrode connected to the first electrode of the second transistor T2. The fourth transistor T4 may further include a back gate electrode, which receives the second low gate voltage VGL2. The low gate voltage VGL may be greater than the second low gate voltage VGL2. The fourth transistor T4 may be turned on in response to an input signal IN having the high level H.

When the first transistor T1 and the third transistor T3 are turned on, the first transistor T1 and the third transistor T3 may provide the high gate voltage VGH to the control node NQ. Accordingly, the voltage of the control node NQ may have the high level H.

When the second transistor T2 and the fourth transistor T4 are turned on, the second transistor T2 and the fourth transistor T4 may provide the low gate voltage VGL to the control node NQ. Accordingly, the voltage of the control node NQ may have the low level L.

The inverter circuit INVC may invert the voltage of the control node NQ and provide the inverted voltage of the control node NQ to the inversion control node NQB1, NQB2. For example, the inverter circuit INVC may invert the voltage of the control node NQ having the high level H and provide the inverted voltage of the control node NQ having the low level L to the inversion control node NQB1, NQB2. For example, the inverter circuit INVC may invert the voltage of the control node NQ having the low level L and provide the inverted voltage of the control node NQ having the high level H to the inversion control node NQB1, NQB2.

The inverter circuit INVC may include a fifth transistor T5 and a sixth transistor T6.

In an embodiment, the fifth transistor T5 may be the PMOS transistor, and the sixth transistor T6 may be the NMOS transistor.

The fifth transistor T5 may include a gate electrode connected to the control node NQ, a first electrode, which receives the high gate voltage VGH, and a second electrode connected to the inversion control node NQB1, NQB2. The fifth transistor T5 may be turned on in response to the voltage of the control node NQ having the low level L to provide the high gate voltage VGH to the inversion control node NQB1, NQB2.

The sixth transistor T6 may include a gate electrode connected to the control node NQ, a first electrode, which receives the low gate voltage VGL, and a second electrode connected to the inversion control node NQB1, NQB2. The sixth transistor T6 may further include a back gate electrode, which receives the second low gate voltage VGL2. The sixth transistor T6 may be turned on in response to the voltage of the control node NQ having the high level H to provide the low gate voltage VGL to the inversion control node NQB1, NQB2.

The gate output circuit OPC may output a gate signal GR in response to the voltage of the control node NQ and the voltage of the inversion control node NQB1, NQB2.

The gate output circuit OPC may include a seventh transistor T7, an eighth transistor T8, and a capacitor C.

In an embodiment, the seventh transistor T7 and the eighth transistor T8 may be PMOS transistors.

The seventh transistor T7 may include a gate electrode connected to the inversion control node NQB1, NQB2, a first electrode, which receives the low gate voltage VGL, and a second electrode connected to a gate output node NGR from which a gate signal GR is output. The seventh transistor T7 may be turned on in response to the voltage of the inversion control node NQB1, NQB2 having the low level L to provide the low gate voltage VGL to the gate output node NGR.

The eighth transistor T8 may include a gate electrode connected to the control node NQ, a first electrode, which receives the high gate voltage VGH, and a second electrode connected to the gate output node NGR. The eighth transistor T8 may further include a back gate electrode, which receives the second low gate voltage VGL2. The eighth transistor T8 may be turned on in response to the voltage of the control node NQ having the low level L to provide the high gate voltage VGH to the gate output node NGR.

The capacitor C may include a first electrode connected to the inversion control node NQB1, NQB2 and a second electrode connected to the gate output node NGR.

The inversion control node NQB1, NQB2 may include a first inversion control node NQB1 and a second inversion control node NQB2.

The node separation circuit NDC may separate the first inversion control node NQB1 and the second inversion control node NQB2.

The node separation circuit NDC may include a ninth transistor T9.

In an embodiment, the ninth transistor T9 may be the PMOS transistor.

The ninth transistor T9 may include a gate electrode, which receives the low gate voltage VGL, a first electrode connected to the first inversion control node NQB1, and a second electrode connected to the second inversion control node NQB2. Since the ninth transistor T9 is turned on in response to the low gate voltage VGL, the ninth transistor T9 may be an always-on transistor (AOT). Since the ninth transistor T9 is the always-on transistor and the PMOS transistor, the ninth transistor T9 may prevent a bootstrapped voltage of the second inversion control node NQB2 from being provided to the first inversion control node NQB1.

The reset circuit RSC may reset the voltage of the control node NQ.

The reset circuit RSC may include a tenth transistor T10.

In an embodiment, the tenth transistor T10 may be the PMOS transistor.

The tenth transistor T10 may include a gate electrode, which receives a reset signal ESR, a first electrode, which receives the high gate voltage VGH, and a second electrode connected to the control node NQ. The tenth transistor T10 may be turned on in response to the reset signal ESR having the low level L to provide the high gate voltage VGH to the control node NQ. Accordingly, the voltage of the control node NQ may be initialized to the high gate voltage VGH. The reset signal ESR may be a global signal which is simultaneously applied to the plurality of stages GR_STG[1], GR_STG[2], GR_STG[3], . . . included in the gate driver 400 of FIG. 22. For example, when a display device is turned on, the reset signal ESR may be simultaneously applied to the stages GR_STG[1], GR_STG[2], GR_STG[3], . . . . Accordingly, node voltages of the stages GR_STG[1], GR_STG[2], GR_STG[3], . . . may be initialized, and a reliability of an operation of the gate driver 400 may be maintained.

The feedback circuit FDC may invert the voltage of the inversion control node NQB1, NQB2 to control the voltage of the control node NQ. The feedback circuit FDC may operate as an inverter circuit. For example, the feedback circuit FDC may invert the voltage of the inversion control node NQB1, NQB2 having the high level H and provide the inverted voltage of the inversion control node NQB1, NQB2 having the low level L to the control node NQ. For example, the feedback circuit FDC may invert the voltage of the inversion control node NQB1, NQB2 having the low level L and provide the inverted voltage of the inversion control node NQB1, NQB2 having the high level H to the control node NQ.

The feedback circuit FDC may include an eleventh transistor T11 and a twelfth transistor T12.

In an embodiment, the eleventh transistor T11 may be the PMOS transistor, and the twelfth transistor T12 may be the NMOS transistor.

The eleventh transistor T11 may include a gate electrode connected to the inversion control node NQB1, NQB2, a first electrode connected to the first electrode of the first transistor T1, and a second electrode connected to the control node NQ. The eleventh transistor T11 may be turned on in response to the voltage of the inversion control node NQB1, NQB2 having the low level L.

The twelfth transistor T12 may include a gate electrode connected to the inversion control node NQB1, NQB2, a first electrode connected to the first electrode of the second transistor T2, and a second electrode connected to the control node NQ. The twelfth transistor T12 may further include a back gate electrode, which receives the second low gate voltage VGL2. The twelfth transistor T12 may be turned on in response to the voltage of the inversion control node NQB1, NQB2 having the high level H.

The clock inverter circuit CLK_INVC may invert the clock signal CLK and output the inversion clock signal CLKB. The clock inverter circuit CLK_INVC may operate as the inverter circuit. For example, the clock inverter circuit CLK_INVC may invert a clock signal CLK having the high level H and output the inverted clock signal CLK having the low level L. For example, the clock inverter circuit CLK_INVC may invert a clock signal CLK having the low level L and output the inverted clock signal CLK having the high level H.

The clock inverter circuit CLK_INVC may include a thirteenth transistor T13 and a fourteenth transistor T14.

In an embodiment, the thirteenth transistor T13 may be the PMOS transistor, and the fourteenth transistor T14 may be the NMOS transistor.

The thirteenth transistor T13 may include a gate electrode, which receives the clock signal CLK, a first electrode, which receives the high gate voltage VGH, and a second electrode outputting the inversion clock signal CLKB. The thirteenth transistor T13 may be turned on in response to the clock signal CLK having the low level L to output the high gate voltage VGH as the inversion clock signal CLKB.

The fourteenth transistor T14 may include a gate electrode, which receives the clock signal CLK, a first electrode, which receives the low gate voltage VGL, and a second electrode outputting the inversion clock signal CLKB. The fourteenth transistor T14 may be turned on in response to the clock signal CLK having the high level H to output the low gate voltage VGL as the inversion clock signal CLKB.

In summary, even if the first clock signal CLK1 and the second clock signal CLK2 of FIG. 4 are designed to have opposite phases, since the first clock signal CLK1 and the second clock signal CLK2 of FIG. 4 are independently generated and applied to the gate driver 200 of FIG. 4, the first clock signal CLK1 and the second clock signal CLK2 do not have the opposite phases and may have a distortion. However, since the inversion clock signal CLKB applied to the stage GR_STG of the gate driver 500 is an inverted clock signal CLK, the clock signal CLK and the inversion clock signal CLKB may be generated dependently and may not have the distortion.

In addition, the stage GR_STG of the gate driver 400 may include the input circuit INC which controls the voltage of the control node NQ, the inverter circuit INVC which inverts the voltage of the control node NQ and provides the inverted voltage of the control node NQ to the inversion control node NQB1, NQB2, and the feedback circuit FDC which inverts the voltage of the inversion control node NQB1, NQB2 to control the voltage of the control node NQ. Therefore, a feedback path may be formed between the control node NQ and the inversion control node NQB1, NQB2, and the voltage of the inversion control node NQB1, NQB2 is determined by the voltage of the control node NQ, but the voltage of the inversion control node NQB1, NQB2 may in turn affect the voltage of the control node NQ. Accordingly, even if a toggling (i.e., a frequency) of the clock signal CLK and the toggling of the inversion clock signal CLKB are reduced in order to reduce a power consumption of the gate driver 400, a node voltage of the stage GR_STG of the gate driver 400 (e.g., the voltage of the control node NQ and the voltage of the inversion control node NQB1, NQB2) may be stabilized.

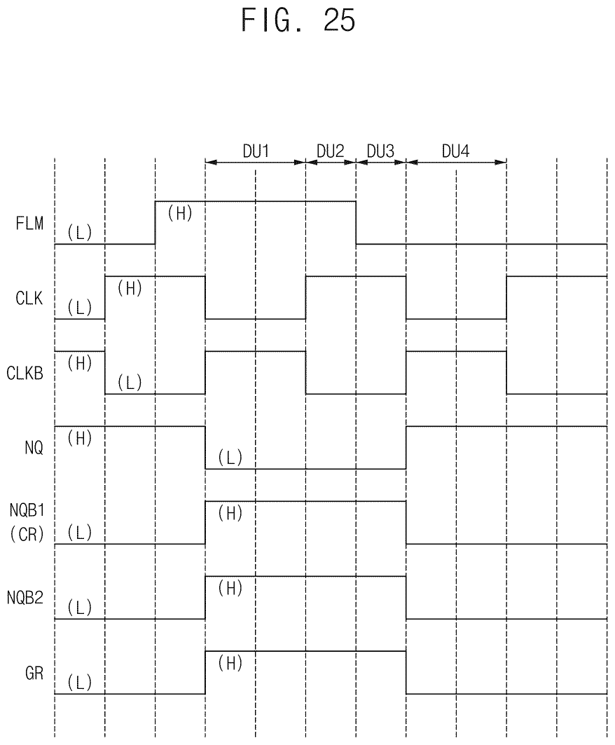

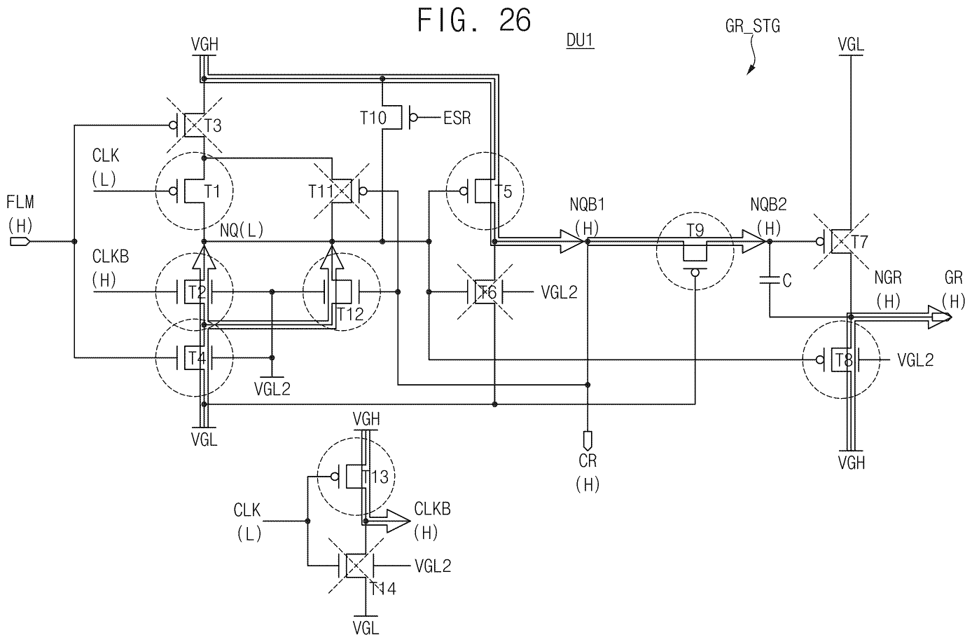

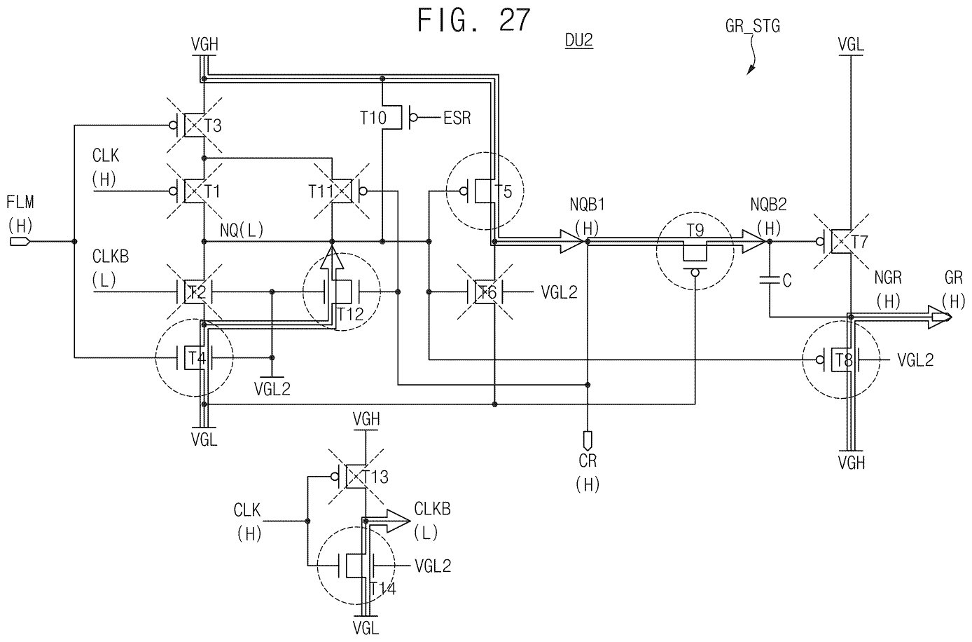

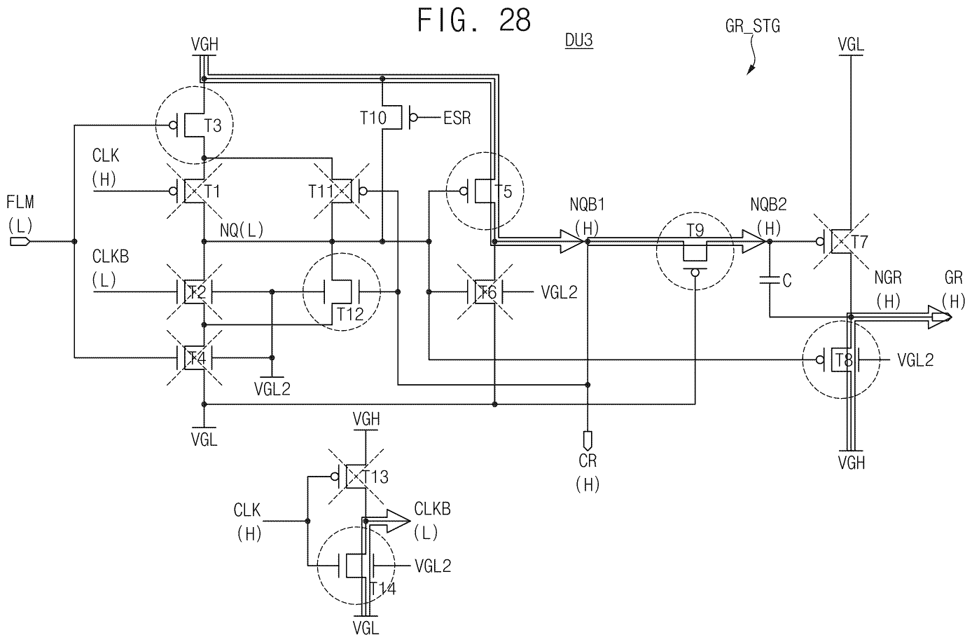

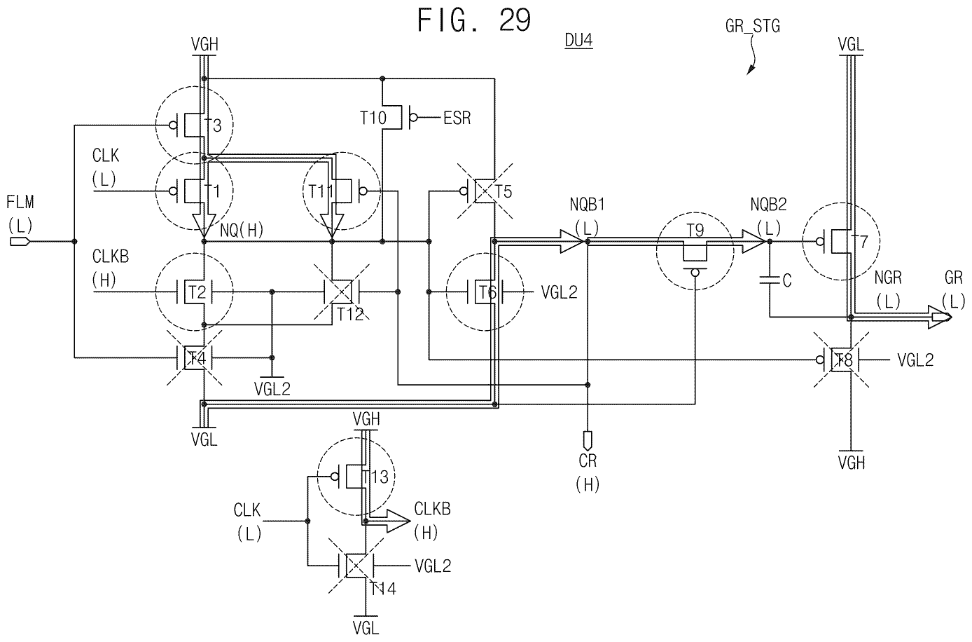

FIG. 25 is a timing diagram showing an example of an operation of a stage GR_STG of FIG. 24. FIG. 26 is a circuit diagram showing an example of an operation of a stage GR_STG of FIG. 24 in a first period DU1 of FIG. 25. FIG. 27 is a circuit diagram showing an example of an operation of a stage GR_STG of FIG. 24 in a second period DU2 of FIG. 25. FIG. 28 is a circuit diagram showing an example of an operation of a stage GR_STG of FIG. 24 in a third period DU3 of FIG. 25. FIG. 29 is a circuit diagram showing an example of an operation of a stage GR_STG of FIG. 24 in a fourth period DU4 of FIG. 25.

Referring to FIGS. 25 and 26, in a first period DU1, the clock signal CLK may have the low level L.

The clock inverter circuit CLK_INVC may invert the clock signal CLK having the low level L and output the inversion clock signal CLKB having the high level H. Specifically, the thirteenth transistor T13 may be turned on in response to the clock signal CLK having the low level L to output the high gate voltage VGH as the inversion clock signal CLKB. The fourteenth transistor T14 may be turned off in response to the clock signal CLK having the low level L.

The gate start signal FLM may have the high level H, the clock signal CLK may have the low level L, and the inversion clock signal CLKB may have the high level H.

The input circuit INC may control the voltage of the control node NQ in response to the gate start signal FLM having the high level H, the clock signal CLK having the low level L, and the inversion clock signal CLKB having the high level H. Specifically, the first transistor T1 may be turned on in response to the clock signal CLK having the low level L. The third transistor T3 may be turned off in response to the gate start signal FLM having the high level H. The second transistor T2 may be turned on in response to the inversion clock signal CLKB having the high level H. The fourth transistor T4 may be turned on in response to the gate start signal FLM having the high level H. Therefore, the second transistor T2 and the fourth transistor T4 may be turned on to provide the low gate voltage VGL to the control node NQ. Therefore, the voltage of the control node NQ may have the low level L.

The inverter circuit INVC may invert the voltage of the control node NQ having the low level L and provide the inverted voltage of the control node NQ having the high level H to the inversion control node NQB1, NQB2. Specifically, the fifth transistor T5 may be turned on in response to the voltage of the control node NQ having the low level L to provide the high gate voltage VGH to the inversion control node NQB1, NQB2. The sixth transistor T6 may be turned off in response to the voltage of the control node NQ having the low level L. Therefore, the voltage of the inversion control node NQB1, NQB2 may have the high level H.

The feedback circuit FDC may invert the voltage of the inversion control node NQB1, NQB2 having the high level H to control the voltage of the control node NQ to the low level L. Specifically, the eleventh transistor T11 may be turned off in response to the voltage of the inversion control node NQB1, NQB2 having the high level H. The twelfth transistor T12 may be turned on in response to the voltage of the inversion control node NQB1, NQB2 having the high level H. Therefore, the fourth transistor T4 and the twelfth transistor T12 may be turned on to provide the low gate voltage VGL to the control node NQ. Accordingly, the voltage of the control node NQ may have the low level L.

Among the inversion control node NQB1, NQB2, the voltage of the first inversion control node NQB1 may have the high level H.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the high level H to the second inversion control node NQB2. Therefore, a voltage of the second inversion control node NQB2 may have the high level H.

The voltage of the inversion control node NQB1, NQB2 may have the high level H.

The gate output circuit OPC may output the gate signal GR in response to the voltage of the control node NQ having the low level L and the voltage of the inversion control node NQB1, NQB2 having the high level H. Specifically, the seventh transistor T7 may be turned off in response to the voltage of the inversion control node NQB1, NQB2 having the high level H. The eighth transistor T8 may be turned on in response to the voltage of the inversion control node NQB1, NQB2 having the low level L to provide the high gate voltage VGH to the gate output node NGR. Therefore, a voltage of the gate output node NGR may have the high level H, and the gate signal GR may have the high level H.

Referring to FIGS. 25 and 27, in a second period DU2, the clock signal CLK may have the high level H.

The clock inverter circuit CLK_INVC may invert the clock signal CLK having the high level H and output the inversion clock signal CLKB having the low level L. Specifically, the thirteenth transistor T13 may be turned off in response to the clock signal CLK having the high level H. The fourteenth transistor T14 may be turned on in response to the clock signal CLK having the high level H to output the low gate voltage VGL as the inversion clock signal CLKB.

The gate start signal FLM may have the high level H, the clock signal CLK may have the high level H, and the inversion clock signal CLKB may have the low level L.

The input circuit INC may control the voltage of the control node NQ in response to the gate start signal FLM having the high level H, the clock signal CLK having the high level H, and the inversion clock signal CLKB having the low level L. Specifically, the first transistor T1 may be turned off in response to the clock signal CLK having the high level H. The third transistor T3 may be turned off in response to the gate start signal FLM having the high level H. The second transistor T2 may be turned off in response to the inversion clock signal CLKB having the low level L. The fourth transistor T4 may be turned on in response to the gate start signal FLM having the high level H. Therefore, the voltage of the control node NQ may be maintained at the low level L.

The inverter circuit INVC may invert the voltage of the control node NQ having the low level L and provide the inverted voltage of the control node NQ having the high level H to the inversion control node NQB1, NQB2. Specifically, the fifth transistor T5 may be turned on in response to the voltage of the control node NQ having the low level L and provide the high gate voltage VGH to the inversion control node NQB1, NQB2. The sixth transistor T6 may be turned off in response to the voltage of the control node NQ having the low level L. Therefore, the voltage of the inversion control node NQB1, NQB2 may have the high level H.

The feedback circuit FDC may invert the voltage of the inversion control node NQB1, NQB2 having the high level H to control the voltage of the control node NQ to the low level L. Specifically, the eleventh transistor T11 may be turned off in response to the voltage of the inversion control node NQB1, NQB2 having the high level H. The twelfth transistor T12 may be turned on in response to the voltage of the inversion control node NQB1, NQB2 having the high level H. Therefore, the fourth transistor T4 and the twelfth transistor T12 may be turned on to provide the low gate voltage VGL to the control node NQ. Accordingly, the voltage of the control node NQ may have the low level L.

A voltage of the first inversion control node NQB1 among the inversion control node NQB1, NQB2 may have the high level H.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the high level H to the second inversion control node NQB2. Therefore, the voltage of the second inversion control node NQB2 may have the high level H.

The voltage of the inversion control node NQB1, NQB2 may have the high level H.

The gate output circuit OPC may output the gate signal GR in response to the voltage of the control node NQ having the low level L and the voltage of the inversion control node NQB1, NQB2 having the high level H. Specifically, the seventh transistor T7 may be turned off in response to the voltage of the inversion control node NQB1, NQB2 having the high level H. The eighth transistor T8 may be turned on in response to the voltage of the inversion control node NQB1, NQB2 having the low level L to provide the high gate voltage VGH to the gate output node NGR. Therefore, a voltage of the gate output node NGR may have the high level H, and the gate signal GR may have the high level H.

Referring to FIGS. 25 and 28, in a third period DU3, the clock signal CLK may have the high level H.

The clock inverter circuit CLK_INVC may invert the clock signal CLK having the high level H and output the inversion clock signal CLKB having the low level L. Specifically, the thirteenth transistor T13 may be turned off in response to the clock signal CLK having the high level H. The fourteenth transistor T14 may be turned on in response to the clock signal CLK having the high level H to output the low gate voltage VGL as the inversion clock signal CLKB.

The gate start signal FLM may have the low level L, the clock signal CLK may have the high level H, and the inversion clock signal CLKB may have the low level L.

The input circuit INC may control the voltage of the control node NQ in response to the gate start signal FLM having the low level L, the clock signal CLK having the high level H, and the inversion clock signal CLKB having the low level L. Specifically, the first transistor T1 may be turned off in response to the clock signal CLK having the high level H. The third transistor T3 may be turned on in response to the gate start signal FLM having the low level L. The second transistor T2 may be turned off in response to the inversion clock signal CLKB having the low level L. The fourth transistor T4 may be turned off in response to the gate start signal FLM having the low level L. Therefore, the voltage of the control node NQ may be maintained at the low level L.

The inverter circuit INVC may invert the voltage of the control node NQ having the low level L and provide the inverted voltage of the control node NQ having the high level H to the inversion control node NQB1, NQB2. Specifically, the fifth transistor T5 may be turned on in response to the voltage of the control node NQ having the low level L to provide the high gate voltage VGH to the inversion control node NQB1, NQB2. The sixth transistor T6 may be turned off in response to the voltage of the control node NQ having the low level L. Therefore, the voltage of the inversion control node NQB1, NQB2 may have the high level H.

The feedback circuit FDC may invert the voltage of the inversion control node NQB1, NQB2 having the high level H to control the voltage of the control node NQ to the low level L. Specifically, the eleventh transistor T11 may be turned off in response to the voltage of the inversion control node NQB1, NQB2 having the high level H. The twelfth transistor T12 may be turned on in response to the voltage of the inversion control node NQB1, NQB2 having the high level H. Therefore, the voltage of the control node NQ may maintain the low level L.

The voltage of the first inversion control node NQB1 among the inversion control node NQB1, NQB2 may have the high level H.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the high level H to the second inversion control node NQB2. Therefore, the voltage of the second inversion control node NQB2 may have the high level H.

The voltage of the inversion control node NQB1, NQB2 may have the high level H.

The gate output circuit OPC may output the gate signal GR in response to the voltage of the control node NQ having the low level L and the voltage of the inversion control node NQB1, NQB2 having the high level H. Specifically, the seventh transistor T7 may be turned off in response to the voltage of the inversion control node NQB1, NQB2 having the high level H. The eighth transistor T8 may be turned on in response to the voltage of the inversion control node NQB1, NQB2 having the low level L to provide the high gate voltage VGH to the gate output node NGR. Therefore, a voltage of the gate output node NGR may have the high level H, and the gate signal GR may have the high level H.

Referring to FIGS. 25 and 29, in a fourth period DU4, the clock signal CLK may have the low level L.

The clock inverter circuit CLK_INVC may invert the clock signal CLK having the low level L and output the inversion clock signal CLKB having the high level H. Specifically, the thirteenth transistor T13 may be turned on in response to the clock signal CLK having the low level L and output the high gate voltage VGH as the inversion clock signal CLKB. The fourteenth transistor T14 may be turned off in response to the clock signal CLK having the low level L.

The gate start signal FLM may have the low level L, the clock signal CLK may have the low level L, and the inversion clock signal CLKB may have the high level H.

The input circuit INC may control the voltage of the control node NQ in response to the gate start signal FLM having the low level L, the clock signal CLK having the low level L, and the inversion clock signal CLKB having the high level H. Specifically, the first transistor T1 may be turned on in response to the clock signal CLK having the low level L. The third transistor T3 may be turned on in response to the gate start signal FLM having the low level L. Therefore, the first transistor T1 and the third transistor T3 may provide the high gate voltage VGH to the control node NQ. The second transistor T2 may be turned on in response to the inversion clock signal CLKB having the high level H. The fourth transistor T4 may be turned off in response to the gate start signal FLM having the low level L. Therefore, the voltage of the control node NQ may maintain the high level H.

The inverter circuit INVC may invert the voltage of the control node NQ having the high level H and provide the inverted voltage of the control node NQ having the low level L to the inversion control node NQB1, NQB2. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB1, NQB2. Therefore, the voltage of the inversion control node NQB1, NQB2 may have the low level L.

The feedback circuit FDC may invert the voltage of the inversion control node NQB1, NQB2 having the low level L to control the voltage of the control node NQ to the high level H. Specifically, the eleventh transistor T11 may be turned on in response to the voltage of the inversion control node NQB1, NQB2 having the low level L. Therefore, the third transistor T3 and the eleventh transistor T11 may be turned on to provide the high gate voltage VGH to the control node NQ. The twelfth transistor T12 may be turned off in response to the voltage of the inversion control node NQB1, NQB2 having the low level L. Therefore, the voltage of the control node NQ may have the high level H.

The voltage of the first inversion control node NQB1 among the inversion control node NQB1, NQB2 may have the low level L.

The node separation circuit NDC may separate the first inversion control node NQB1 and the second inversion control node NQB2. Specifically, the ninth transistor T9 may be turned on in response to the low gate voltage VGL to provide the voltage of the first inversion control node NQB1 having the low level L to the second inversion control node NQB2. Therefore, the voltage of the second inversion control node NQB2 may have the low level L.

The voltage of the inversion control node NQB1, NQB2 may have the low level L.

The gate output circuit OPC may output the gate signal GR in response to the voltage of the control node NQ having the high level H and the voltage of the inversion control node NQB1, NQB2 having the low level L. Specifically, the seventh transistor T7 may be turned on in response to the voltage of the inversion control node NQB1, NQB2 having the low level L to provide the low gate voltage VGL to the gate output node NGR. The eighth transistor T8 may be turned off in response to the voltage of the control node NQ having the high level H. Therefore, the voltage of the gate output node NGR may have the low level L, and the gate signal GR may have the low level L.

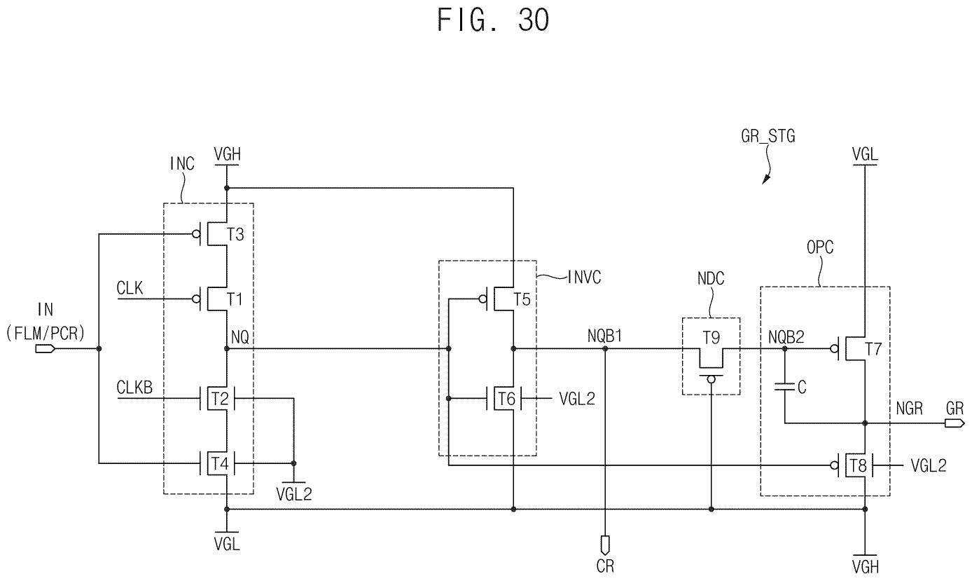

FIG. 30 is a circuit diagram showing an example GR_STG of a stage GR_STG[1], GR_STG[2], GR_STG[3], . . . included in a gate driver 400 of FIG. 22.

Referring to FIGS. 1 to 30, a gate driver 400 according to embodiments of the present invention may include a plurality of stages GR_STG[1], GR_STG[2], GR_STG[3], . . . . In an embodiment, as shown in FIG. 24, some of the stages GR_STG[1], GR_STG[2], GR_STG[3], . . . include the node separation circuit NDC, the reset circuit RSC, the feedback circuit FDC, and the clock inverter circuit CLK_INVC, but as shown in FIG. 30, other stages of the stages GR_STG[1], GR_STG[2], GR_STG[3], . . . may not include at least one of the node separation circuit NDC, the reset circuit RSC, the feedback circuit FDC, and the clock inverter circuit CLK_INVC.

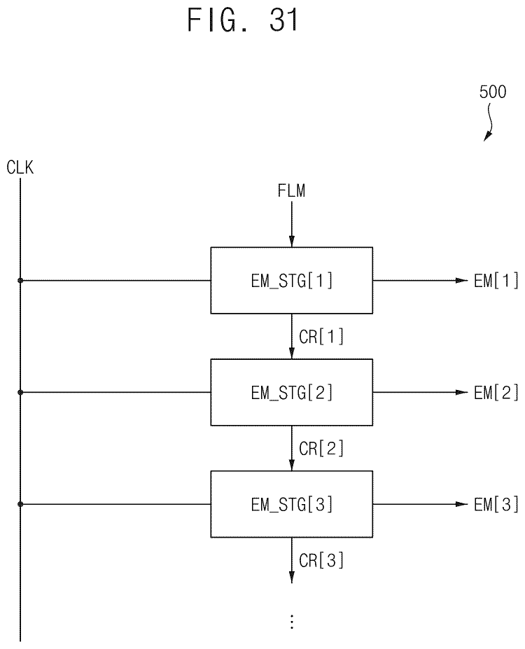

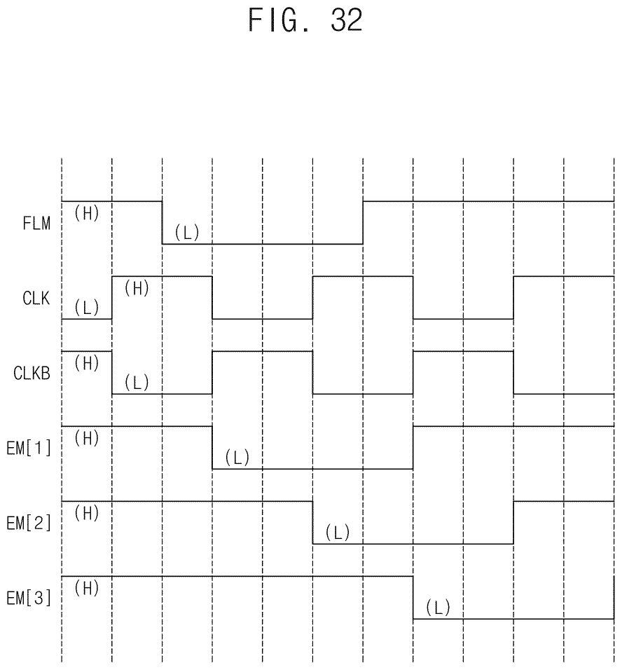

FIG. 31 is a block diagram showing a gate driver 500 according to embodiments of the present invention. FIG. 32 is a timing diagram showing an example of an operation of a gate driver 500 of FIG. 31.

Referring to FIGS. 1 to 32, a gate driver 500 according to embodiments of the present invention may include a plurality of stages EM_STG[1], EM_STG[2], EM_STG[3], . . . . The gate driver 500 may be implemented in the form of a shift register in which the stages EM_STG[1], EM_STG[2], EM_STG[3], . . . sequentially output gate signals EM[1], EM[2], EM[3], . . . .

The stages EM_STG[1], EM_STG[2], EM_STG[3], . . . may receive a gate start signal FLM and a clock signal CLK.

Each of the stages EM_STG[1], EM_STG[2], EM_STG[3], . . . may receive the clock signal CLK. For example, a clock terminal of a first stage EM_STG[1] may receive the clock signal CLK. For example, a clock terminal of a second stage EM_STG[2] may receive the clock signal CLK. For example, a clock terminal of a third stage EM_STG[3] may receive the clock signal CLK.

Each of the stages EM_STG[1], EM_STG[2], EM_STG[3], . . . may receive an input signal (e.g., a gate start signal FLM or a previous carry signal CR[1], CR[2], CR[3], . . . ) in response to the clock signal CLK and an inversion clock signal CLKB inverted from the clock signal CLK. Each of the stages EM_STG[1], EM_STG[2], EM_STG[3], . . . may initiate an operation in response to the input signal. In an embodiment, an odd-numbered stage EM_STG[1], EM_STG[3], . . . may receive the input signal in response to a clock signal CLK having a low level L and an inversion clock signal CLKB having a high level H. In an embodiment, an even-numbered stage EM_STG[2], . . . may receive the input signal in response to a clock signal CLK having the high level H and an inversion clock signal CLKB having the low level L. In an embodiment, an input terminal of the first stage EM_STG[1] may receive the gate start signal FLM. In an embodiment, an input terminal of each of subsequent stages EM_STG[2], EM_STG[3], . . . may receive a carry signal of a previous stage. For example, an input terminal of the first stage EM_STG[1] may receive the gate start signal FLM in response to the clock signal CLK having the low level L and the inversion clock signal CLKB having the high level H. For example, an input terminal of the second stage EM_STG[2] may receive a first carry signal CR[1] of the first stage EM_STG[1] in response to the clock signal CLK having the high level H and the inversion clock signal CLKB having the low level L. For example, an input terminal of the third stage EM_STG[3] may receive a second carry signal CR[2] of the second stage EM_STG[2] in response to the clock signal CLK having the low level L and the inversion clock signal CLKB having the high level H.

The stages EM_STG[1], EM_STG[2], EM_STG[3], . . . may sequentially output carry signals CR[1], CR[2], CR[3], . . . in response to the clock signal CLK and the inversion clock signal CLKB. For example, a carry output terminal of the first stage EM_STG[1] may output the first carry signal CR[1]. For example, a carry output terminal of the second stage EM_STG[2] may output the second carry signal CR[2]. For example, a carry output terminal of the third stage EM_STG[3] may output the third carry signal CR[3].

The stages EM_STG[1], EM_STG[2], EM_STG[3], . . . may sequentially output the gate signals EM[1], EM[2], EM[3], . . . in response to the clock signal CLK and the inversion clock signal CLKB. For example, a gate output terminal of the first stage EM_STG[1] may output a first gate signal EM[1] having the low level L. For example, a gate output terminal of the second stage EM_STG[2] may output a second gate signal EM[2] having the low level L. For example, a gate output terminal of the third stage EM_STG[3] may output a third gate signal EM[3] having the low level L.

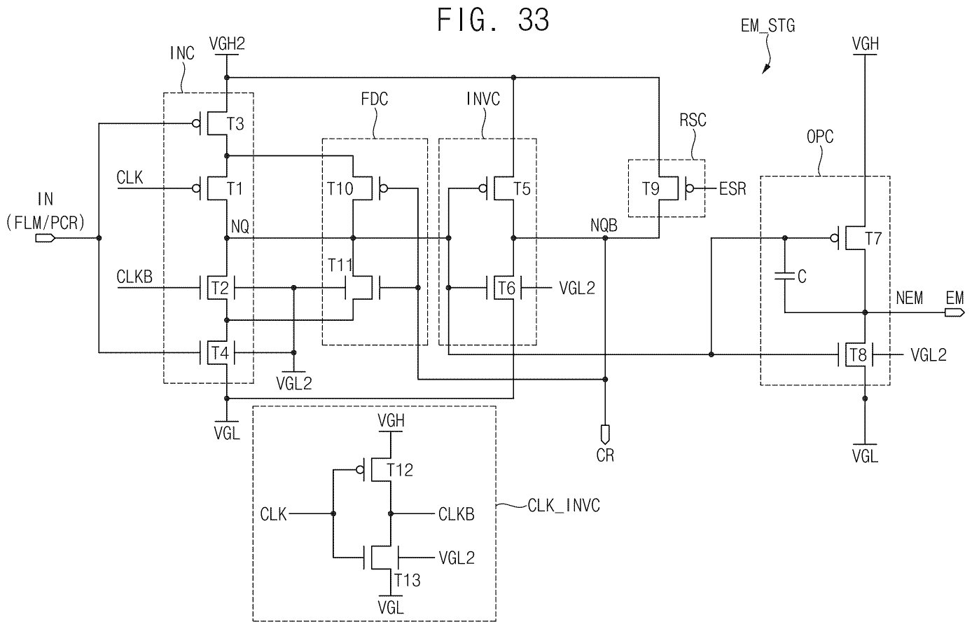

FIG. 33 is a circuit diagram showing an example EM_STG of a stage EM_STG[1], EM_STG[2], EM_STG[3], . . . included in a gate driver 500 of FIG. 31.

Referring to FIGS. 1 to 33, a gate driver 500 according to embodiments of the present invention may include a plurality of stages EM_STG[1], EM_STG[2], EM_STG[3], . . . . The stages EM_STG[1], EM_STG[2], EM_STG[3], . . . have substantially a same configuration and a same operation. Therefore, in FIG. 33, the first stage EM_STG[1] of FIG. 31 is described, and a description of the subsequent stages EM_STG[2], EM_STG[3], . . . of FIG. 31 is omitted.

A stage EM_STG may include an input circuit INC, an inverter circuit INVC, a feedback circuit FDC, and a gate output circuit OPC. In an embodiment, the stage EM_STG may further include a reset circuit RSC. In an embodiment, the stage EM_STG may further include a clock inverter circuit CLK_INVC.

The input circuit INC may control a voltage of a control node NQ in response to a clock signal CLK, an inversion clock signal CLKB inverted from the clock signal CLK, and an input signal IN. The input signal IN may be a gate start signal FLM or a previous carry signal PCR.

The input circuit INC may include a first transistor T1, a second transistor T2, a third transistor T3, and a fourth transistor T4.

In an embodiment, the first transistor T1 and the third transistor T3 may be PMOS transistors, and the second transistor T2 and the fourth transistor T4 may be NMOS transistors.

The first transistor T1 may include a gate electrode, which receives a clock signal CLK, a first electrode, and a second electrode connected to a control node NQ. The first transistor T1 may be turned on in response to a clock signal CLK having a low level L.

The second transistor T2 may include a gate electrode, which receives an inversion clock signal CLKB inverted from the clock signal CLK, a first electrode, and a second electrode connected to the control node NQ. The second transistor T2 may further include a back gate electrode, which receives a second low gate voltage VGL2. The second transistor T2 may be turned on in response to an inversion clock signal CLKB having a high level H.

The third transistor T3 may include a gate electrode, which receives the input signal IN, a first electrode, which receives a second high gate voltage VGH2, and a second electrode connected to the first electrode of the first transistor T1. The third transistor T3 may be turned on in response to an input signal IN having the low level L.

The fourth transistor T4 may include a gate electrode, which receives the input signal IN, a first electrode, which receives a low gate voltage VGL, and a second electrode connected to the first electrode of the second transistor T2. The fourth transistor T4 may further include a back gate electrode, which receives the second low gate voltage VGL2. The low gate voltage VGL may be greater than the second low gate voltage VGL2. The fourth transistor T4 may be turned on in response to an input signal IN having the high level H.

When the first transistor T1 and the third transistor T3 are turned on, the first transistor T1 and the third transistor T3 may provide the second high gate voltage VGH2 to the control node NQ. Accordingly, the voltage of the control node NQ may have the high level H.

When the second transistor T2 and the fourth transistor T4 are turned on, the second transistor T2 and the fourth transistor T4 may provide the low gate voltage VGL to the control node NQ. Accordingly, the voltage of the control node NQ may have the low level L.

The inverter circuit INVC may invert the voltage of the control node NQ and provide the inverted voltage of the control node NQ to the inversion control node NQB. For example, the inverter circuit INVC may invert the voltage of the control node NQ having the high level H and provide the inverted voltage of the control node NQ having the low level L to the inversion control node NQB. For example, the inverter circuit INVC may invert the voltage of the control node NQ having the low level L and provide the inverted voltage of the control node NQ having the high level H to the inversion control node NQB.

The inverter circuit INVC may include a fifth transistor T5 and a sixth transistor T6.

In an embodiment, the fifth transistor T5 may be the PMOS transistor, and the sixth transistor T6 may be the NMOS transistor.

The fifth transistor T5 may include a gate electrode connected to the control node NQ, a first electrode, which receives the second high gate voltage VGH2, and a second electrode connected to the inversion control node NQB. The fifth transistor T5 may be turned on in response to the voltage of the control node NQ having the low level L to provide the second high gate voltage VGH2 to the inversion control node NQB.

The sixth transistor T6 may include a gate electrode connected to the control node NQ, a first electrode, which receives the low gate voltage VGL, and a second electrode connected to the inversion control node NQB. The sixth transistor T6 may further include a back gate electrode, which receives the second low gate voltage VGL2. The sixth transistor T6 may be turned on in response to the voltage of the control node NQ having the high level H to provide the low gate voltage VGL to the inversion control node NQB.

The gate output circuit OPC may output a gate signal EM in response to the voltage of the control node NQ and the voltage of the inversion control node NQB.

The gate output circuit OPC may include a seventh transistor T7, an eighth transistor T8, and a capacitor C.

In an embodiment, the seventh transistor T7 may be the PMOS transistor, and the eighth transistor T8 may be the NMOS transistor.

The seventh transistor T7 may include a gate electrode connected to the inversion control node NQB, a first electrode, which receives a high gate voltage VGH, and a second electrode connected to a gate output node NEM from which a gate signal EM is output. The seventh transistor T7 may be turned on in response to the voltage of the inversion control node NQB having the low level L to provide the high gate voltage VGH to the gate output node NEM.

The eighth transistor T8 may include a gate electrode connected to the inversion control node NQB, a first electrode, which receives the low gate voltage VGL, and a second electrode connected to the gate output node NEM. The eighth transistor T8 may further include a back gate electrode, which receives the second low gate voltage VGL2. The eighth transistor T8 may be turned on in response to the voltage of the inversion control node NQB having the high level H to provide the low gate voltage VGL to the gate output node NEM.

The capacitor C may include a first electrode connected to the inversion control node NQB and a second electrode connected to the gate output node NEM.

The reset circuit RSC may reset the voltage of the inversion control node NQB.

The reset circuit RSC may include a ninth transistor T9.

In an embodiment, the ninth transistor T9 may be the PMOS transistor.

The ninth transistor T9 may include a gate electrode, which receives a reset signal ESR, a first electrode, which receives the second high gate voltage VGH2, and a second electrode connected to the inversion control node NQB. The ninth transistor T9 may be turned on in response to a reset signal ESR having the low level L to provide the second high gate voltage VGH2 to the inversion control node NQB. Accordingly, the voltage of the inversion control node NQB may be initialized to the second high gate voltage VGH2. The reset signal ESR may be a global signal which is simultaneously applied to the plurality of stages EM_STG[1], EM_STG[2], EM_STG[3], . . . included in the gate driver 500 of FIG. 31. For example, when a display device is turned on, the reset signal ESR may be simultaneously applied to the stages EM_STG[1], EM_STG[2], EM_STG[3], . . . . Accordingly, node voltages of the stages EM_STG[1], EM_STG[2], EM_STG[3], . . . may be initialized, and a reliability of an operation of the gate driver 500 may be maintained.

The feedback circuit FDC may invert the voltage of the inversion control node NQB to control the voltage of the control node NQ. The feedback circuit FDC may operate as an inverter circuit. For example, the feedback circuit FDC may invert the voltage of the inversion control node NQB having the high level H and provide the inverted voltage of the inversion control node NQB having the low level L to the control node NQ. For example, the feedback circuit FDC may invert the voltage of the inversion control node NQB having the low level L and provide the inverted voltage of the inversion control node NQB having the high level H to the control node NQ.

The feedback circuit FDC may include a tenth transistor T10 and an eleventh transistor T11.

In an embodiment, the tenth transistor T10 may be the PMOS transistor, and the eleventh transistor T11 may be the NMOS transistor.

The tenth transistor T10 may include a gate electrode connected to the inversion control node NQB, a first electrode connected to the first electrode of the first transistor T1, and a second electrode connected to the control node NQ. The tenth transistor T10 may be turned on in response to the voltage of the inversion control node NQB having the low level L.

The eleventh transistor T11 may include a gate electrode connected to the inversion control node NQB, a first electrode connected to the first electrode of the second transistor T2, and a second electrode connected to the control node NQ. The eleventh transistor T11 may further include a back gate electrode, which receives the second low gate voltage VGL2. The eleventh transistor T11 may be turned on in response to the voltage of the inversion control node NQB having the high level H.

The clock inverter circuit CLK_INVC may invert the clock signal CLK and output the inversion clock signal CLKB. The clock inverter circuit CLK_INVC may operate as the inverter circuit. For example, the clock inverter circuit CLK_INVC may invert the clock signal CLK having the high level H and output the inverted clock signal CLK having the low level L. For example, the clock inverter circuit CLK_INVC may invert a clock signal CLK having the low level L and output the inverted clock signal CLK having the high level H.

The clock inverter circuit CLK_INVC may include a twelfth transistor T12 and a thirteenth transistor T13.

In an embodiment, the twelfth transistor T12 may be the PMOS transistor, and the thirteenth transistor T13 may be the NMOS transistor.

The twelfth transistor T12 may include a gate electrode, which receives the clock signal CLK, a first electrode, which receives the high gate voltage VGH, and a second electrode outputting the inversion clock signal CLKB. The thirteenth transistor T13 may be turned on in response to the clock signal CLK having the low level L to output the high gate voltage VGH as the inversion clock signal CLKB.

The thirteenth transistor T13 may include a gate electrode, which receives the clock signal CLK, a first electrode, which receives the low gate voltage VGL, and a second electrode outputting the inversion clock signal CLKB. The thirteenth transistor T13 may be turned on in response to the clock signal CLK having the high level H to output the low gate voltage VGL as the inversion clock signal CLKB.

In summary, even if the first clock signal CLK1 and the second clock signal CLK2 of FIG. 4 are designed to have opposite phases, since the first clock signal CLK1 and the second clock signal CLK2 of FIG. 4 are independently generated and applied to the gate driver 200 of FIG. 4, the first clock signal CLK1 and the second clock signal CLK2 may not have opposite phases and may have a distortion. However, since the inversion clock signal CLKB applied to the stage EM_STG of the gate driver 500 is an inverted clock signal CLK, the clock signal CLK and the inversion clock signal CLKB may be generated dependently and may not have the distortion.

In addition, the stage EM_STG of the gate driver 500 may include the input circuit INC which controls the voltage of the control node NQ, the inverter circuit INVC which inverts the voltage of the control node NQ and provides the inverted voltage of the control node NQ to the inversion control node NQB, and the feedback circuit FDC which inverts the voltage of the inversion control node NQB to control the voltage of the control node NQ. Therefore, a feedback path may be formed between the control node NQ and the inversion control node NQB, and the voltage of the inversion control node NQB is determined by the voltage of the control node NQ, but the voltage of the inversion control node NQB may in turn affect the voltage of the control node NQ. Accordingly, even if a toggling (i.e., a frequency) of the clock signal CLK and the toggling of the inversion clock signal CLKB are reduced in order to reduce the power consumption of the gate driver 500, a node voltage of the stage EM_STG of the gate driver 500 (e.g., the voltage of the control node NQB and the voltage of the inversion control node NQB) may be stabilized.

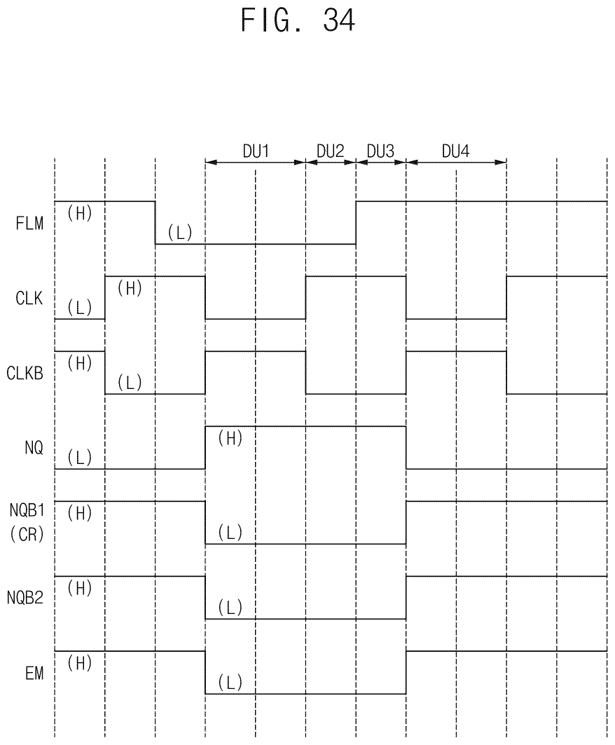

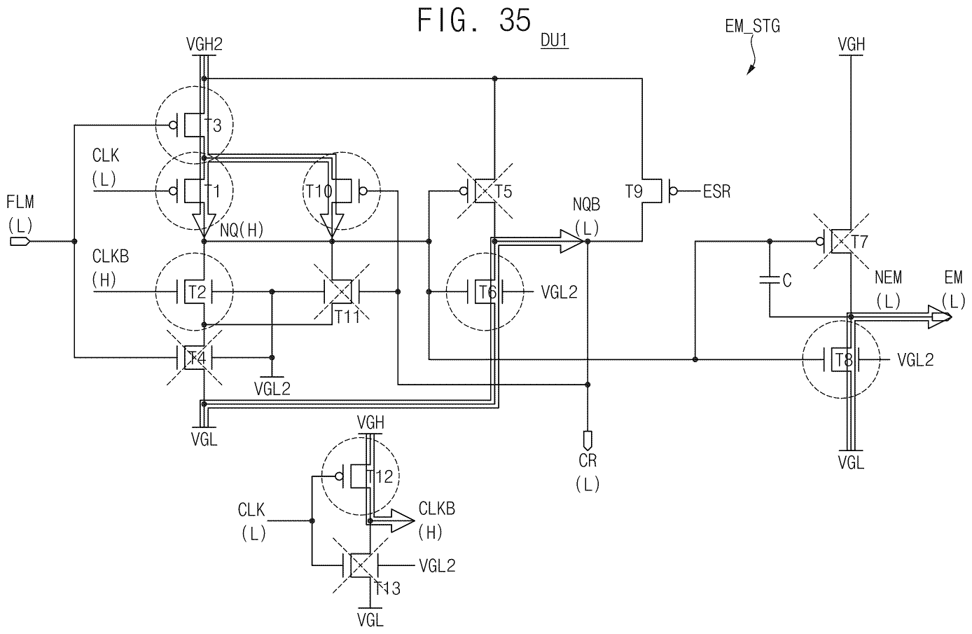

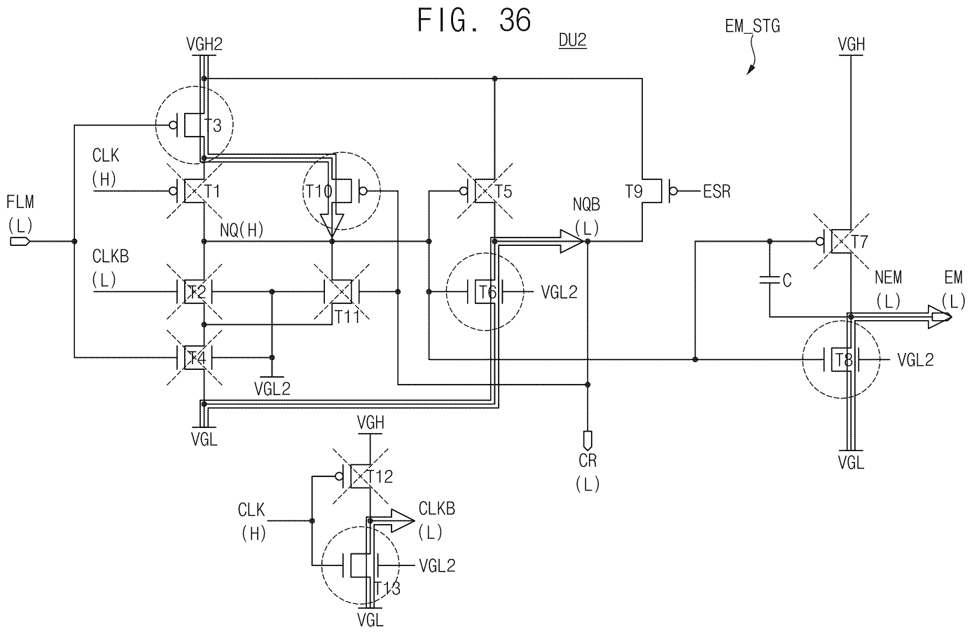

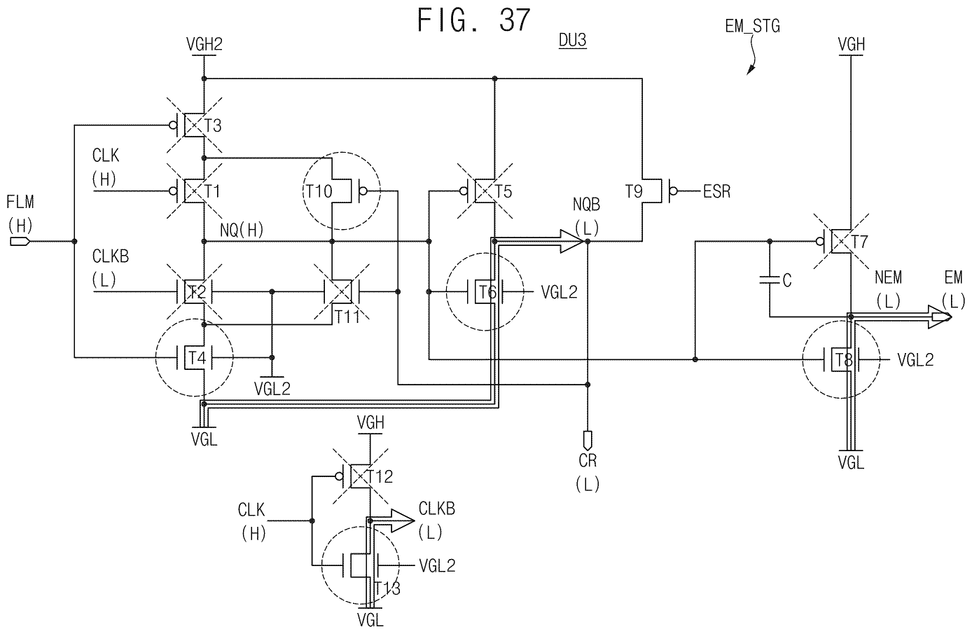

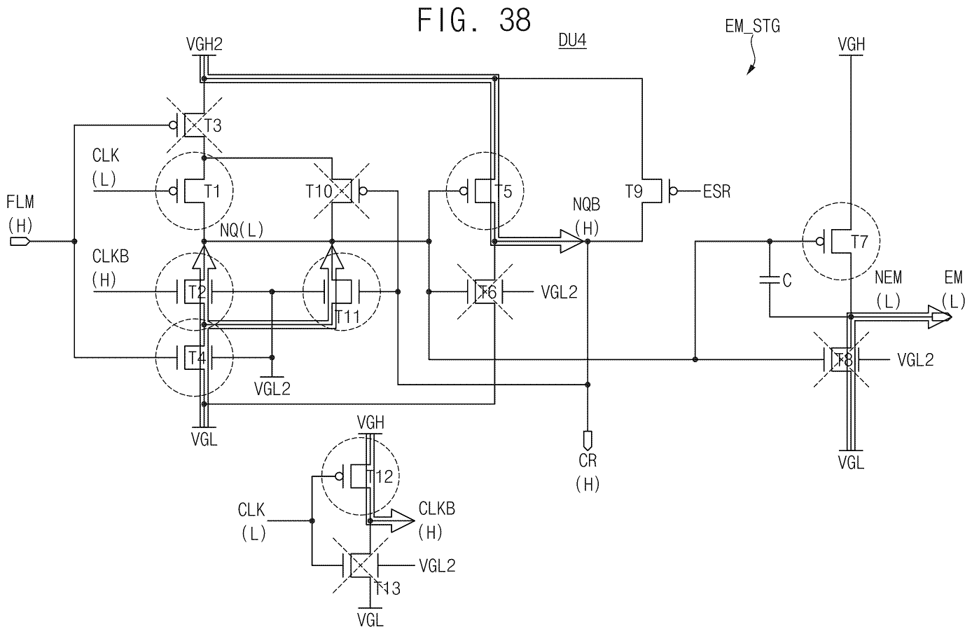

FIG. 34 is a timing diagram showing an example of an operation of a stage EM_STG of FIG. 33. FIG. 35 is a circuit diagram showing an example of an operation of a stage EM_STG of FIG. 33 in a first period DU1 of FIG. 34. FIG. 36 is a circuit diagram showing an example of an operation of a stage EM_STG of FIG. 33 in a second period DU2 of FIG. 34. FIG. 37 is a circuit diagram showing an example of an operation of a stage EM_STG of FIG. 33 in a third period DU3 of FIG. 34. FIG. 38 is a circuit diagram showing an example of an operation of a stage EM_STG of FIG. 33 in a fourth period DU4 of FIG. 34.

Referring to FIGS. 34 and 35, in a first period DU1, the clock signal CLK may have the low level L.

The clock inverter circuit CLK_INVC may invert the clock signal CLK having the low level L and output the inversion clock signal CLKB having the high level H. Specifically, the twelfth transistor T12 may be turned on in response to the clock signal CLK having the low level L to output the high gate voltage VGH as the inversion clock signal CLKB. The thirteenth transistor T13 may be turned off in response to the clock signal CLK having the low level L.

The gate start signal FLM may have the low level L, the clock signal CLK may have the low level L, and the inversion clock signal CLKB may have the high level H.

The input circuit INC may control the voltage of the control node NQ in response to the gate start signal FLM having the low level L, the clock signal CLK having the low level L, and the inversion clock signal CLKB having the high level H. Specifically, the first transistor T1 may be turned on in response to the clock signal CLK having the low level L. The third transistor T3 may be turned on in response to the gate start signal FLM having the low level L. Therefore, the first transistor T1 and the third transistor T3 may be turned on to provide the second high gate voltage VGH2 to the control node NQ. The second transistor T2 may be turned on in response to the inversion clock signal CLKB having the high level H. The fourth transistor T4 may be turned off in response to the gate start signal FLM having the low level L. Therefore, the voltage of the control node NQ may have the high level H.

The inverter circuit INVC may invert the voltage of the control node NQ having the high level H and provide the inverted voltage of the control node NQ having the low level L to the inversion control node NQB. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB. Therefore, the voltage of the inversion control node NQB may have the low level L.

The feedback circuit FDC may invert the voltage of the inversion control node NQB having the low level L to control the voltage of the control node NQ to the high level H. Specifically, the tenth transistor T10 may be turned on in response to the voltage of the inversion control node NQB having the low level L. The eleventh transistor T11 may be turned off in response to the voltage of the inversion control node NQB having the low level L. Therefore, the third transistor T3 and the tenth transistor T10 may be turned on to provide the second high gate voltage VGH2 to the control node NQ. Accordingly, the voltage of the control node NQ may have the high level H.

The gate output circuit OPC may output the gate signal EM in response to the voltage of the control node NQ having the high level H. Specifically, the seventh transistor T7 may be turned off in response to the voltage of the control node NQ having the high level H. The eighth transistor T8 may be turned on in response to the voltage of the control node NQ having the high level H to provide the low gate voltage VGL to the gate output node NEM. Therefore, the voltage of the gate output node NEM may have the low level L, and the gate signal EM may have the low level L.

Referring to FIGS. 34 and 36, in a second period DU2, the clock signal CLK may have the high level H.

The clock inverter circuit CLK_INVC may invert the clock signal CLK having the high level H and output the inversion clock signal CLKB having the low level L. Specifically, the twelfth transistor T12 may be turned off in response to the clock signal CLK having the high level H. The thirteenth transistor T13 may be turned on in response to the clock signal CKL having the high level H to output the low gate voltage VGL as the inversion clock signal CLKB.

The gate start signal FLM may have the low level L, the clock signal CLK may have the high level H, and the inversion clock signal CLKB may have the low level L.

The input circuit INC may control the voltage of the control node NQ in response to the gate start signal FLM having the low level L, the clock signal CLK having the high level H, and the inversion clock signal CLKB having the low level L. Specifically, the first transistor T1 may be turned off in response to the clock signal CLK having the high level H. The third transistor T3 may be turned on in response to the gate start signal FLM having the low level L. The second transistor T2 may be turned off in response to the inversion clock signal CLKB having the low level L. The fourth transistor T4 may be turned off in response to the gate start signal FLM having the low level L. Therefore, the voltage of the control node NQ may maintain the high level H.

The inverter circuit INVC may invert the voltage of the control node NQ having the high level H and provide the inverted voltage of the control node NQ having the low level L to the inversion control node NQB. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB. Therefore, the voltage of the inversion control node NQB may have the low level L.

The feedback circuit FDC may invert the voltage of the inversion control node NQB having the low level L to control the voltage of the control node NQ to the high level H. Specifically, the tenth transistor T10 may be turned on in response to the voltage of the inversion control node NQB having the low level L. The eleventh transistor T11 may be turned off in response to the voltage of the inversion control node NQB having the low level L. Therefore, the third transistor T3 and the tenth transistor T10 may be turned on to provide the second high gate voltage VGH2 to the control node NQ. Accordingly, the voltage of the control node NQ may have the high level H.

The gate output circuit OPC may output the gate signal EM in response to the voltage of the control node NQ having the high level H. Specifically, the seventh transistor T7 may be turned off in response to the voltage of the control node NQ having the high level H. The eighth transistor T8 may be turned on in response to the voltage of the control node NQ having the high level H to provide the low gate voltage VGL to the gate output node NEM. Therefore, the voltage of the gate output node NEM may have the low level L, and the gate signal EM may have the low level L.

Referring to FIGS. 34 and 37, in a third period DU3, the clock signal CLK may have the high level H.

The clock inverter circuit CLK_INVC may invert the clock signal CLK having the high level H and output the inversion clock signal CLKB having the low level L. Specifically, the twelfth transistor T12 may be turned off in response to the clock signal CLK having the high level H. The thirteenth transistor T13 may be turned on in response to the clock signal CKL having the high level H to output the low gate voltage VGL as the inversion clock signal CLKB.

The gate start signal FLM may have the high level H, the clock signal CLK may have the high level H, and the inversion clock signal CLKB may have the low level L.

The input circuit INC may control the voltage of the control node NQ in response to the gate start signal FLM having the high level H, the clock signal CLK having the high level H, and the inversion clock signal CLKB having the low level L. Specifically, the first transistor T1 may be turned off in response to the clock signal CLK having the high level H. The third transistor T3 may be turned off in response to the gate start signal FLM having the high level H. The second transistor T2 may be turned off in response to the inversion clock signal CLKB having the low level L. The fourth transistor T4 may be turned off in response to the gate start signal FLM having the high level H. Therefore, the voltage of the control node NQ may maintain the high level H.

The inverter circuit INVC may invert the voltage of the control node NQ having the high level H and provide the inverted voltage of the control node NQ having the low level L to the inversion control node NQB. Specifically, the fifth transistor T5 may be turned off in response to the voltage of the control node NQ having the high level H. The sixth transistor T6 may be turned on in response to the voltage of the control node NQ having the high level H to provide the low gate voltage VGL to the inversion control node NQB. Therefore, the voltage of the inversion control node NQB may have the low level L.

The feedback circuit FDC may invert the voltage of the inversion control node NQB having the low level L to control the voltage of the control node NQ to the high level H. Specifically, the tenth transistor T10 may be turned on in response to the voltage of the inversion control node NQB having the low level L. The eleventh transistor T11 may be turned off in response to the voltage of the inversion control node NQB having the low level L. Therefore, the voltage of the control node NQ may maintain the high level H.

The gate output circuit OPC may output the gate signal EM in response to the voltage of the control node NQ having the high level H. Specifically, the seventh transistor T7 may be turned off in response to the voltage of the control node NQ having the high level H. The eighth transistor T8 may be turned on in response to the voltage of the control node NQ having the high level H to provide the low gate voltage VGL to the gate output node NEM. Therefore, the voltage of the gate output node NEM may have the low level L, and the gate signal EM may have the low level L.

Referring to FIGS. 34 and 38, in a fourth period DU4, the clock signal CLK may have the low level L.

The clock inverter circuit CLK_INVC may invert the clock signal CLK having the low level L and output the inversion clock signal CLKB having the high level H. Specifically, the twelfth transistor T12 may be turned on in response to the clock signal CLK having the low level L and output the high gate voltage VGH as the inversion clock signal CLKB. The thirteenth transistor T13 may be turned off in response to the clock signal CKL having the low level L.

The gate start signal FLM may have the high level H, the clock signal CLK may have the low level L, and the inversion clock signal CLKB may have the high level H.

The input circuit INC may control the voltage of the control node NQ in response to the gate start signal FLM having the high level H, the clock signal CLK having the low level L, and the inversion clock signal CLKB having the high level H. Specifically, the first transistor T1 may be turned on in response to the clock signal CLK having the low level L. The third transistor T3 may be turned off in response to the gate start signal FLM having the high level H. The second transistor T2 may be turned on in response to the inversion clock signal CLKB having the high level H. The fourth transistor T4 may be turned off in response to the gate start signal FLM having the high level H. Therefore, the second transistor T2 and the fourth transistor T4 may be turned on to provide the low gate voltage VGL to the control node NQ. Accordingly, the voltage of the control node NQ may have the low level L.

The inverter circuit INVC may invert the voltage of the control node NQ having the low level L and provide the inverted voltage of the control node NQ having the high level H to the inversion control node NQB. Specifically, the fifth transistor T5 may be turned on in response to the voltage of the control node NQ having the low level L to provide the second high gate voltage VGH2 to the inversion control node NQB. The sixth transistor T6 may be turned off in response to the voltage of the control node NQ having the low level L. Therefore, the voltage of the inversion control node NQB may have the high level H.

The feedback circuit FDC may invert the voltage of the inversion control node NQB having the high level H to control the voltage of the control node NQ to the low level L. Specifically, the tenth transistor T10 may be turned off in response to the voltage of the inversion control node NQB having the high level H. The eleventh transistor T11 may be turned on in response to the voltage of the inversion control node NQB having the high level H. Therefore, the fourth transistor T4 and the eleventh transistor T11 may be turned on to provide the low gate voltage VGL to the control node NQ. Accordingly, the voltage of the control node NQ may have the low level L.

The gate output circuit OPC may output the gate signal EM in response to the voltage of the control node NQ having the low level L. Specifically, the seventh transistor T7 may be turned on in response to the voltage of the control node NQ having the low level L to provide the high gate voltage VGH to the gate output node NEM. The eighth transistor T8 may be turned off in response to the voltage of the control node NQ having the low level L. Therefore, the voltage of the gate output node NEM may have the low level L, and the gate signal EM may have the low level L.

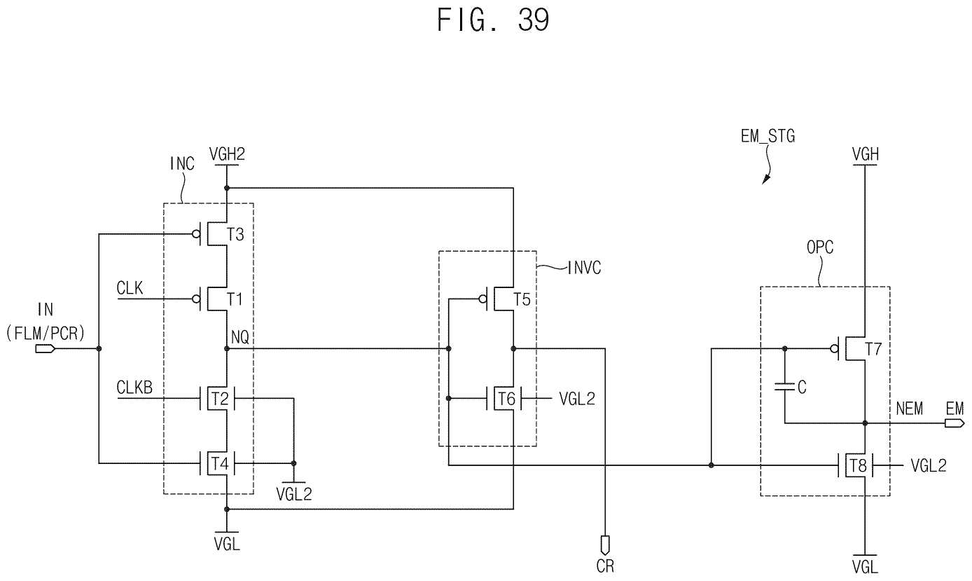

FIG. 39 is a circuit diagram showing an example EM_STG of a stage EM_STG[1], EM_STG[2], EM_STG[3], . . . included in a gate driver 500 of FIG. 31.

Referring to FIGS. 1 to 39, a gate driver 500 according to embodiments of the present invention may include a plurality of stages EM_STG[1], EM_STG[2], EM_STG[3], . . . . In an embodiment, as shown in FIG. 33, some of the stages EM_STG[1], EM_STG[2], EM_STG[3], . . . include the reset circuit RSC, the feedback circuit FDC, and the clock inverter circuit CLK_INVC, but as shown in FIG. 39, other stages of the stages EM_STG[1], EM_STG[2], EM_STG[3], . . . may not include at least one of the reset circuit RSC, the feedback circuit FDC, and the clock inverter circuit CLK_INVC.

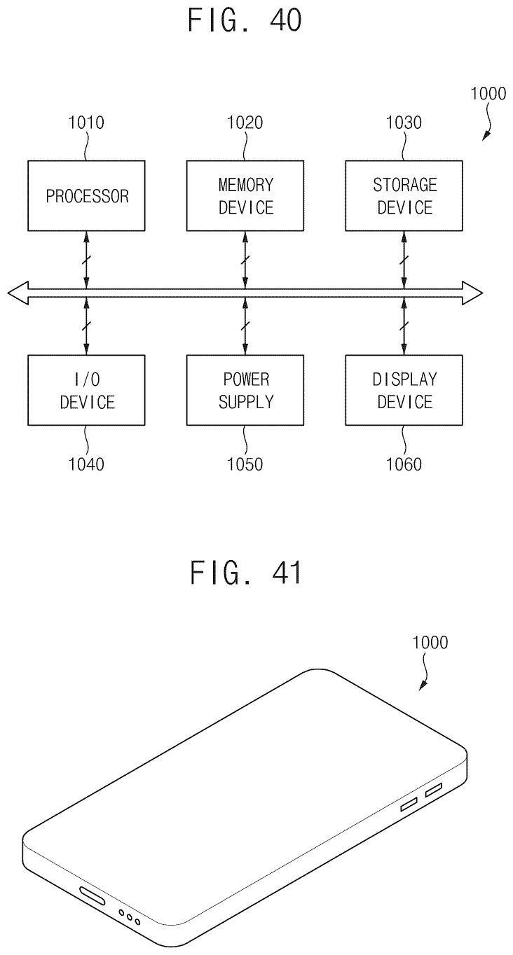

FIG. 40 is a block diagram showing an electronic device 1000 according to an embodiment of the present invention. FIG. 41 is a diagram showing an example in which the electronic device 1000 of FIG. 40 is implemented as a smart phone.

Referring to FIGS. 1 to 41, the electronic device 1000 may include a processor 1010, a memory device 1020, a storage device 1030, an input/output (I/O) device 1040, a power supply 1050 and a display device 1060. Here, the display device 1060 may be the display device of FIG. 1. In addition, the electronic device 1000 may further include a plurality of ports for communicating with a video card, a sound card, a memory card, a universal serial bus (USB) device, other electronic devices, etc.

In an embodiment, as shown in FIG. 41, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 120 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

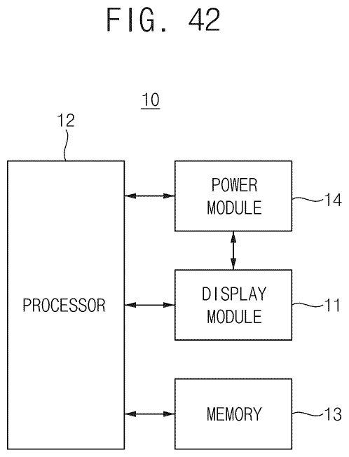

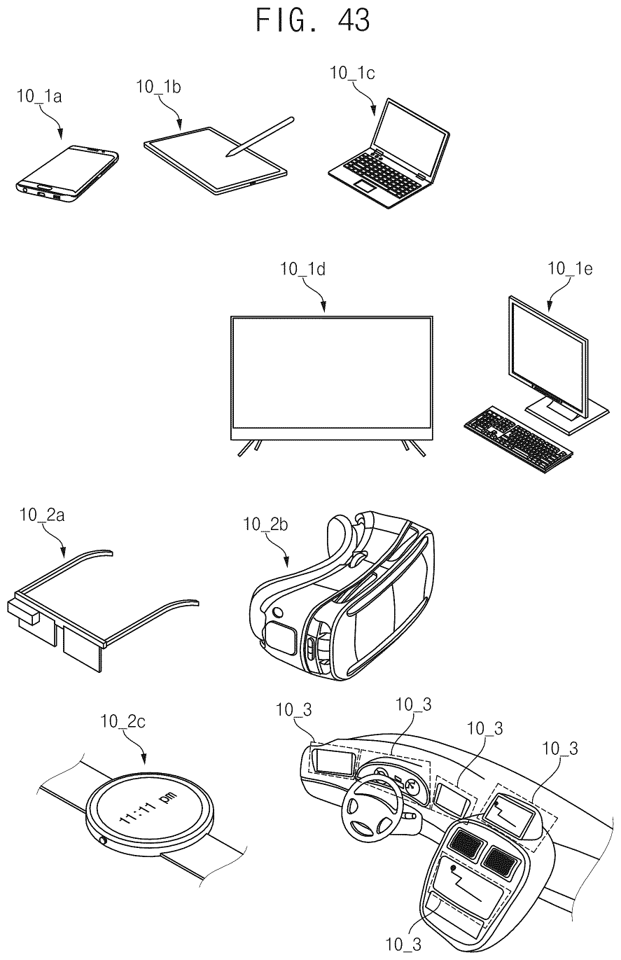

FIG. 42 is a block diagram showing an electronic device 10 according to an embodiment of the present invention. FIG. 43 is schematic diagrams showing electronic devices of FIG. 42.

Referring to FIG. 42, the electronic device 10 according to an embodiment may include a display module 11, a processor 12, a memory 13 and a power module 14.

The display device according to the embodiment of the present invention may be applied to various electronic devices.

In an embodiment, the electronic device 10 may include the display device of FIG. 1. An operation of the display device included in the electronic device 10 may be the same as the operation of the display device explained referring to FIGS. 1 to 39. The electronic device 10 may further include a module or an device having additional functions in addition to the display device.

The processor 12 may include at least one of a central processing unit (CPU), a application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 120 included in the display device of FIG. 1.

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller, which receives an image signal from the main processor and processing the image signal to match interface specifications of the display module 11. For example, the auxiliary processor may include the driving controller 120 included in the display device of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information required for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power required for the operation of the electronic device 10.

At least one of the elements of the electronic device 10 may be included in the display device according to embodiments of the present invention. In addition, a part of a single functional module may be included in the display device and another part of the single functional module may be disposed out of the display device. For example, the display module 11 may be included in the display device but the processor 12, the memory 13 and the power module 14 may be included in another device in the electronic device 10 which is not the display device.

Referring to FIG. 43, the various electronic devices including the display device according to the present embodiments may include electronic devices for displaying image such as a smartphone 10_1a, a tablet PC 10_1b, a laptop 10_1c, a television 10_1d, a desktop monitor 10_1e, wearable electronic devices including a display module such as smart glasses 10_2a, a head mounted display 10_2b and a smart watch 10_2c and vehicle electronic devices 10_3 including display modules such as a CID (center information display), a room mirror display disposed on an instrument panel, center fascia, and a dashboard of a vehicle. The electronic device 10 may not be limited to the electronic devices for displaying image, the wearable electronic devices and the vehicle electronic devices 10_3.

According to the driver, the display device including the driver and the electronic device including the driver of the present embodiment as explained above, the power consumption of the display device may be reduced.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A gate driver comprising:
an input circuit, which controls a voltage of a control node in response to a clock signal, an inversion clock signal, which is an inverted signal of the clock signal, and an input signal;
an inverter circuit, which inverts the voltage of the control node and provides the inverted voltage of the control node to an inversion control node;
a feedback circuit, which inverts a voltage of the inversion control node and controls the voltage of the control node; and
a gate output circuit, which outputs a gate signal in response to the voltage of the control node or the voltage of the inversion control node.

2. The gate driver of claim 1, wherein the input circuit includes:
a first transistor including a gate electrode, which receives the clock signal, a first electrode, and a second electrode connected to the control node;
a second transistor including a gate electrode, which receives the inversion clock signal, a first electrode, and a second electrode connected to the control node;
a third transistor including a gate electrode, which receives the input signal, a first electrode, which receives a high gate voltage, and a second electrode connected to the first electrode of the first transistor; and
a fourth transistor including a gate electrode, which receives the input signal, a first electrode, which receives a low gate voltage, and a second electrode connected to the first electrode of the second transistor.

3. The gate driver of claim 2, wherein the first transistor and the third transistor are p-channel metal-oxide-semiconductor field-effect transistor (PMOS) transistors, and the second transistor and the fourth transistor are n-channel metal-oxide-semiconductor field-effect transistor (NMOS) transistors.

4. The gate driver of claim 2, wherein the inverter circuit includes:
a fifth transistor including a gate electrode connected to the control node, a first electrode, which receives the high gate voltage, and a second electrode connected to the inversion control node; and
a sixth transistor including a gate electrode connected to the control node, a first electrode, which receives the low gate voltage, and a second electrode connected to the inversion control node.

5. The gate driver of claim 4, wherein the fifth transistor is a PMOS transistor and the sixth transistor is an NMOS transistor.

6. The gate driver of claim 2, wherein the feedback circuit includes:
a seventh transistor including a gate electrode connected to the inversion control node, a first electrode connected to the first electrode of the first transistor, and a second electrode connected to the control node; and
an eighth transistor including a gate electrode connected to the inversion control node, a first electrode connected to the first electrode of the second transistor, and a second electrode connected to the control node.

7. The gate driver of claim 6, wherein the seventh transistor is a PMOS transistor and the eighth transistor is an NMOS transistor.

8. The gate driver of claim 2, wherein the gate output circuit includes:
a ninth transistor including a gate electrode electrically connected to the inversion control node, a first electrode, which receives a gate clock signal, and a second electrode connected to a gate output node from which the gate signal is output; and
a tenth transistor including a gate electrode connected to the inversion control node, a first electrode, which receives the low gate voltage, and a second electrode connected to the gate output node.

9. The gate driver of claim 8, wherein the ninth transistor is a PMOS transistor and the tenth transistor is an NMOS transistor.

10. The gate driver of claim 8, wherein the inversion control node includes a first inversion control node and a second inversion control node, and the gate driver further includes a node separation circuit, which separates the first inversion control node and the second inversion control node, and
wherein the node separation circuit includes an eleventh transistor including a gate electrode, which receives the low gate voltage, a first electrode connected to the first inversion control node, and a second electrode connected to the second inversion control node.

11. The gate driver of claim 8, wherein the gate driver further includes a reset circuit, which resets the voltage of the inversion control node, and
wherein the reset circuit includes a twelfth transistor including a gate electrode, which receives a reset signal, a first electrode, which receives the high gate voltage, and a second electrode connected to the inversion control node.

12. The gate driver of claim 8, wherein the gate driver further includes a clock inverter circuit, which inverts the clock signal and outputs the inversion clock signal, and
wherein the clock inverter circuit includes:
a thirteenth transistor including a gate electrode, which receives the clock signal, a first electrode, which receives the high gate voltage, and a second electrode, which outputs the inversion clock signal; and
a fourteenth transistor including a gate electrode, which receives the clock signal, a first electrode, which receives the low gate voltage, and a second electrode, which outputs the inversion clock signal.

13. The gate driver of claim 12, wherein the thirteenth transistor is a PMOS transistor and the fourteenth transistor is an NMOS transistor.

14. The gate driver of claim 2, wherein the gate output circuit includes:
a ninth transistor including a gate electrode electrically connected to the inversion control node, a first electrode, which receives the low gate voltage, and a second electrode connected to a gate output node from which the gate signal is output; and
a tenth transistor including a gate electrode connected to the control node, a first electrode, which receives the high gate voltage, and a second electrode connected to the gate output node.

15. The gate driver of claim 14, wherein the ninth transistor and the tenth transistor are PMOS transistors.

16. The gate driver of claim 14, wherein the inversion control node includes a first inversion control node and a second inversion control node, and the gate driver further includes a node separation circuit, which separates the first inversion control node and the second inversion control node, and
wherein the node separation circuit includes an eleventh transistor including a gate electrode, which receives the low gate voltage, a first electrode connected to the first inversion control node, and a second electrode connected to the second inversion control node.

17. The gate driver of claim 14, wherein the gate driver further includes a reset circuit, which resets the voltage of the control node, and
wherein the reset circuit includes a twelfth transistor including a gate electrode, which receives a reset signal, a first electrode, which receives the high gate voltage, and a second electrode connected to the control node.

18. The gate driver of claim 14, wherein the gate driver further includes a clock inverter circuit, which inverts the clock signal and outputs the inversion clock signal, and
wherein the clock inverter circuit includes:
a thirteenth transistor including a gate electrode, which receives the clock signal, a first electrode, which receives the high gate voltage, and a second electrode, which outputs the inversion clock signal; and
a fourteenth transistor including a gate electrode, which receives the clock signal, a first electrode, which receives the low gate voltage, and a second electrode, which outputs the inversion clock signal.

19. A display device comprising:
a display panel including a pixel;
a gate driver, which provides a gate signal to the pixel;
a data driver, which provides a data voltage to the pixel; and
a driving controller, which controls the gate driver and the data driver,
wherein the gate driver comprises:
an input circuit, which controls a voltage of a control node in response to a clock signal, an inversion clock signal, which is an inverted signal of the clock signal, and an input signal;
an inverter circuit, which inverts the voltage of the control node and provides the inverted voltage of the control node to an inversion control node;
a feedback circuit, which inverts a voltage of the inversion control node and controls the voltage of the control node; and
a gate output circuit, which outputs a gate signal in response to the voltage of the control node or the voltage of the inversion control node.

20. An electronic device comprising:
a display panel including a pixel;
a gate driver, which provides a gate signal to the pixel;
a data driver, which provides a data voltage to the pixel;
a driving controller, which controls the gate driver and the data driver; and
a processor, which controls the driving controller,
wherein the gate driver comprises:
an input circuit, which controls a voltage of a control node in response to a clock signal, an inversion clock signal which is an inverted signal of the clock signal, and an input signal;
an inverter circuit, which inverts the voltage of the control node and provides the inverted voltage of the control node to an inversion control node;
a feedback circuit, which inverts a voltage of the inversion control node and controls the voltage of the control node; and
a gate output circuit, which outputs a gate signal in response to the voltage of the control node or the voltage of the inversion control node.
